(19) United States
(12) Patent Application Publication
(10) Pub. No.: US 2025/0384204 A1
(43) Pub. Date: Dec. 18, 2025

(54) METHODS AND SYSTEMS FOR IMPROVING SPECIFYING AND USING JOINS BETWEEN DATA SETS IN A SPREADSHEET PIVOT TABLE

(71) Applicant: Adaptam Inc., Palo Alto, CA (US)

(72) Inventors: Robert E. Dvorak, Portola Valley, CA (US); Yuriy Garin, San Carlos, CA (US); Alexey Verkhovskiy, Calgary (CA)

(73) Assignee: Adaptam Inc., Palo Alto, CA (US)

(21) Appl. No.: 19/238,042

(22) Filed: Jun. 13, 2025

Related U.S. Application Data
(60) Provisional application No. 63/659,808, filed on Jun. 13, 2024.

(51) Int. Cl. G06F 40/18

(52) U.S. Cl. CPC G06F 40/18

(57) ABSTRACT

The disclosed technology creates a range of manual to automated ways of setting up and verifying the correct joining of data sets for use generating spreadsheet pivot tables. Handling pairing of data sets and then chaining/sequencing of joins resulting in joins of three or more data sets. Limiting joins to keys with matching data types and matching data values. Limiting joins, as desired, to data value matching criteria and data modelling cardinality requirements. Allowing the qualification of the data sets for joining to be done within or before spreadsheet pivot input panel. Making the qualified joinable data sets available in situationally intelligent data field/range selection lists for use populating the pivot table inputs. Availing those joined data fields/ranges to be used to generate spreadsheet pivot tables.

### CROSS-REFERENCE

This application claims the benefit of U.S. Provisional Application No. 63/659,808 titled “Methods and Systems for Improving Specifying and Using Joins Between Data Sets in a Spreadsheet Pivot Table,” filed on 13 Jun. 2024 (Atty. Docket No. ADAP 1018-1). The priority application is incorporated by reference herein for all purposes.

### RELATED APPLICATIONS

This application is related to the following applications:

U.S. application Ser. No. 18/765,168 titled “Methods and Systems for Specifying and Using in Spreadsheet Cell Formulas Joins Between Data Sets,” filed 5 Jul. 2024 (Atty. Docket No. ADAP 1016-2) which claims the benefit of U.S. Provisional Application No. 63/525,138, filed 5 Jul. 2023 (Atty Docket No. ADAP 1016-1) and

U.S. application Ser. No. 18/777,446 titled “Methods and Systems for Specifying and Using Joins Between Data Sets in a Spreadsheet Data Visualizer,” filed 18 Jul. 2024 (Atty. Docket No. ADAP 1017-2) which claims the benefit of U.S. Provisional Application No. 63/529,135, filed 26 Jul. 2023 (Atty Docket No. ADAP 1017-1). The related cases are incorporated by reference herein for all purposes.

U.S. application Ser. No. 19/200,549, titled “Method and System for Combination Filling of Spreadsheet Analytical Function Outputs,” filed 6 May 2025 (Atty Docket No. ADAP 1021-2) which claims the benefit of U.S. Provisional Application No. 63/643,876, filed 7 May 2024 (Atty Docket No. ADAP 1021-1).

### INCORPORATIONS

This application is related to and incorporates by reference the following applications:

U.S. application Ser. No. 16/31,339 titled “Methods and Systems for Providing Selective Multi-Way Replication and Atomization of Cell Blocks and Other Elements in Spreadsheets and Presentations,” filed 10 Jul. 2018, now U.S. Pat. No. 11,182,548, issued 23 Nov. 2021 (Atty. Docket No. ADAP 1000-2), which claims the benefit of U.S. Provisional Application No. 62/530,835, filed 10 Jul. 2017 (Atty. Docket No. ADAP 1000-1).

U.S. application Ser. No. 16/31,379 titled “Methods and Systems for Connecting a Spreadsheet to External Data Sources with Formulaic Specification of Data Retrieval,” filed 10 Jul. 2018, now U.S. Pat. No. 11,354,494, issued 7 Jun. 2022 (Atty. Docket No. ADAP 1001-2), which claims the benefit of U.S. Provisional Application No. 62/530,786, filed 10 Jul. 2017 (Atty. Docket No. ADAP 1001-1).

U.S. application Ser. No. 16/31,759 titled, “Methods and Systems for Connecting a Spreadsheet to External Data Sources with Temporal Replication of Cell Blocks,” filed 10 Jul. 2018, now U.S. Pat. No. 1,117,165, issued 25 May 2021 (Atty. Docket No. ADAP 1002-2), which claims the benefit of U.S. Provisional Patent Application No. 62/530,794, filed 10 Jul. 2017 (Atty. Docket No. ADAP 1002-1).

U.S. application Ser. No. 16/191,402 titled, “Methods and Systems for Connecting a Spreadsheet to External Data Sources with Ordered Formulaic Specification of Data Retrieved,” filed 14 Nov. 2018, now U.S. Pat. No. 1,136,929, issued 15 Jun. 2021 (Atty. Docket No. ADAP 1003-2), which claims the benefit of U.S. Provisional Patent Application No. 62/586,719, filed on Nov. 15, 2017 (Atty Docket ADAP 1003-1).

U.S. application Ser. No. 17/359,430 titled, “Methods and Systems for Constructing a Complex Formula in a Spreadsheet Cell,” filed 25 Jun. 2021, now U.S. Pat. No. 11,836,444, issued 5 Dec. 2023 (Atty Docket ADAP 1004-2), which claims the benefit of U.S. Provisional Patent Application No. 63/044,990, filed 26 Jun. 2020 (Atty Docket No. ADAP 1004-1).

U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 (Atty Docket No. ADAP 1005-2), which claims the benefit of U.S. Provisional Patent Application No. 63/044,989, filed 26 Jun. 2020 (Atty Docket No. ADAP 1005-1).

U.S. application Ser. No. 17/384,404 titled “Method and System for Improved Spreadsheet Charts,” filed 23 Jul. 2021, now U.S. Pat. No. 12,058,445, issued 6 Aug. 2024 (Atty Docket No. ADAP 1006-2), which claims the benefit of U.S. Provisional Patent Application No. 63/055,581, filed 23 Jul. 2020 (Atty Docket No. ADAP 1006-1).

U.S. application Ser. No. 17/374,898 titled “Method and System for Improved Spreadsheet Analytical Functioning,” filed 13 Jul. 2021, now U.S. Pat. No. 11,694,23, issued 4 Jul. 2023 (Atty Docket No. ADAP 1007-2), which claims the benefit of U.S. Provisional Patent Application No. 63/051,280, filed 13 Jul. 2020 (Atty Docket No. ADAP 1007-1).

U.S. application Ser. No. 17/374,901 titled “Method and System for Improved Ordering of Output from Spreadsheet Analytical Functions,” filed 13 Jul. 2021, now U.S. Pat. No. 11,972,204, issued 30 Apr. 2024 (Atty Docket No. ADAP 1008-2), which claims the benefit of U.S. Provisional Patent Application No. 63/051,283, filed 13 Jul. 2020 (Atty Docket No. ADAP 1008-1).

U.S. application Ser. No. 17/752,814 titled “Method and System for Spreadsheet Error Identification and Avoidance,” filed 24 May 2022, now U.S. Pat. No. 11,977,835, issued 7 May 2024 (Atty Docket No. ADAP 1009-2) which claims the benefit of U.S. Provisional Patent Application No. 63/192,475, filed 24 May 2021 (Atty Docket No. ADAP 1009-1).

U.S. application Ser. No. 17/903,934 titled “Method and System for Improved 2d Ordering of Output from Spreadsheet Analytical Functions,” filed 6 Sep. 2022, now U.S. Pat. No. 12,050,859, issued 30 Jul. 2024 (Atty Docket No. ADAP 1010-2) which claims the benefit of U.S. Provisional Patent Application No. 63/240,828, filed 3 Sep. 2021 (Atty Docket No. ADAP 1010-1).

U.S. application Ser. No. 17/988,641 titled “Methods and Systems for Sorting Spreadsheet Cells with Formulas,” filed 16 Nov. 2022 (Atty Docket No. ADAP 1011-2) which claims the benefit of U.S. Provisional Patent Application No. 63/280,590, filed 17 Nov. 2021 (Atty Docket No. ADAP 1011-1).

U.S. application Ser. No. 18/074,301 titled “Method and System for Improved Visualization of Charts in Spreadsheets,” filed 2 Dec. 2022 (Atty Docket No. ADAP 1012-2) which claims the benefit of U.S. Provisional Patent Application No. 63/25,945, filed 3 Dec. 2021 (Atty Docket No. ADAP 1012-1).

U.S. application Ser. No. 18/142,560 titled “Methods and Systems for Spreadsheet Function and Flex Copy-Paste Control of Formatting and Use of Selection List Panels,” filed 2 May 2022, now U.S. Pat. No. 12,169,687, issued 17 Dec. 2024 (Atty Docket No. ADAP 1013-2) which claims the benefit of U.S. Provisional Application No. 63/337,576, filed 2 May 2022 (Atty Docket No. ADAP 1013-1).

U.S. application Ser. No. 18/142,557 titled “Methods and Systems for Bucketing Values in Spreadsheet Functions,” filed 2 May 2023 (Atty Docket No. ADAP 1014-2) which claims the benefit of U.S. Provisional Application No. 63/337,572, filed 2 May 2022 (Atty Docket No. ADAP 1014-1).

U.S. application Ser. No. 18/542,510 titled “Methods and Systems for Flexibly Linking Spreadsheet Cell Movements and Formulas,” filed 15 Dec. 2023 Atty Docket No. ADAP 1015-2) which claims the benefit of U.S. Provisional Application No. 63/433,408, filed 16 Dec. 2022 (Atty Docket No. ADAP 1015-1).

U.S. application Ser. No. 19/031,145 titled “Methods and Systems for a Family of Dual Entry Spreadsheet Functions, Improved Spreadsheet Validations, and Partial Locking of Spreadsheet Functions and Cell Capabilities,” filed 17 Jan. 2025 which claims the benefit of U.S. Provisional Application No. 63/622,515, filed 18 Jan. 2024 (Atty Docket No. ADAP 1019-1).

U.S. application Ser. No. 18/586,370, titled “Method and System For Repeat 2d Ordering of Output From Spreadsheet Analytical Functions,” filed 23 Feb. 2024 (Atty Docket No. ADAP 1020-1) which is a continuation-in-part of application Ser. No. 17/903,934, titled “Method and System For Improved 2d Ordering of Output From Spreadsheet Analytical Functions,” filed 6 Sep. 2022 (Atty Docket No. ADAP 1010-2) which claims the benefit of U.S. Provisional Application No. 63/240,828, filed 3 Sep. 2021 (Atty Docket No. ADAP 1010-1.)

### BACKGROUND

With the exception of Power Pivot in Microsoft Excel, all the other spreadsheets lack the ability to join different data sets within their PivotTables. However, the Power Pivot capability within Microsoft Excel lacks important help to users to avoid setting up joins that fail, has substantial limitations in its ability to join data sets, and lacks important selection list intelligence to stop users from setting up PivotTables using data from different data sets lacking joins.

Excel Power Pivot creates the relationships between the tables used in its PivotTables but in the creation of those table joins does not proactively or reactively stop the user from creating joins with data type (e.g., one join key text and the other join key dates) or data value mismatches (e.g., no values shared by both of the join keys). The Power Pivot PivotTable executes the join and generates a result for the PivotTable using the join providing only a warning that “Relationships between tables may be needed”. There is no blocking of joins or definitive error message from creating joins that clearly will not work (i.e., not join any data across the two tables) because of data type mismatches or no data value match in the join keys. The Excel Power Pivot joining has substantial limitations in its joining ability in that it only supports one join type, left outer joins, thereby potentially dropping data that a full outer join would not, and not allowing users to do inner joins, right outer joins, self joins, or cross joins. It does not support compound keys and it does not support many-to-many cardinality joins. It does not support multiple joins between two data sets. It also employs only primary key/foreign key joins and therefore cannot do a one-to-many join with nulls in the one key. The Excel Power Pivot employs a very subtle way of letting users know that tables are joined in their selection lists and allows users to populate PivotTable inputs with fields from tables that are not joined.

Therein arises opportunities to help users avoid setting up joins that fail, substantially increase the types of data set joins usable with a spreadsheet PivotTable, and proactively and reactively stop users from setting up spreadsheet PivotTables using data from different data sets lacking joins.

### SUMMARY

The disclosed technology creates a range of proactive informational and active blocking of data set joins that are guaranteed to fail (i.e., not join any data across the two tables) because of join key data type mismatches or the lack of any value overlap between the join keys. Embodiments also provide reactive error messaging clearly identifying for the user the join key failure.

Embodiments of the disclosed technology support multiple joins between the same two data sets with manual or automated solutions for the naming of the multiple joined fields. Embodiments also support the automatic or automatically prompted human selection changes to PivotTable input fields originally specified as the single data set field that need to be converted to double joined fields after the user inputs into the PivotTable a field from the double joined table. Embodiments of our technology support a much broader set of join types including those employing compound keys, those employing unique to many key relationships, and joins involving one or more null within the unique key. Embodiments support join types beyond left outer joins, such as full outer joins and inner joins.

Embodiments of the disclosed technology proactively stop users from selecting fields that combine data sets in the PivotTable inputs which lack joins or lack joins that join data from both tables (e.g., because of key data type mismatches or keys lacking shared values). They automatically add newly joinable fields in the selection lists as joins between the data sets are added as well as removing previously joinable fields as joins are removed. Embodiments support clear reactive messaging of errors should users input fields from data sets without functioning joins.

Particular aspects of the technology disclosed are described in the claims, specification, and drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The color drawings also may be available in Patent Center via the Supplemental Content tab.

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIGS. 1 and 2 examples “how Power Query and Power Pivot work together and some Power Query limitations in Microsoft Excel.

FIGS. 3A, 3B and 3C examples some limitations of the Microsoft Excel Power Pivot data model in joining data sets.

FIGS. 4 and 5 examples the primary key limitation in Microsoft Excel Power Pivot PivotTable data set joins of no nulls.

FIG. 6 examples five data sets with color coded potential data set to data set join keys used in the Microsoft Excel Power Pivot PivotTable join examples in FIGS. 7 through 21.

FIG. 7 examples a two data set join with a one-to-one join, which therefore joins either direction in Microsoft Power Pivot, that does not work for the PivotTable inputs because the join is in the opposite direction as the PivotTable inputs.

FIG. 8 examples the user reversing the direction of the join in FIG. 7 to align with the PivotTable inputs in FIG. 7 and then getting the correct PivotTable result (not the Cartesian Products).

FIG. 9 examples the same join as in FIG. 7 successfully working because the join direction and the PivotTable Values to Row direction are in the same direction (aligned).

FIG. 10 examples the user reversing the direction of the join in FIG. 8 with the PivotTable inputs of FIG. 8 and then instead of getting the correct PivotTable result of FIG. 8 get the Cartesian Products result because the joins and inputs are misaligned.

FIGS. 11 and 12 examples that the same misalignment problems and limitations exist in Microsoft Power Pivot PivotTable joins for ‘Value’ to ‘Column’ inputs.

FIGS. 13 and 14 examples the further join to input alignment limitations in chained joins in Microsoft Excel Power Pivot PivotTables.

FIG. 15 examples a user setting up Power Pivot PivotTable with inputs from two different data sets which are not joined.

FIGS. 16 and 17 example a user then unsuccessfully using the Microsoft Excel Power Pivot PivotTable ‘Auto-Detect’ capability to set up the join needed in FIG. 15.

FIG. 18 examples the lack of data type or data value join keys mismatch blocking in the creation of a join in Microsoft Excel Power Pivot PivotTable.

FIG. 19 further examples the lack of blocking of setting up data type join keys mismatch but the proactive altering of the direction of the join based on cardinality (in this case of keys that will not join).

FIG. 20 examples Microsoft Excel Power Pivot PivotTable generating a result from a join that does not work (data type mismatch) with no specific error message but the same ‘Relationships between tables may be needed’ yellow area shown in other situations.

FIG. 21 examples for FIG. 20 that there is an ‘Active’ join between the two data sets used in the Microsoft Excel Power Pivot PivotTable inputs despite it is a join that does not work (join any data across the two tables) because of join keys' data type mismatch.

FIGS. 22, 23, and 24 examples a different join set up UI in Microsoft Excel Power Pivot after both key selection blocking a many to many join but no proactive blocking of joins that will not work.

FIG. 25 examples the different locations that joins can be set up (qualified) or altered (requalified) in our technology.

FIG. 26 examples some of the combination of manual and automated ways joins can be set up in our technology.

FIG. 27 examples many of the different join set up/qualification validation paths supported by technology.

FIG. 28A examples our spreadsheet PivotTable joining technology using non-spreadsheet cells (NSC) external data sources on the same computer as the application.

FIG. 28B examples our spreadsheet PivotTable joining technology using non-spreadsheet cells (NSC) external data sources in the cloud.

FIG. 29A examples our spreadsheet PivotTable joining technology using data sets residing with ranges of cells within the spreadsheet.

FIG. 29B examples our spreadsheet PivotTable joining technology using data sets residing with tables within the spreadsheet.

FIG. 30 examples a join key selection support tool in our technology where the user specifies the first data set and its join key, and the second data set and our technology then automatically screens all the fields in the second data set as join key candidates.

FIGS. 31A, 31B, 32, 33, 34A, 34B, 34C, 35A, 35B, 35C, 36A, 36B, 36C, 36D, and 37 example different join setup UI variants with different combinations of join key information presented to the user, different levels of option blocking (e.g., from none to blocking all unsuccessful join options) and different join type options (e.g., beyond just the left outer join).

FIGS. 38, 39A, 39B, 39C, 39D, 39E, 40A, 40B, 40C, 40D, 40E, 41, 42A, and 42B example one PivotTable join setup via a number of different more intelligent PivotTable field selection lists working successfully for a join in our technology when the join and the PivotTable inputs are misaligned.

FIGS. 42A, 42B, 43, 44A, and 44B examples our technology successfully executing the PivotTable when the join and the PivotTable inputs directions align, demonstrating alignment works any direction in our technology.

FIGS. 45, 46A, and 46B examples our technology successfully executing the PivotTable when the join and the PivotTable ‘Values’ to ‘Columns’ inputs directions misalign, further demonstrating alignment works any direction in our technology.

FIG. 47 examples five data sets used by our spreadsheet PivotTable technology with the same four color-coded joins as those used in FIG. 6 for the Microsoft Excel Power Pivot PivotTable joins.

FIG. 48 examples the exact same PivotTable inputs and joins successfully working in contract to the unsuccessful working of Microsoft Excel Power Pivot PivotTable in FIG. 14.

FIG. 49 examples the exact same PivotTable as in FIG. 48 except that instead of having the visible join arguments in FIG. 48, FIG. 49 has invisible join arguments.

FIGS. 50A, and 50B illustratively examples our technology correctly executing the joins and PivotTable data manipulations and calculations for FIGS. 48 and 49 despite the misalignment between the joins and the PivotTable inputs.

FIGS. 51, 52, 53A, 53B, 54A, and 54B examples our technology working for more complex and totally misaligned PivotTable chained/sequenced joins.

FIGS. 55A, and 55B examples two data sets and the illustrative manual set up/qualification of double join (two joins) between those two data sets.

FIGS. 56A, and 56B illustratively example those same double joins as in FIG. 55B being automatically generated and on the user's computer, in the cloud or some combination of the two.

FIG. 57 examples a charity user starting to set up a PivotTable in our technology employing the double joins between two data sets.

FIG. 58 examples the automatically generated selection list displaying the original data set and the two double joined data sets (complete with their automatically generated multi join field names and multi join table names).

FIG. 59 examples the user selecting one of the double joined fields in our technology.

FIG. 60 examples the user result from generating a PivotTable in our technology using one of two double joined data sets.

FIG. 61 examples the automatically generated selection list displaying the original data set and the two double joined data sets (complete with their automatically generated multi join field names and multi join table names) after the use in the PivotTable inputs of the original data set and one of the double joins.

FIG. 62 examples the user result from generating a PivotTable in our technology using both of two double joined data sets.

FIG. 63 illustratively examples our technology executing a double join.

FIGS. 64A and 64B illustratively examples our technology using the relevant double joined data from FIG. 63 to do the PivotTable manipulations and calculations to give the result in FIG. 62.

FIGS. 65, 66, and 67 examples a situation where our technology automatically replaces a regular (non-double joined) version of a double joined field with a double joined version of the same field.

FIGS. 68, 69, 70, 71, and 72 examples an ambiguous situation where a regular version of a double joined field replacement is required and is automatically prompted for user decision because only the user could decide with complete certainty on which field to select.

FIGS. 73A, 73B, 74A, 74B, 75, 76, 77, 78, and 79 examples our technology automatically altering the selection lists when selection combinations turn previously cardinality acceptable joins into unacceptable cardinality chained/sequenced joins.

FIG. 80 examples a user altering in our technology the allowed cardinalities to accept previously unacceptable many to many joins.

FIG. 81 illustratively examples the Partial Cartesian product join created by user inputs in our technology in FIG. 80.

FIG. 82 illustratively examples the PivotTable manipulations and calculations to deliver the result in FIG. 80 which includes Partial Cartesian product duplications.

FIG. 83 examples a sophisticated user adding a filter to remove in our PivotTable technology the Partial Cartesian product duplicates that were in the result of FIG. 80 and get the correct results for the donations by state for donors contacted before Oct. 1, 2022.

FIGS. 84A and 84B illustratively examples our PivotTable manipulations and calculations to deliver the result in FIG. 83 which removes the Partial Cartesian product duplications.

FIGS. 85A and 85B examples different UIs in our technology for setting up joins where the user specifies cardinality and data value match requirements.

FIGS. 86A and 86B example different outcomes from a Join validation UI in our technology.

FIG. 87 examples our PivotTable technology definitively informing a user of an error when they attempt to use fields that lack direct or chained/sequenced joins together in the PivotTable inputs.

FIG. 88 examples our technology successfully executing the PivotTable when the join and the PivotTable ‘Values’ to ‘Columns’ inputs directions align, further demonstrating alignment works any direction in our technology.

FIG. 89 examples our PivotTable join technology successfully working for a two data set join where the join, which is displayed in the PivotTable inputs, direction is misaligned with the ‘Values’ to ‘Rows’ input direction.

FIG. 90 examples an embodiment of our technology that displays an error in the PivotTable should a user employ a join where the keys have a data type mismatch (e.g., text field in one key and a date field in the other key) and enter PivotTable inputs from those mismatched join data sets.

FIG. 91 examples an embodiment of our technology that displays an error in the PivotTable should a user employ a join where the keys have the same data type but a values mismatch (e.g., no common values in the two keys) and enter PivotTable inputs from those mismatched join data sets.

FIG. 92 examples how Microsoft Excel subtly displays in the PivotTable sidebar joined tables using light grey line dividers.

FIG. 93 lists when Power Pivot was added to the different versions of Microsoft Excel.

FIGS. 94, 95A, 95B, 95C, 95D, 95E, 96A, 96B, 96C, 96D, and 96E examples the use of our technology in different PivotTable inputs for selection lists which provide the user with more information with which to make their selections and proactively block them from setting up PivotTables that will not work because of invalid joins.

FIG. 97 illustratively examples our technology executing a single double join.

FIGS. 98A and 98B illustratively examples our technology using the relevant single double joined data from FIG. 97 to do the PivotTable manipulations and calculations to give the result in FIG. 97.

FIG. 99 examples our technology using a ‘Values’ input similar to Micro Excel while replicating our technology's ability to generate correct joins with misalignment.

FIGS. 100, 101A, 101B, 102A, and 102B examples our PivotTable technology successfully delivering a PivotTable result with multiple separate Values arguments, a filter, and chained/sequenced joins between five data sets.

FIGS. 103, 104, and 105 examples an alternative to FIGS. 58 and 59 for what happens when the user clicks the ‘ADD’ button 5736 in FIG. 57 with both approaches delivering the result in FIG. 60.

FIG. 106 examples an embodiment of our technology that displays a popup blocking a user from entering PivotTable join with data mismatches and informing them as to what the problem is or problems are, in this situation a join which a data type mismatch (e.g., text field in one key and a date field in the other key).

FIGS. 107, 108A, 108B, 108C, 108D, 110A, and 110B examples a set of selection lists/hints employing a table selection UI used to deliver the results in FIG. 109 and FIG. 111.

FIG. 112 depicts an example computer system that can be used to implement aspects of the technology disclosed.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

When spreadsheet applications were first created, they electronically emulated tabular paper spreadsheets. More recently, Microsoft Excel, Google Sheets, Apple Numbers, and others have dramatically increased the breadth of capabilities and usefulness of spreadsheets. Spreadsheet applications now access data across a wide variety of sources including relational, structured, and semi-structured, open data protocol (OData), Web and Hadoop among others; and these applications manipulate data—such as in pivot tables and via Microsoft PowerPivot. Additionally, spreadsheets have extensive functionality for creating charts with SmartArt and for building forms, and they even have programming languages embedded within them, such as Visual Basic (VBA in Excel), Apps Script (in Google Sheets) and Apple Script (in Numbers).

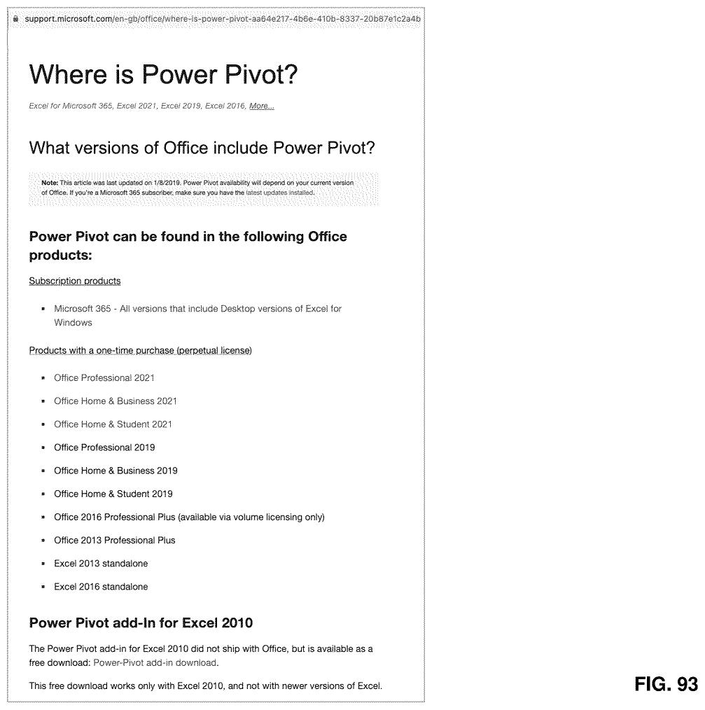

With all the added capabilities, spreadsheet applications have become substantially more complicated. All this complexity has led to over a hundred books and thousands of online videos that have been published to help users understand the capabilities of Excel alone. However, unlike programming languages and programming where users tend to spend long hours of focused use day after day, most spreadsheet users are much more occasional users episodically working in spreadsheets as part of being a student, doing their job or doing some other activity. Therefore, they tend to know how to use a small fraction of the spreadsheet capabilities and not to remember non-intuitive instructions. For these users it is incredibly beneficial to make the usage simple and intuitive requiring no memory of what to do and how to do it. For those users it is very valuable to have external data (e.g., web or their employer company data) simply available in their spreadsheets and to eliminate as much data manipulation and data analytics as possible. Microsoft Excel via Power Query and Power Pivot have made external and in-cell data sets available in their Power Pivot PivotTables with a data set joining capability in Power Pivot. This capability was introduced in 2010 as an add-in for Excel 2010 and then added to versions of Excel and Office starting in 2013 as exampled in FIG. 93. It is a capability unique to Microsoft which has not been duplicated in the other spreadsheets, e.g., Google Sheets or Apple Numbers.

Microsoft Power Pivot Join limitations

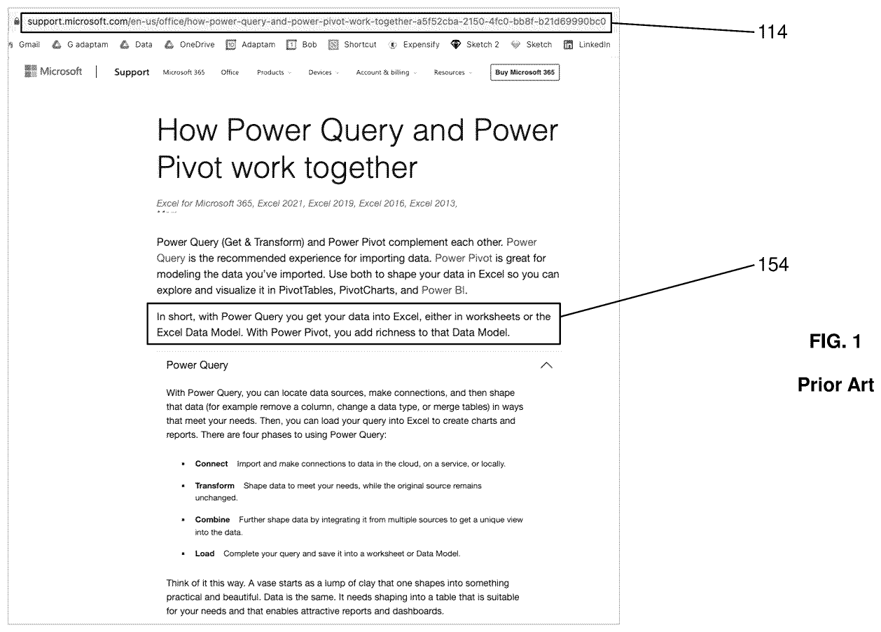

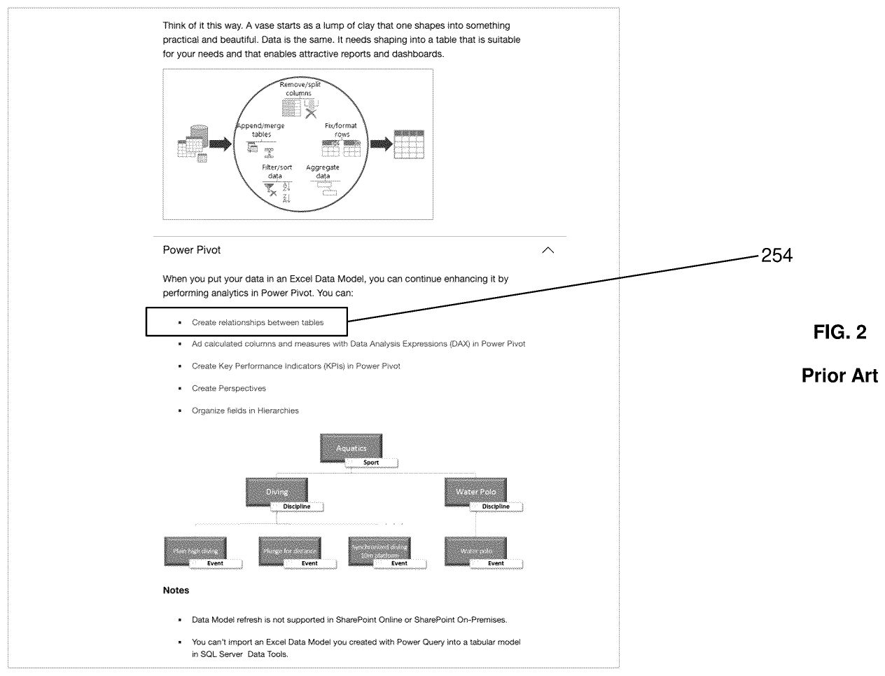

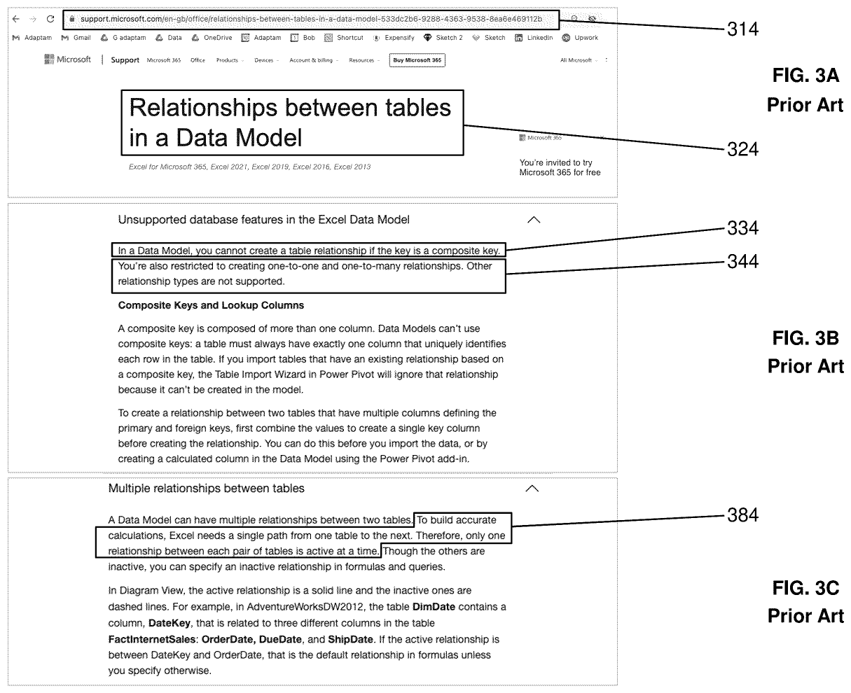

Microsoft Power Query supports putting the data sets into Excel worksheets or the Excel Data Model while Power Pivot adds richness to the Data Model as cited by Microsoft (FIG. 1 114) in FIG. 1 154. That citation by Microsoft continues in FIG. 2 listing part of the richness added in Power Pivot is to ‘Create relationships between tables’ 254. However, those Power Pivot PivotTable data model relationships (324 in FIG. 3) have many limitations as cited by Microsoft (FIG. 3 314):
No composite join keys as 334,
No multiple joins between two tables active at the same time 384,
Only one to one and one to many join key cardinality relationships 344, and
Only supports left outer joins, except in some situations switching to what appears to be a cross join (cartesian join) without any explanation as to why.

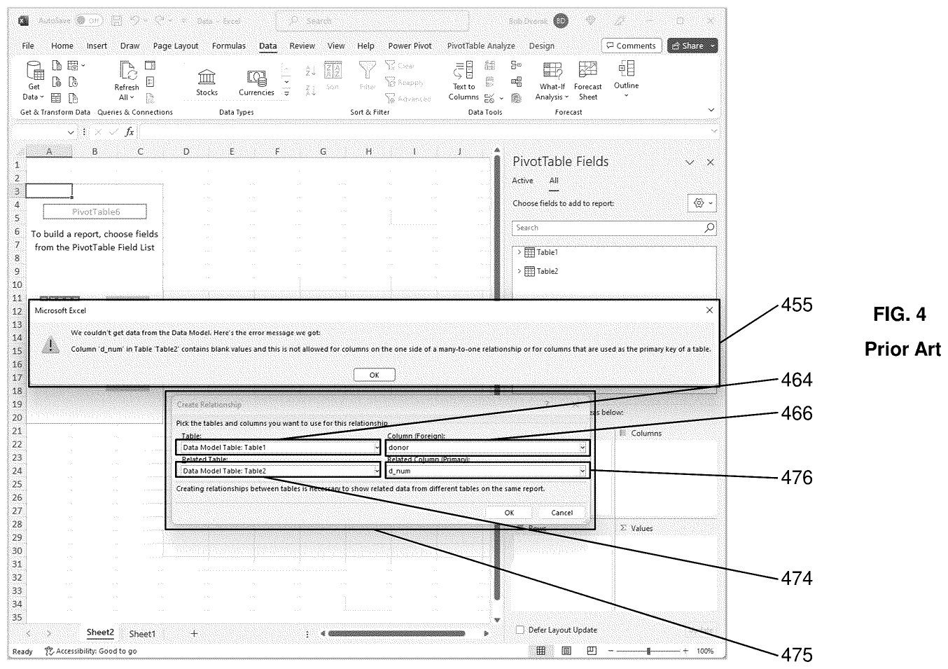

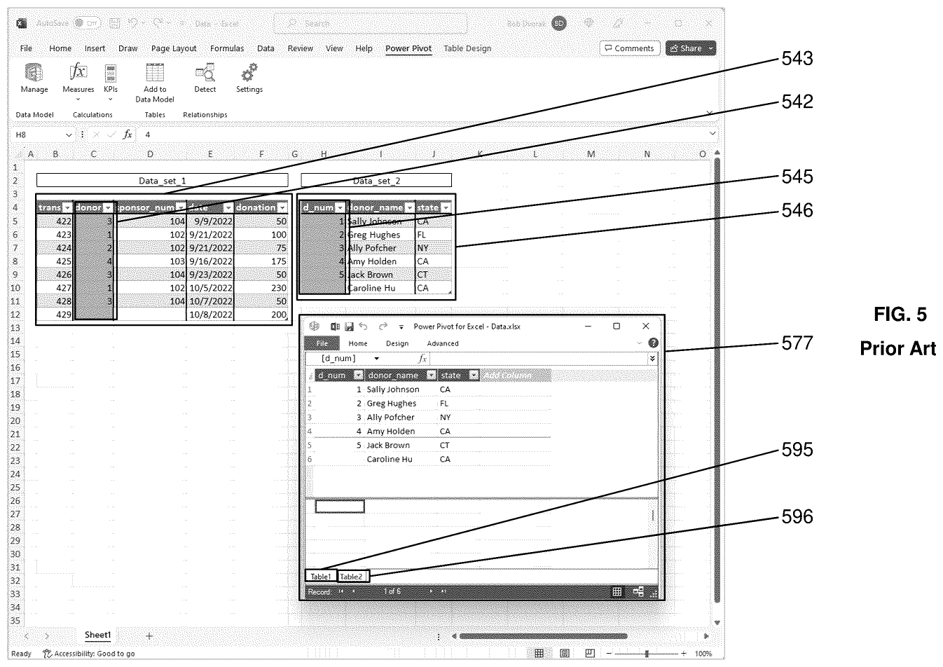

FIG. 4 and FIG. 5 further examples the limitations of the Power Pivot data set joining capabilities for the join of the two data sets ‘Data_set_1’ 543 and ‘Data_set_2’ 546 in FIG. 5. Those two tables have been added to the PowerPivot ‘Data Model 577 as ‘Table’ 595 and ‘Table2’ 596, respectively. However, because both of the join keys ‘donor’ 542 and ‘d_num” 545 contain nulls they are not joinable within Power Pivot. That is because all joins are primary key/foreign key relationships allowing no nulls (blank values) in the primary keys, therefore:
Not allowing joins of a unique cardinality (being a one with one or more nulls) as the primary key as exampled in FIG. 4 455.
Not allowing joins of two unique cardinality join keys each containing a null as exampled by FIG. 4 455 because neither could be the primary key and one must be the primary in Power Pivot PivotTable joins.

In FIG. 4 when the user attempts to set up a join between FIG. 5 ‘Data_set_1’ 543 and ‘Data_set_2’ 546 using the ‘Data Model 577 ‘Table 1’ 595 and ‘Table2’ 596 they find they cannot do it because of the null in the unique cardinality join key ‘d_num” 545. And because the other join key ‘donor’ 542 is a many cardinality they cannot set up the join (464, 466, 474, and 476 inputs in the ‘Create Relationship’ popup 475). In this example a one cardinality and a unique cardinality are not the same thing because the unique cardinality (by our definition) allows null (blank) values while the one does not. The Microsoft Excel Power Pivot joining supports one to one (e.g., primary key to foreign key), one to unique, and one to many (non-unique joins) but does not support unique (containing a null) to one, unique (containing a null) to unique (containing a null), and unique (containing a null) to many joins as well as many to one, many to unique, and many to many joins. This is because as a unique (a one containing a null) or a many cannot be the primary key, which was the first in each of the examples just cited.

In addition, as previously mentioned, Microsoft Power Pivot only supports one type of join, a left outer join. This eliminates the other types of joins such as the full outer, inner, cross, self, and right outer joins. In combination with the cardinality limitations many joining situations are not possible in Microsoft Power Pivot. However, there is an even more challenging join limitation having to do with the directional alignment of the join and the PivotTable inputs that adds complexity for users and further limits the applicability as we will example next.

Microsoft Power Pivot and PivotTable Join direction limitations

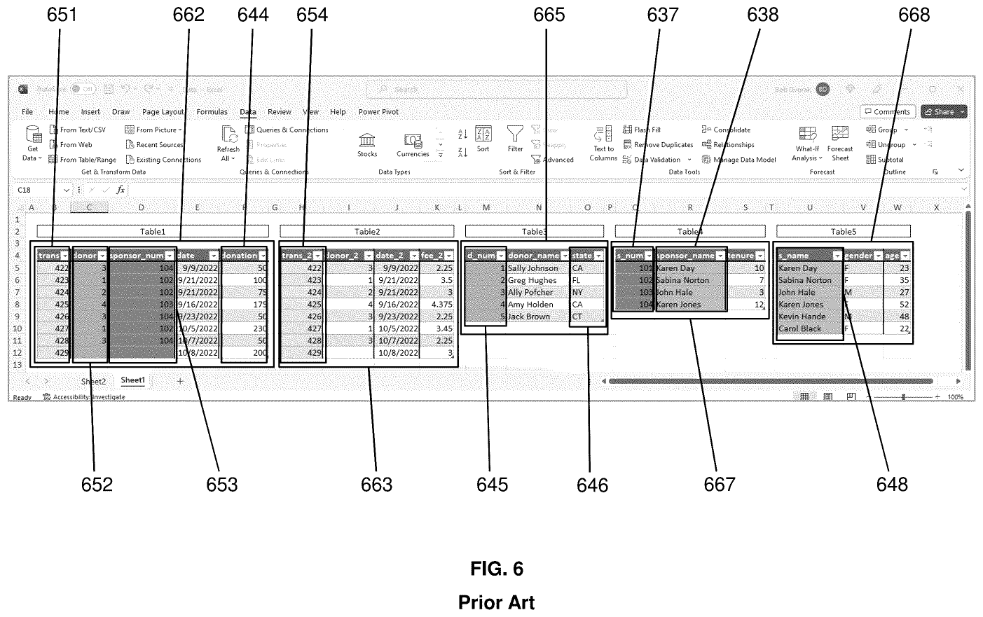

FIG. 6 through FIG. 21 example additional limitations of Microsoft Power Pivot joins that work (i.e., meet all the requirements of primary keys, cardinality etc. to work for Power Pivot) but then do not work in certain PivotTable input situations. FIG. 6 examples five data sets (‘Table1’ 662, ‘Table2’ 663, ‘Table3’ 665, ‘Table4’ 667, and ‘Table5’ 668) which each contain color coded join keys to one or more of the other data sets. These join key combinations work (i.e., 651/654, 652/645, 653/637, and 38/648 work in at least one direction of setting up the join as per Microsoft Power Pivot) for the cardinality, null limitations, primary key and other join requirements of Microsoft Power Pivot. Each of those tables (data sets) have been added to the Microsoft Power Pivot Data Model and therefore are available for Power Pivot joins and PivotTable usage.

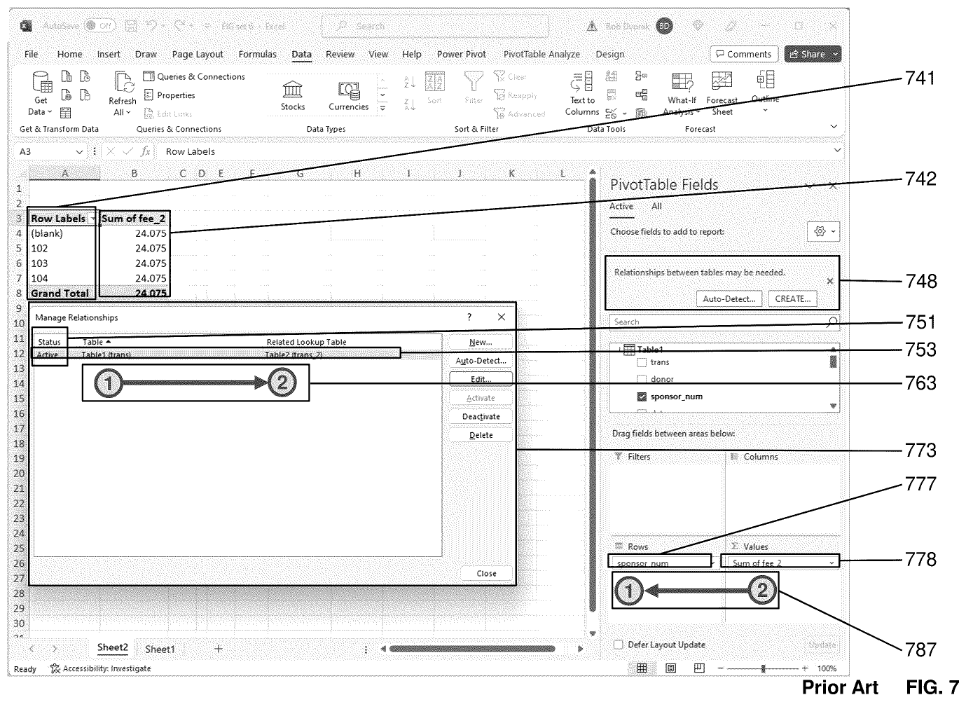

However, as we will example in FIG. 7 through FIG. 14 joins must also directionally align with the inputs in the Microsoft Excel Power Pivot PivotTable to work, otherwise they do not work if they do not have the same directional alignment. It not only requires the user to align the join or joins to their inputs in the PivotTable but also means that the PowerPivot PivotTables cannot support inputs that are not all in the same direction making joins between some of these tables impossible in Microsoft Excel Power Pivot PivotTables because the primary to foreign key or cardinalities make setting up the join in that direction impossible.

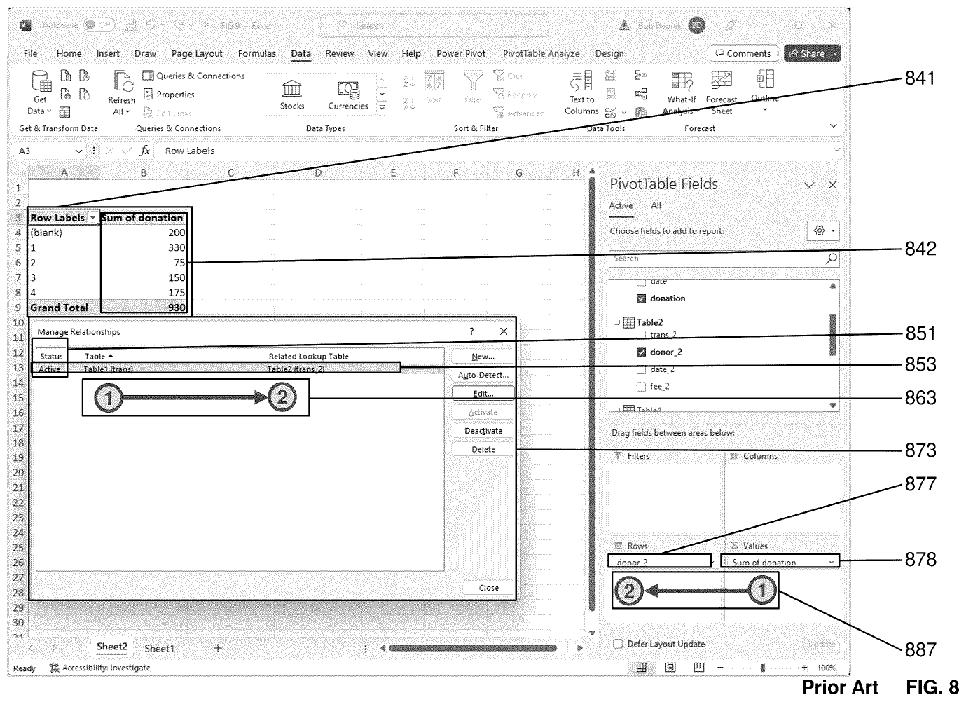

FIG. 7 examples a two data set join with a one-to-one join, which therefore should join either direction in Microsoft Power Pivot, that does not work for the Power Pivot PivotTable inputs because the join is in the opposite direction as the PivotTable inputs. The Power Pivot PivotTable input direction is set from the ‘Values’ to ‘Rows’ and/or from ‘Values’ to ‘Columns’. In this example the direction is set from the ‘Values’ PivotTable input ‘Sum of fee_2’ 778 (a field in ‘Table2’) to the ‘Rows’ PivotTable input ‘sponsor_num’ 777 (a field in ‘Table1’). This is indicated by the red ‘2’ (‘Table2’) going via the red arrow to the “1’ (‘Table2’) 787. The join shown in the ‘Manage Relationships’ popup 773 of ‘Table’ ‘Table1(trans)’ to ‘Related Lookup Table’ ‘Table2(trans_2)’ 753 is going from ‘Table 1’ to ‘Table2’ as indicated by the red ‘1’ and the red arrow going to the red ‘2’ 763. Because these two sets of directions (‘2’ to ‘1’ 787 and ‘1’ to ‘2’ 763) are going in opposite directions (misaligned) the PivotTable output 741 does not generate the correct ‘SUM of fee_2’ values 742 but instead gives the Cartesian Product for each ‘Row labels’ 741 ‘Sum of fee_2’ value of ‘24.075’. The PivotTable does not definitely tell the user that the join did not work as they would have expected summing the ‘fee_2’ value for each ‘sponsor_num’ value but exposes the box 748 suggesting ‘Relationships between tables may be needed’ which makes little sense given a totally legitimate join (with no error message) between the two tables appears to exist as shown in the ‘Manage Relationships’ popup 773 ‘Status’ ‘Active’ 751 join 753 and in the successful use of the exact same join exampled in FIG. 8. Another possible way of describing what is happening is that when the directions are aligned the Microsoft Power Pivot PivotTable joins do a left join and when they are not aligned, they do a cross join (also known as a cartesian join). The challenge for the user is nothing tells the user that is what has happened, and no rationale is given as to why one situation would do one type of join and what feels like a very similar situation would do a very different join. No matter what Microsoft's rationale is the user does not get what they expected, a left join between two data sets.

FIG. 8 examples the exact same join 873 as in FIG. 7 773 successfully working because the join direction and the Power Pivot PivotTable ‘Values’ to ‘Rows’ direction are in the same direction (aligned). In FIG. 8 the user changes the PivotTable inputs so that the PivotTable input ‘Sum of donation’ 878 (a field in ‘Table1’) is going from ‘Table1’ as indicated by the red ‘1’ to a Rows input ‘donor_2’ 877 (a field in ‘Table2’). as indicated by the red ‘2’ with the directionality shown of the ‘1 going via the red arrow to the 2’ 887. The join shown in the ‘Manage Relationships’ popup 873 of ‘Status’ ‘Active’ 851 ‘Table’ ‘Table1(trans) to ‘Related Lookup Table’ ‘Table2(trans_2)’ join 853, which is exactly the same as in FIG. 7 753, is going from ‘Table1’ to a ‘Table2’ as indicated by the ‘red 1 and the red arrow going to the red2’ 863. Because both the PivotTable input table direction 887 (‘1’ to ‘2’) and the join table direction 863 (‘1’ to ‘2’) are the same the Microsoft Power Pivot PivotTable generates the correct left join output 841 with the correct ‘SUM of donation’ values 842 proving that the exact same join works but only with directional alignment of the PivotTable inputs and the join inputs.

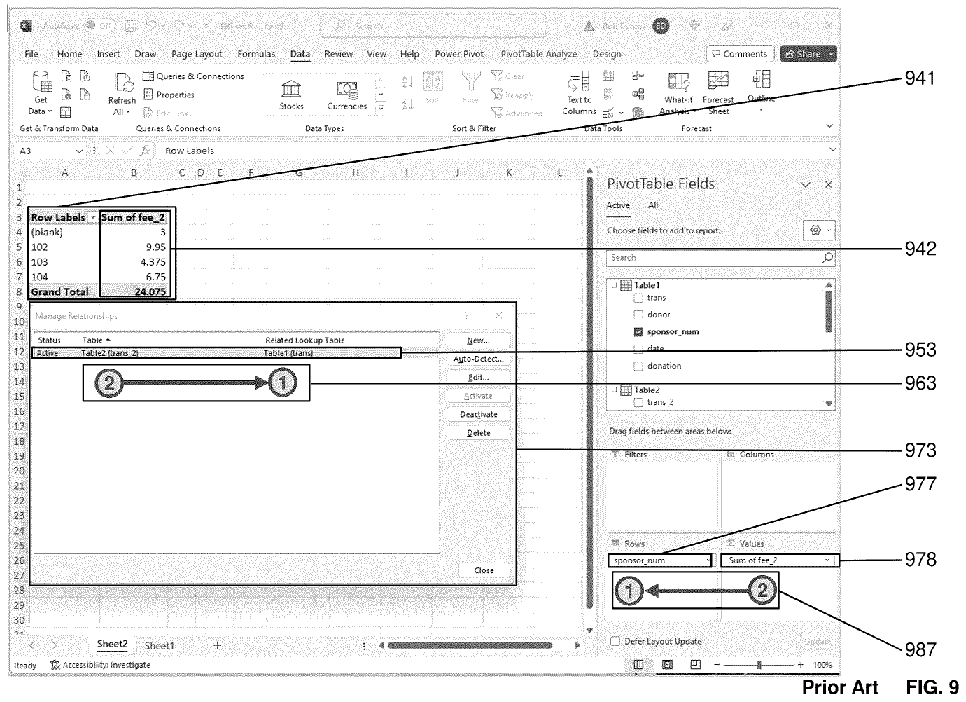

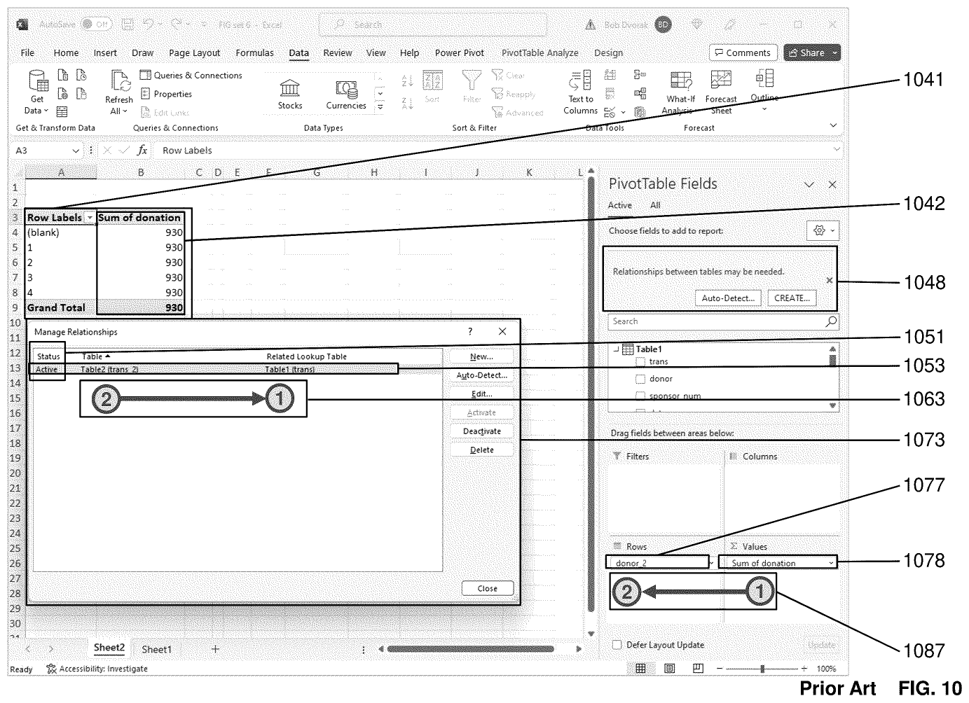

FIG. 9 confirms this because when the user returns to the Microsoft Power Pivot situation in FIG. 7 and reverses the join 953 in the ‘Manage Relationships’ popup 973 so that it goes from ‘2 to 1’ 963 (matching the direction 987 in the PivotTable inputs 978 and 977 which is what it was in FIG. 7), then the correctly joined (left join) PivotTable output is generated 941 with the correct ‘SUM of fee_2’ values 942. Not the Cartesian Product results 742 generated in FIG. 7. Thus, putting a challenging requirement on the user to align the PivotTable inputs and the join and requiring anytime the user changes the direction of the PivotTable inputs the user must change the direction of the join as exampled in FIG. 10 where the failure to do so results in the erroneous Cartesian Product outputs. And as previously mentioned making it impossible to do certain PivotTables if the alignment of the PivotTable inputs requires a join that will fail because of the primary key/foreign key or cardinality limitations.

FIG. 10 examples the user reversing the direction of the join in FIG. 8 with the PivotTable inputs of FIG. 8 and then instead of getting the correct (left join) PivotTable result of FIG. 8, they get the Cartesian Products result 1041 of ‘930’ 1042 for each of the PivotTable ‘Row Labels’ values because the join and PivotTable inputs are misaligned. In FIG. 10 the user retains the join (1053 with the directionality 1063) in FIG. 9 (953 with the directionality 963) which is the opposite of that in in FIG. 8. However, they then change the FIG. 10 PivotTable inputs (1077 and 1078 with directionality 1087) to those in FIG. 8 (877 and 878 with directionality 887) and as described previously instead of getting the correct (left join) PivotTable result of FIG. 8 get the Cartesian Products result because the joins and inputs are now misaligned. The user gets no definitive message telling them of the problem as the join shows ‘Status' Active’ 1051 although again they get the yellow box ‘Relationships between tables may be needed’ 1048 which is hard to understand because of the active status join in 1073. And as we have seen in the previous examples there is no problem with the join between the tables but there is some alignment problem between the PivotTable inputs and the join.

Same Problems with Value to Column PivotTable Situations

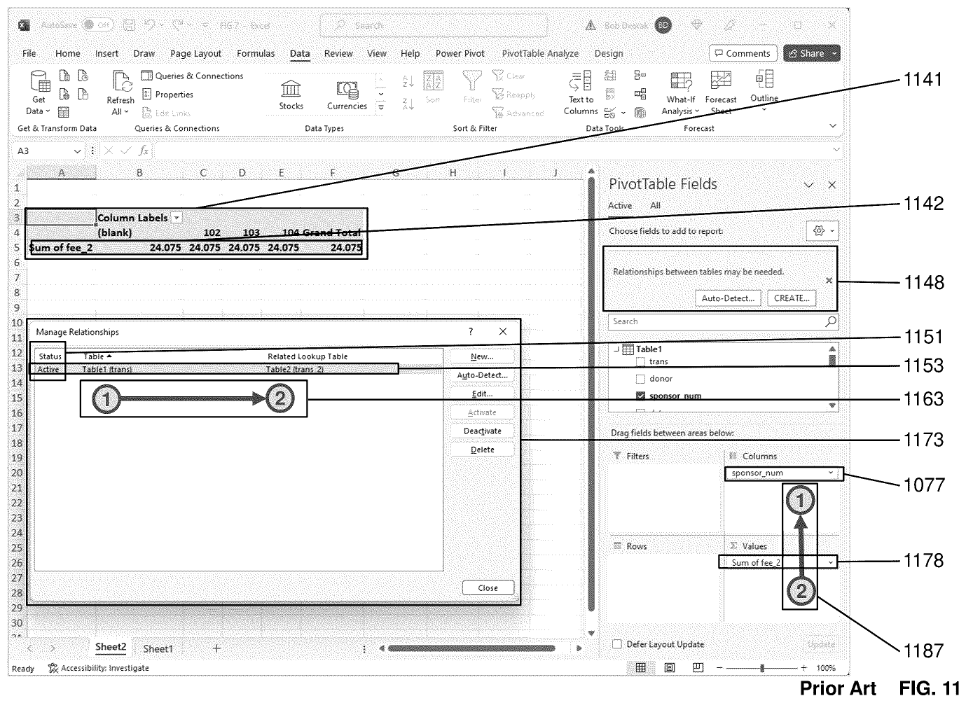

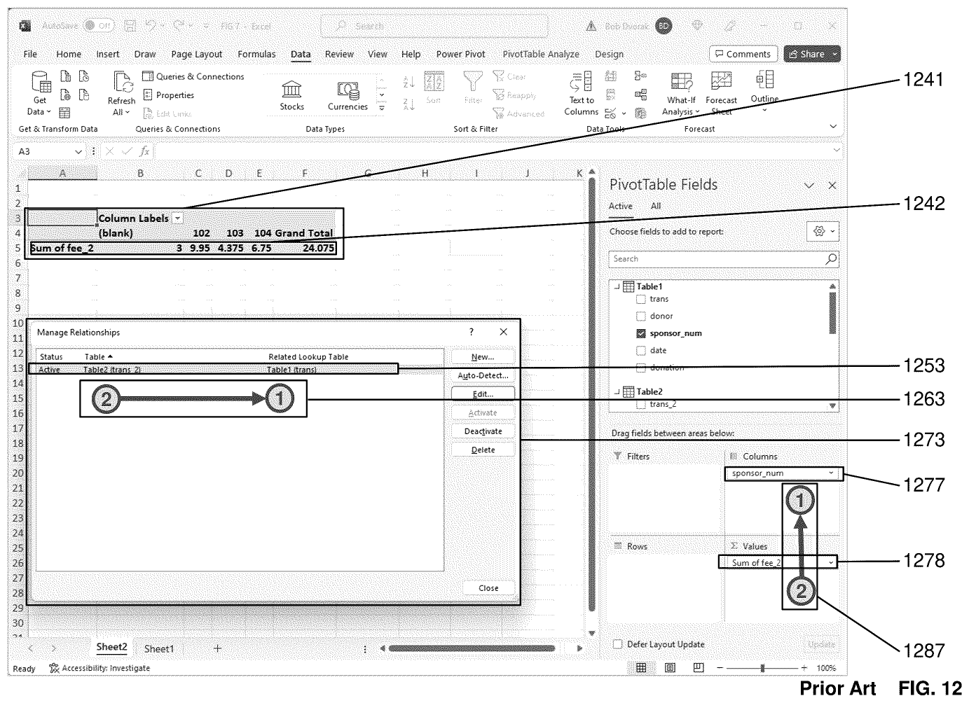

FIG. 11 and FIG. 12 examples that the same misalignment problems and limitations exist in Microsoft Power Pivot PivotTable joins for ‘Value’ to ‘Column’ inputs. FIG. 11 examples the same two data set join as FIG. 12. In the FIG. 11 example the PivotTable input ‘Sum of fee_2’ 1178 is going from a field in ‘Table2’ as indicated by the red ‘2’ to a field in ‘Table1’ ‘Column’ input ‘sponsor_num’ 1177 as indicated by the red ‘1’ with the directionality shown of the ‘2 going via the red arrow to the1’ 1187. The join shown in the ‘Manage Relationships’ popup 1173 of ‘Status’ ‘Active’ 1151 ‘Table’ ‘Table1(trans)’ ‘Related Lookup Table’ ‘Table2(trans_2)’ 1153 is going from ‘Table1’ to a ‘Table2’ as indicated by the ‘red 1 and the red arrow going to the red2’ 1163. Because these alignments are going in opposite directions (misaligned) the PivotTable output 1141 does not generate the correct (left join) ‘SUM of fee_2’ values 1142 but instead gives the Cartesian Product for each value of ‘24.075’. As described previously the PivotTable does not definitely tell the user that it did not work (or why they got a cross join rather than a left join) but exposes the box 1148 suggesting ‘Relationships between tables may be needed’ which makes little sense given a totally legitimate Status' ‘Active’ 1151 join 1153 between the two tables exists as previously exampled in FIG. 8.

In FIG. 12 the user changes the direction of the join in the ‘Manage Relationships’ popup 1273 to ‘Table2(trans_2) Table1(trans) 1253. This changes the direction of the join to ‘2 to1’ 1263 which is the same direction 1287 as the PivotTable inputs 1278 and 1277 thus generating the correct (left join) ‘SUM of fee_2’ values 1242 in the PivotTable output 1241. Thus, exampling that the same directionality of joins (alignment) limitations applies to ‘Columns’ as to ‘Rows’ in the Microsoft Power Pivot PivotTable. A process that is unduly complicated, requiring users to do to extra work, and eliminates many otherwise useful PivotTable results from working (due to primary key and cardinality situation limitations). A process that becomes even more complicated in chained joins as we will example next.

### Microsoft Power Pivot and PivotTable Chained Joins Complexity and Limitations

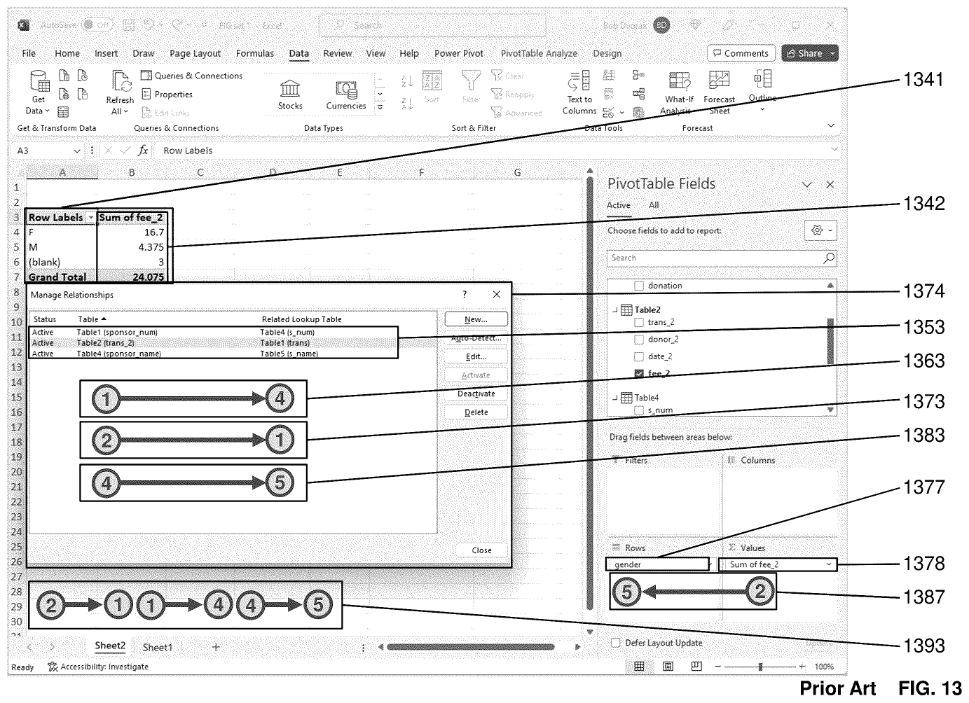

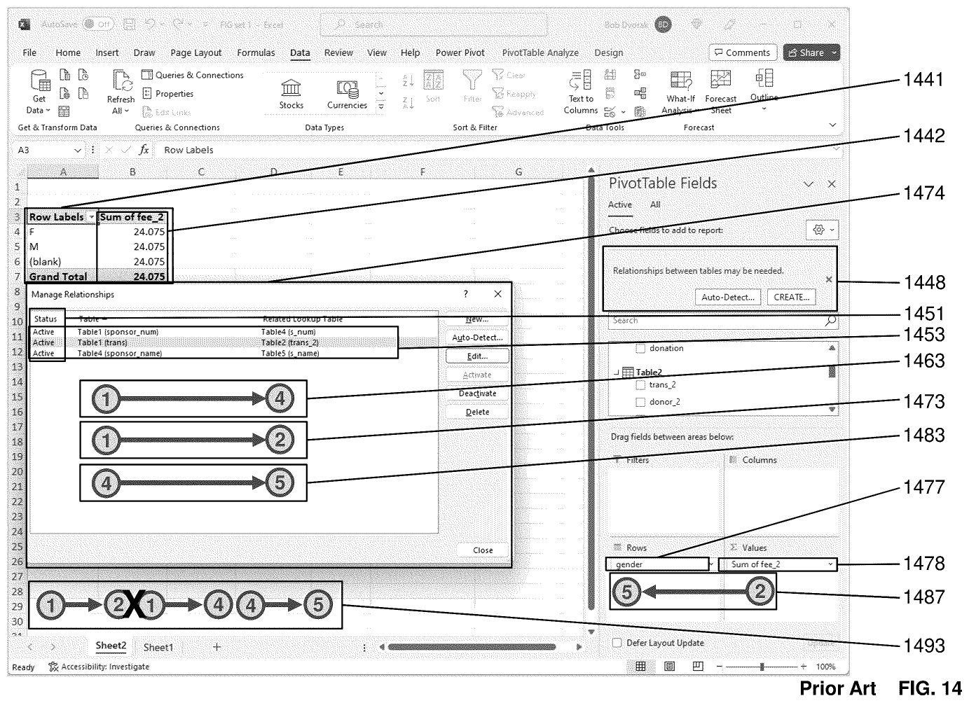

FIG. 13 and FIG. 14 examples an added complexity of the Microsoft Power Pivot PivotTable join direction alignment requirement for chained joins. Specifically, the need to make sure every join in the chain is aligned (e.g., 2 to 1, 1 to 4, and 4 to 5) because if one is misaligned (e.g., 2 to 1, 4 to 1, and 4 to 5) then the chain join does not work. FIG. 13 examples a situation where all of the joins are correctly aligned head to tail to match the PivotTable inputs. In this example needing to get the direction correct for all three joins 1353. So not only specifying the correct keys, as indicated by the color joins exampled in FIG. 6—yellow 651 to 654, blue 653 to 637, and orange 638 to 648, but putting them all in the correct directions in the ‘Manage Relationships’ setup 1374 of the joins 1353 to match the PivotTable inputs. So those directions (1363, 1373, and 1383) align head to tail 1393 to give the same direction 1387 as the PivotTable inputs (1377 and 1378). This then produces the correct (left join) result, in this example of ‘Sum of fee_2’ 1342, for each ‘gender’ joined value in the PivotTable output 1341. However, if one join 1453 is not directionally aligned (1463, 1473, and 1483) head to tail 1493 to give the same direction 1487 as the PivotTable inputs (1477 and 1478) then an incorrect Cartesian Product (not left joins) output is delivered as exampled in FIG. 14. Where the PivotTable output 1441 for the Sum of fee ‘2’ 1442, for each ‘gender’ is the Cartesian Product ‘24.075’, not the correct left chained join values. Note, again the user gets no definitive message telling them of the problem as the join shows ‘Status' Active’ 1451 although again they get the yellow box ‘Relationships between tables may be needed’ 1448 which is hard to understand because of the active status join in the ‘Manage Relationships’ popup 1474. Thus, not only making chained joins only support PivotTable inputs going one direct but also making it more complicated to set up the joins because of the need for what we are calling head to tail alignment of joins in the same direction. This is one dimension of how the Microsoft Power Pivot join set up is more difficult than it needs to be and severely limits its successful applicability. We will now example other challenges with Microsoft Excel's Power Pivot PivotTable join set up capabilities.

### Microsoft Power Pivot Lack of Proactive Incorrect Join Information and Blocking

Many of our previous examples showed the lack of clear post join set up error messaging, where instead of clearly giving the user a message of what they had done wrong they got a vague ‘Relationship between tables may be needed’ display (e.g., FIG. 7 748, FIG. 10 1048, FIG. 11 1148, and FIG. 14 1448). Those examples were in situations of join and PivotTable input misalignment, but we will now example data type and data value mismatch problems that lead to the same vague message when instead clear error messages could be generated so the use knows they made a mistake and exactly what they did wrong. More importantly we will highlight the lack of information and/or pre-emptive blocking to stop users from making these mistakes as they set up the joins.

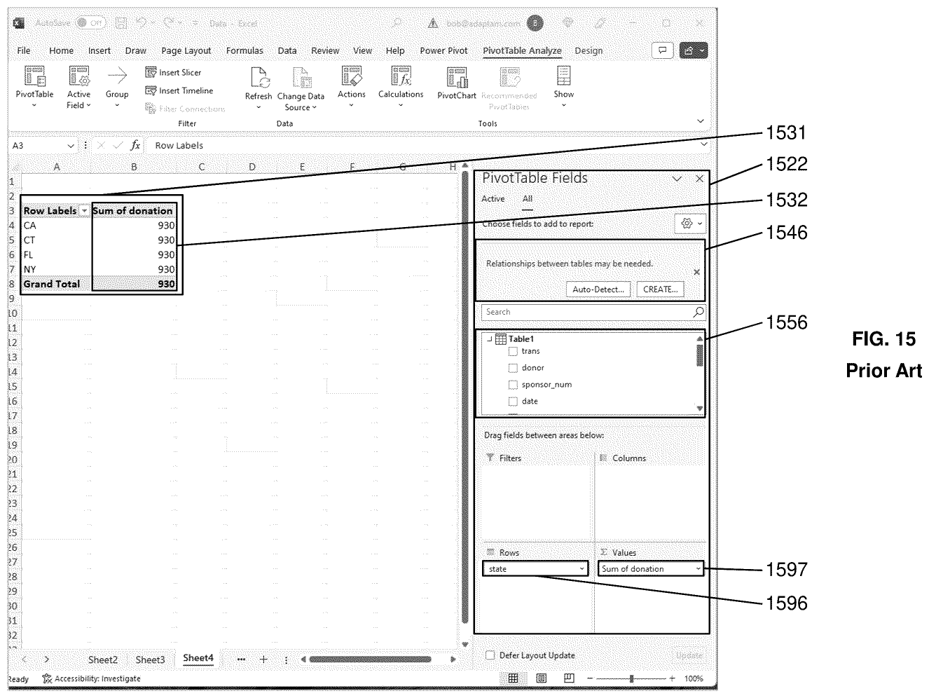

FIG. 15 examples a charity user looking to create a PivotTable summing donations by the donor's state of residence which involves the field ‘donation’ 644 from ‘Table1’ 662 and the field ‘state’ 646 from Table3’ 665 in FIG. 6. However, at this point in the example no joins have been set up between any of the data sets (the five tables in FIG. 6). In Microsoft's Power Pivot PivotTable approach the user started with access to all five of the tables in FIG. 6 which are in the Power Pivot Data Model in the selection box 1556 in FIG. 15. However, after their first selection to ‘Sum of donation’ 1597 (a field from ‘Table1’) they still had access to all the other tables despite there being no joins from “Table 1’ to the other tables. Thus, nothing stopped the user from populating the field ‘state’ 1596 despite there being no join between ‘Table1’ 662 and Table3’ 665 yet set up. Instead, the Microsoft Power Pivot PivotTable inputs 1522 of 1597 and 1596 generated a result 1531 which appears to have done a Cartesian Product of the donation values 1532 rather than giving the user an ERROR message for attempting a PivotTable with two fields lacking a join. Instead, they got a result with that same message we have seen before 1546 suggesting ‘Relationship between tables may be needed’. A clear error message stating something like “ERROR—no join exists between Table1 and Table3 seems more helpful. Then the need for the user to ‘Auto-Detect . . . ’ or ‘CREATE . . . ’ a relationship (join) then would be extremely clear. It also demonstrates that the default solution even when there are no joins set up is to generate a result which is the cartesian product of the two tables.

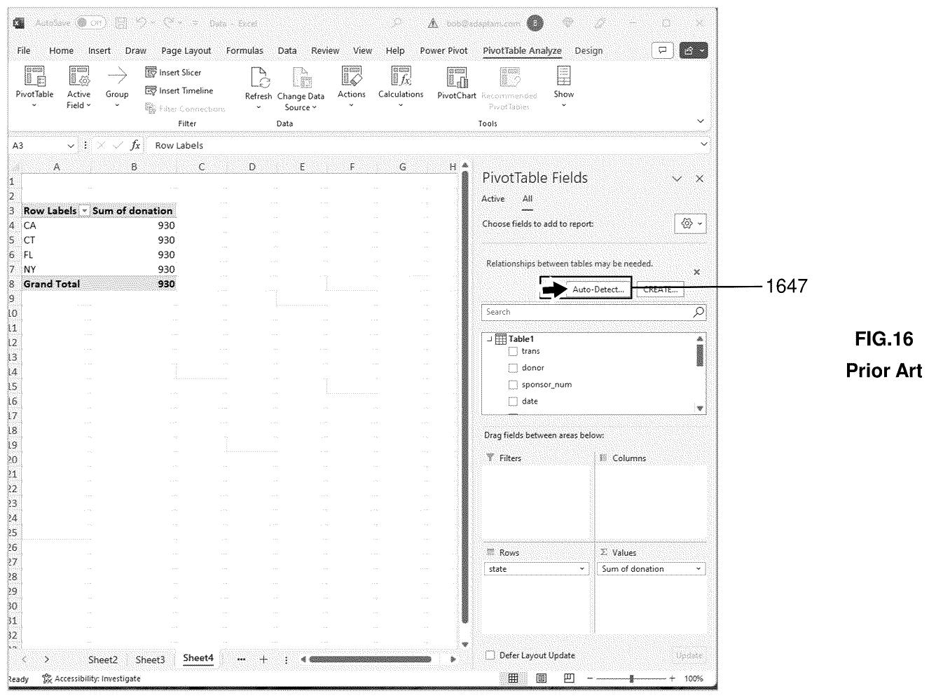

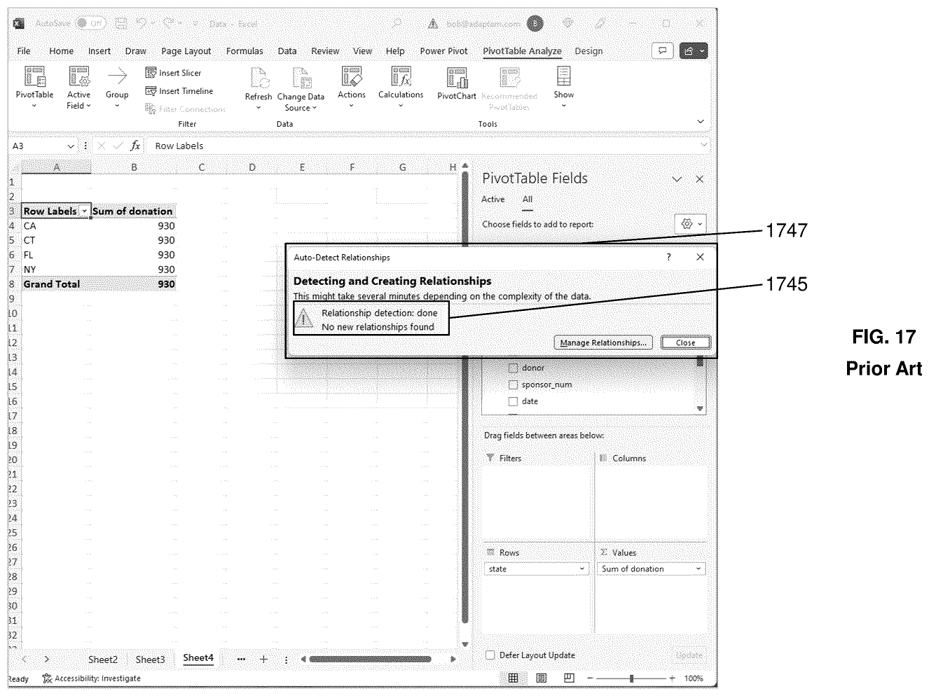

Given the pretty obvious join keys between the two tables of ‘d_num” 645 and ‘donor’ 652 (highlighted in green in FIG. 6) the user clicks the Auto-Detect . . . ’ 1647 in FIG. 16 (FIG. 15 with the click 1647 added) to get the ‘Auto-Detect Relationships popup 1747 outcome in FIG. 17. This tells the user ‘Relationship detection: done No new relationships found’ 1745. Thus, not detecting the ‘d_num” 645 and ‘donor’ 652 (highlighted in green in FIG. 6) join keys. It also did not appear to do a broader determination of potential joins in the five different tables as it did not identify any of the color-coded join key combinations (651 and 654, 652 and 645, 653 and 637, and 638 and 648 exampled in FIG. 6).

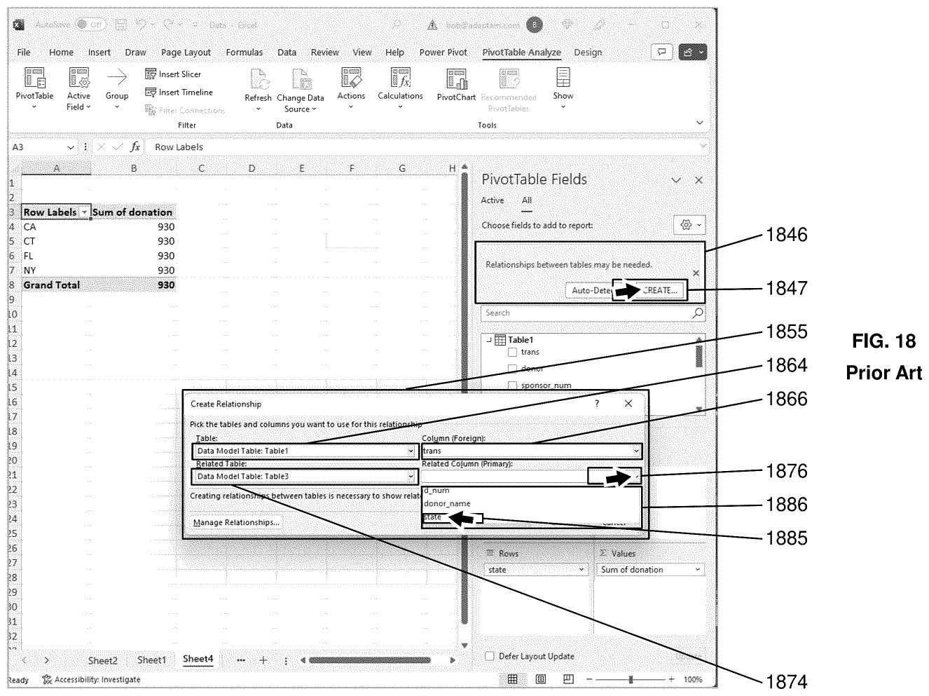

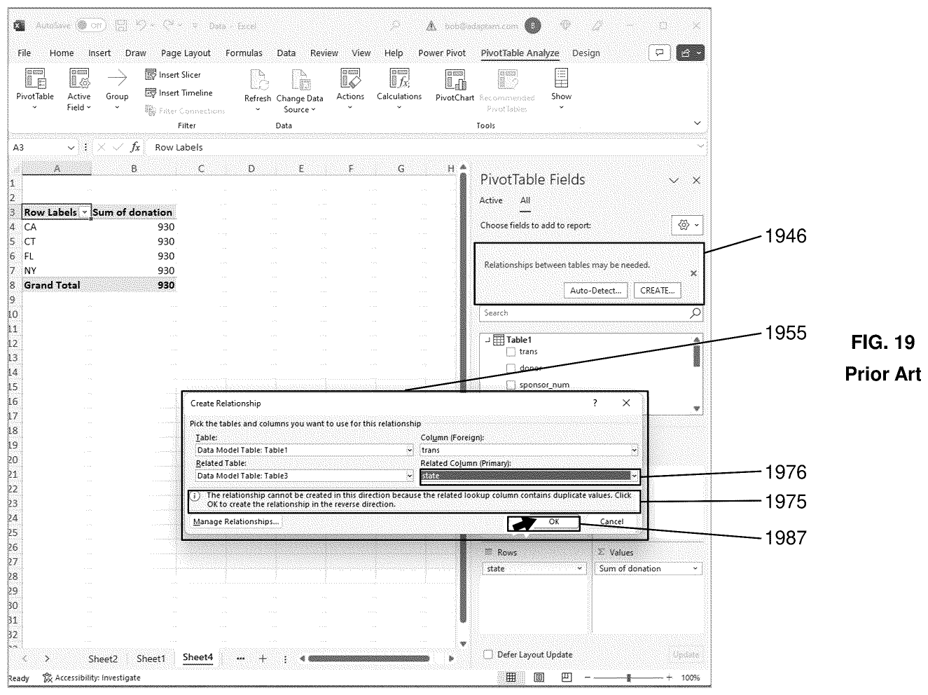

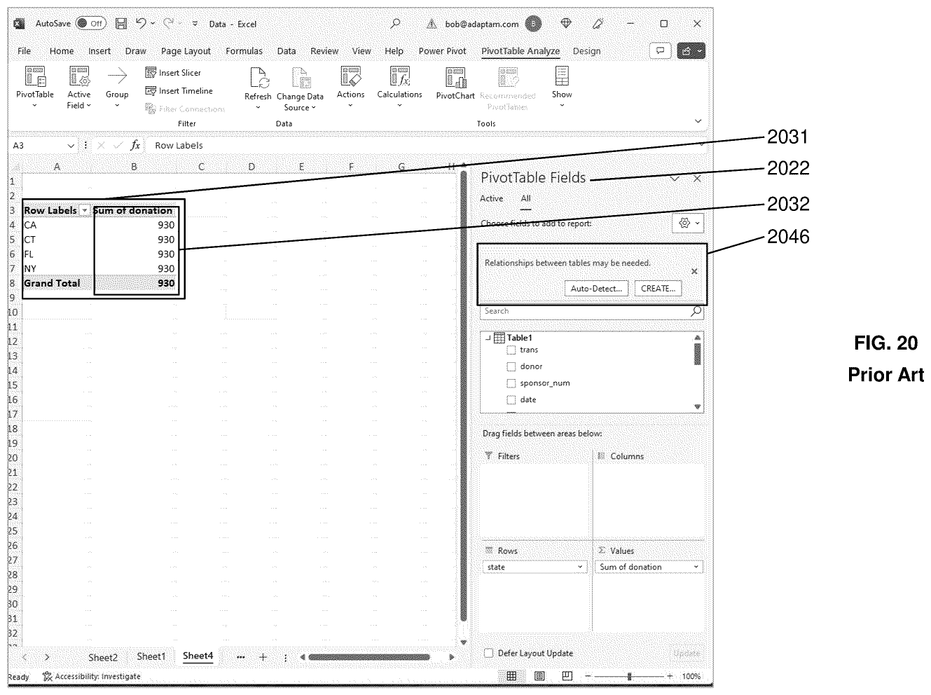

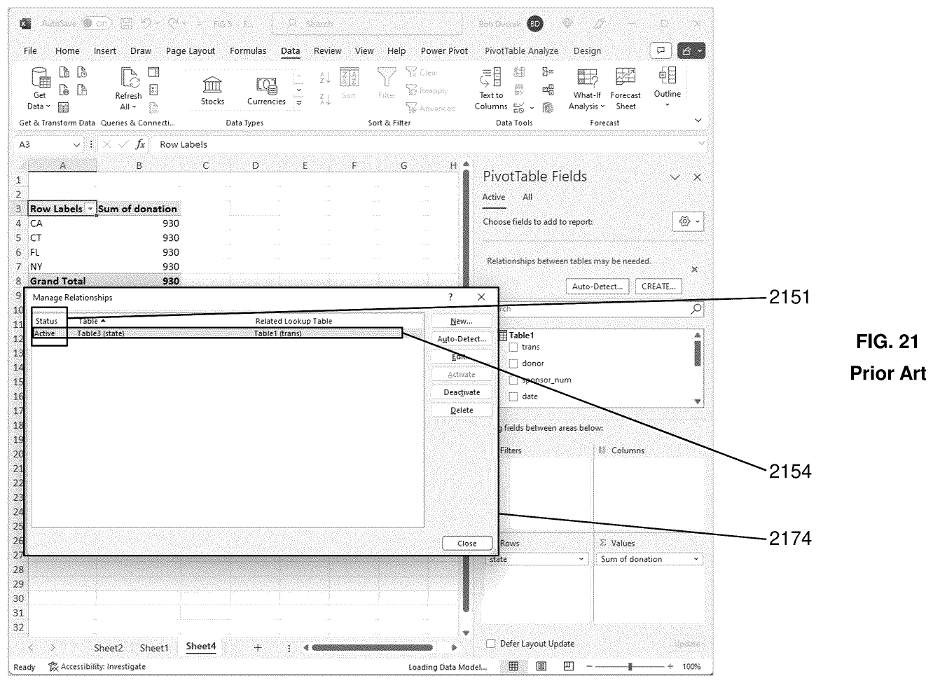

So, in FIG. 18 the user clicks the ‘CREATE . . . ’ button 1847 in the yellow ‘Relationships between tables may be needed’ box 1846 to get the ‘Create Relationship’ popup 1855. The user then starts to fill out the join keys selecting ‘Table1’ 1864 then selecting join key ‘trans’ 1866. They then select ‘Table3’ 1874 and open 1876 the second key field selection list 1886. This selection list displays all the fields in ‘Table3’ despite the fact that ‘donor_name’ and ‘state’ are a data type mismatch (with ‘trans’) and will not generate any join. It also displays ‘d_num’ which like ‘trans’ (the already selected first join key) is an integer field and therefore passes the data type match but does not pass the overlapping values test as the two fields have no values in common (see 645 has no values matching 651 in FIG. 6). So, it too will not generate any Left Outer joining between the two tables. So, Microsoft Power Pivot's joining capabilities do not stop the user from setting up joins with data type and data value mismatches and do not stop users from executing a join that will not work in those situations as exampled by the user selecting ‘state’ 1885 (as shown in 1976 in FIG. 19) and then clicking ‘OK’ 1987 in the ‘Create Relationship’ popup 1955 in FIG. 19 to generate the PivotTable result 2031 in FIG. 20. That result has not changed the apparent Cartesian Product ‘Sum of donation’ values 2032 and did not change the message 2046 (from 1946 in FIGS. 19 and 1846 in FIG. 18) suggesting ‘Relationship between tables may be needed’. Microsoft Power Pivot has not told the user they just put in an erroneous set of join keys. It also did nothing to stop the user from entering those join keys with clearly erroneous data type and data value mismatches. It did record and retain the erroneous join 2154 as shown with ‘Status’ ‘Active’ 2151 in FIG. 21 in the ‘Manage Relationships’ popup 2174. Note, the one thing Microsoft Excel did do is warn the user that the direction of the join was not allowed in ‘The relationship cannot be created in this direction because the related lookup column contains duplicate values. Click OK to create the relationship in the reverse direction’ 1975. This is due to the limitation of the primary key not having duplicate values however it was not at all concerned with the fact that the two keys were different data types as it then reversed the direction and executed the join, or in this situation a non-join join (meaning a join that does not work). That message if anything gave the user confidence that the join would then work.

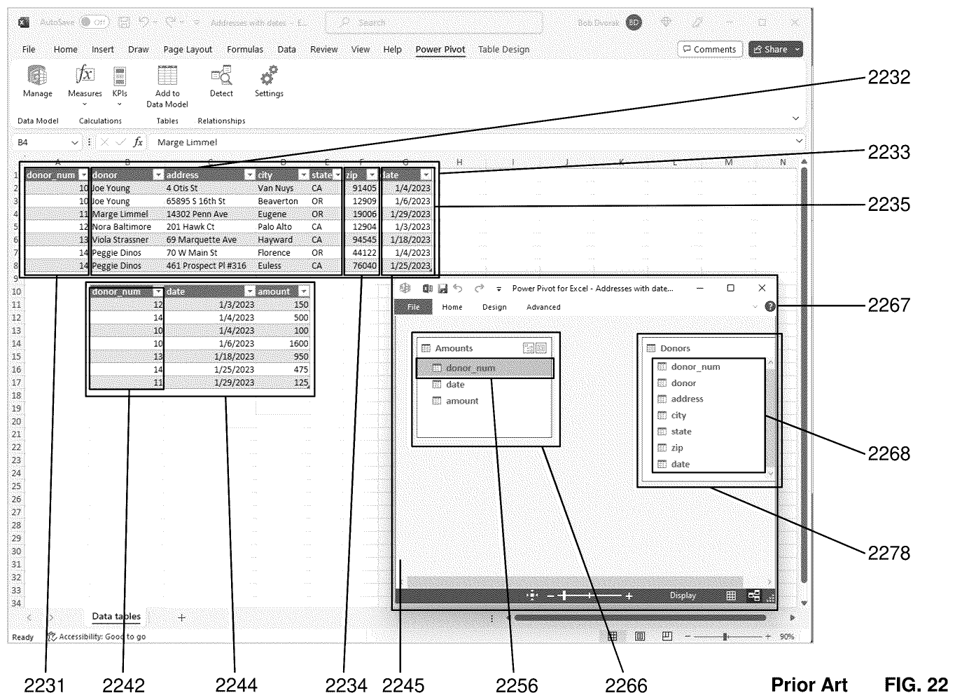

There are only three areas where Microsoft Power Pivot blocks the join after the selection, 1) many to many cardinality, 2) nulls in the primary key, and 3) a many cardinality in the primary key. We say after the selection because it offers up all the join field options within a data set, doing no screening/blocking of options that will if selected violate the Microsoft Power Pivot requirements. It is worth noting that these requirements are not SQL join requirements, as SQL will support joins violating all of these requirements, but simply Microsoft Power Pivot join requirements. FIG. 3 344 examples number 1) the many to many restriction and FIG. 22 through FIG. 24 example that the cardinality blocking happens after the selection (as described below) not pre-empting the selection. FIG. 4 455 examples the 2) nulls in the primary key and 3) a many cardinality in the primary key restrictions happening in Microsoft Power Pivot after the selection not pre-empting the user making a wrong selection.

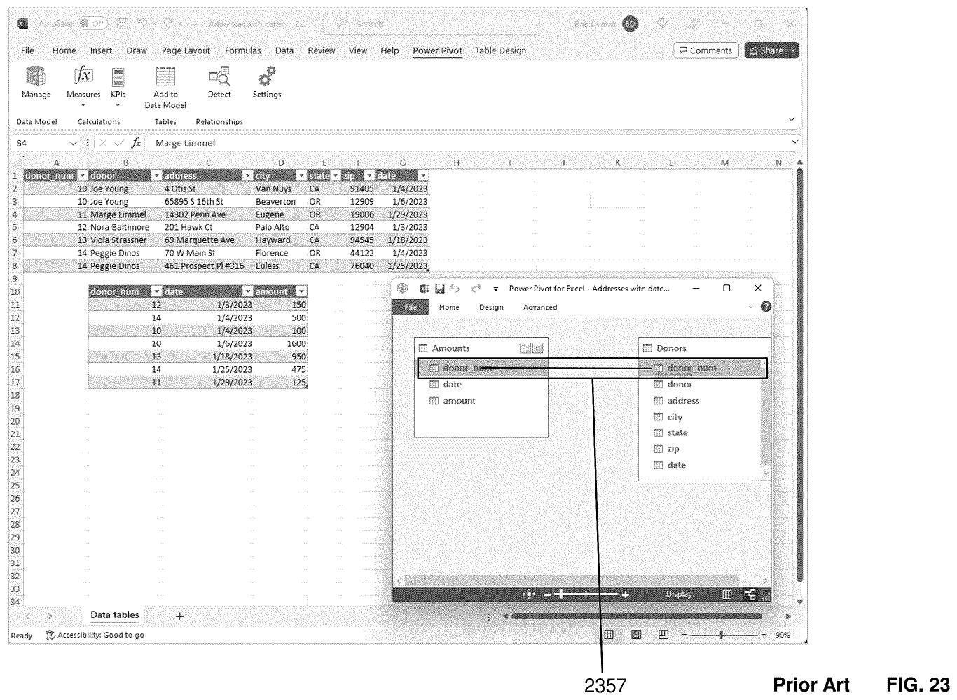

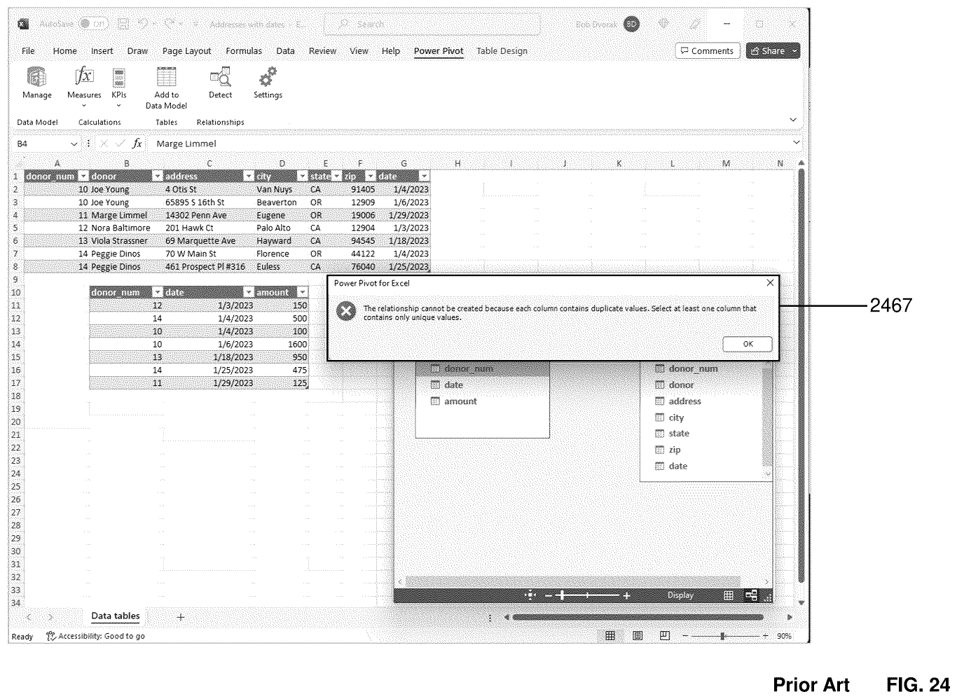

Microsoft Power Pivot has multiple UIs and ways for setting up join relationships as exampled in FIG. 22 through FIG. 24 (which uses a UI different from our previous examples), however the outcomes are the same. In this example the user has two data sets (2233 and 2244 in FIG. 22) and attempts to set up a join between two join keys ‘donor_num’ 2231 in the data set 2233 and ‘donor_num’ 2242 in data set 2244. However, the problem is that Microsoft Power Pivot will not join together two keys that are both many. When the user selects ‘donor_num’ 2256 in the selection list 2266 in the Relationship diagram 2267 there is no screening of fields 2268 in the other key selection list 2278 to eliminate those that will not work. For example, the fields ‘donor’, ‘address’, ‘city’ are text 2232 and therefore a data type mismatch (with the integers in ‘donor_num’ 2242). The field ‘date’ 2235 is a date field and therefore also a data type mismatch. The field ‘zip’ 2234 is not a data type mismatch (although in some cases could be if it were input as text) but has no overlapping values and therefore also will not join any data between the two data sets. Finally, the field ‘donor_num’ 2231 is also a many so that will not work in Power Pivot. Thus, if Microsoft Power Pivot selection lists had blocking of selections that do not work then there would be no fields 2268 left in the second selection list 2278 after the key selection of ‘donor_num’ 2256. Because Microsoft does not block invalid selections and gives the user no information pointing out they are invalid the user proceeds with the selection of ‘donor_num’ 2357 in FIG. 23. This results in the after the selection blocking of the join as exampled by the popup 2467 in FIG. 24.

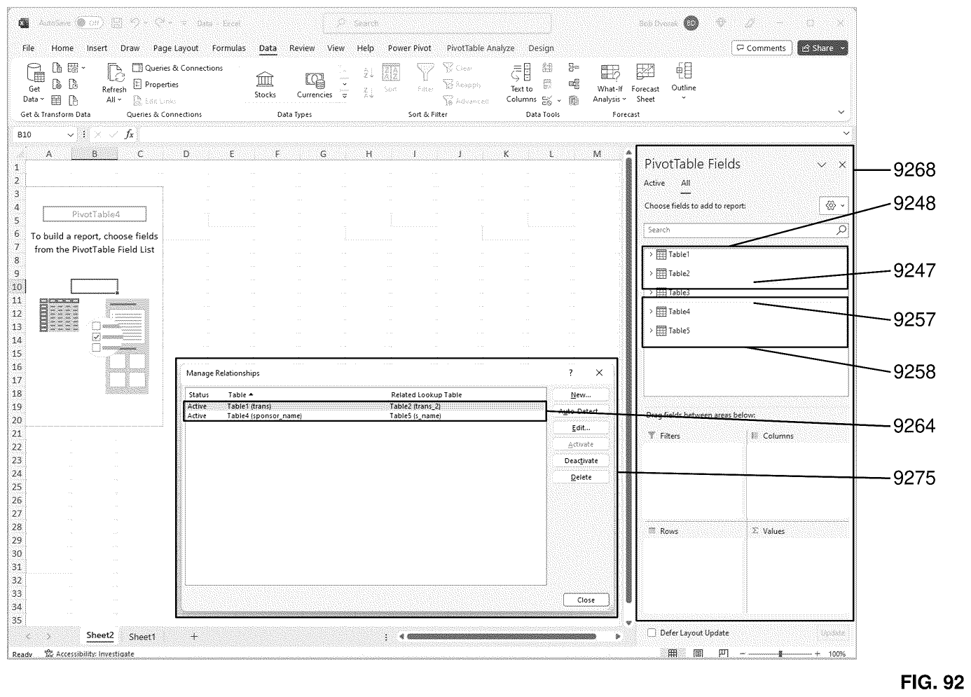

Another deficiency of the current spreadsheet display of PivotTable Table joins is its subtly in the PivotTable sidebar of indicating joins. FIG. 92 examples the two joins 9264 setup by the user in the ‘Manage Relationships’ pop-up 9275 and how they are displayed in the PowerPivot PivotTable sidebar 9268. They are shown to the user by the two light grey lines 9247 and 9257 which group together the two sets of joined tables 9248 and 9258. There is no explanation that those lines denote joined tables in the PivotTable UI but from usage observation it appears to true.

Therein lies many opportunities for our technology to better inform users about the joins they are attempting to make for their PivotTables and embodiments that go further to pre-emptively block users from making joins that that fail data type, data value, cardinality, and other join requirements. Reacting to the previous examples therein lies the opportunity in our technology to also support a much broader set of PivotTable join situations (e.g., unaligned PivotTable input joins and multiple two table joins), more key types (e.g., not requiring primary key constraints), cardinalities (e.g., many to many), and more join types (i.e., joins other than a left outer including compound key joins) as we will example.

In the interest of conciseness, the combinations of features disclosed in this application are not individually enumerated and are not repeated for each combination of features. We have not attempted to example all the different types of selection lists and input panels that our disclosed technology supports recognizing the reader can translate the exampled selection lists and input panels combining ribbons, popups, on chart inputs, and other UIs with mix and match combination. We have not exampled all the possible PivotTable output variants focusing instead on the feature and function of our technology and not the different possible output variants.

### Join Selection Improvement

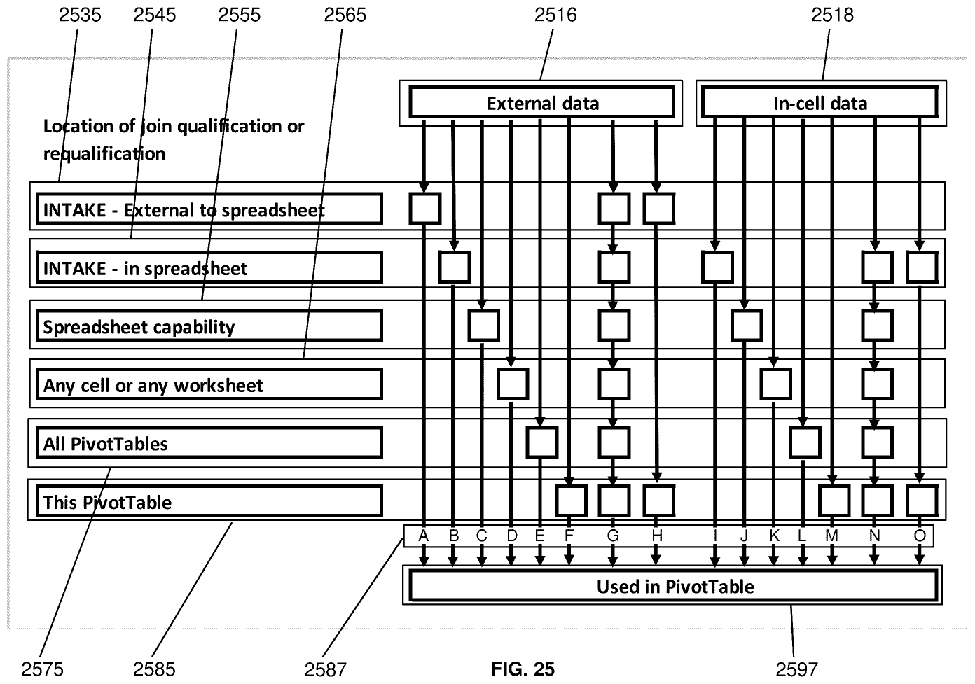

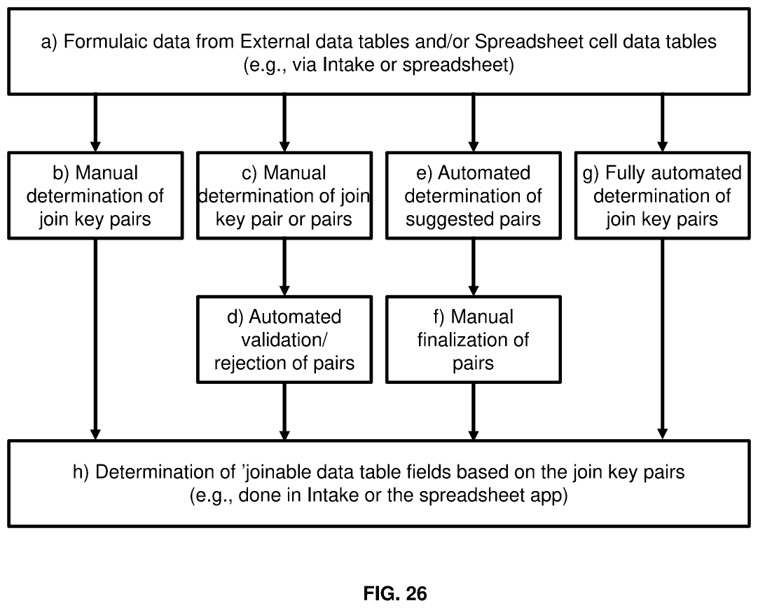

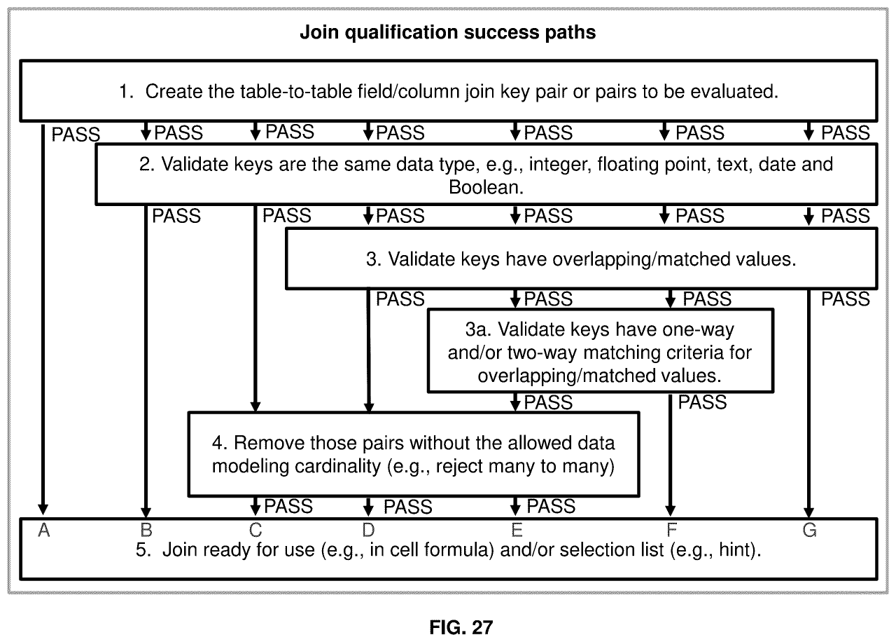

Our data set joining technology works to make it dramatically easier for users to set up joins for use within a PivotTable. It does this by better informing the user about the potential join key combinations they are considering and/or curating those selection lists to eliminate potential selections which will not result in a join between the tables bringing together values from both tables. Our technology supports the join set up in many different locations (see FIG. 25), many different ways (see FIG. 26), employing many different join validation tests (see FIG. 27), and employing data sets from many different sources (see FIG. 28A through FIG. 29B). Those external data sources can be from a large spectrum of database sources residing on the users' computer (e.g., a separate database or a database with the spreadsheet), the users' server, elsewhere in the cloud as illustratively exampled in FIG. 28A and FIG. 28B. The in-cell data sources can also use a spectrum of sources with different labelling such the three data sets (2942, 2945, and 2948) in FIG. 29A which can be used with or without the heading rows (2953) used as formulaic data field names. In the without using those our technology supports using the cell ranges. Additionally, the in-cell data can come from cell tables as exampled in FIG. 29B for the three tables 2982, 2985, and 2988 using the table headings as the formulaic data field names or some other approach replacing those names or simply using the cell ranges. We will now briefly example these so that we then do not need to example all different combinations with each of the improvements of our PivotTable data set joining set up and use capabilities.

A join setup/prequalification before the user starts their inputs into the PivotTable being created (i.e., ‘This PivotTable’ 2585), can be done in many different locations (2535, 2545, 2555, 2565, 2575, and 2585) and combinations of locations (path examples ‘A’ through ‘O’ 2587) using data from different sources (2516 and 2518 or a combination of the two) in our pivot table technology 2597 as exampled in FIG. 25. These setups/qualifications can be done in many different manual and/or automated ways as exampled in FIG. 26. Our data joining technology supports a broad range of data set joining qualification (set up and validation), from no validation (exampled in FIG. 27 path ‘A’) to extensive join key pair validation (exampled in FIG. 27 path ‘E’). Embodiments of our disclosed technology support the same or different qualification validations (e.g., paths in FIG. 27) used for joins setup in different locations (e.g., an embodiment where joins set up in ‘This PivotTable’ 2585 FIG. 25 input allows all data modelling cardinalities of single and compound key joins while joins set up before ‘this PivotTable’, e.g., 2535, 2545, 2555, 2565, and 2575 in FIG. 25, only accept unique to unique, unique to non-unique and non-unique to unique single key joins).

Our technology supports these different cardinality combination restrictions (or other restrictions) at different points of setup to potentially protect less sophisticated users from creating complicated joins that they are unlikely to understand, e.g., non-unique (“many”) to non-unique (“many”) joins and compound key joins, while still giving the sophisticated user the full set of join capabilities. Our technology also supports different levels of validation, including tests that can be helpful to everyone eliminating joins that will generate a null set or no join between the tables (e.g., not passing ‘2’ and ‘3’ in FIG. 3) and tests that are more situationally valuable (e.g., ‘3a’ or ‘4’ in FIG. 27) but not always definitively correct.

### Data Join Qualification Steps/Tests

Our disclosed technology supports many different combinations of qualification tests (see FIG. 27) for validating which data joins are doable without an error and which are presentable in selectable list for input use in a spreadsheet Pivot Table. It also supports many different acceptable test criteria for the steps ‘3a’ and ‘4’ in FIG. 27. Those outcomes can be situational in our technology, working in some situations and not working in others. For example, a combination of joins (chained/sequenced) may make two individual one to many joins an invalid non-unique to non-unique (“many to many”) join when they are chained/sequenced together and face a data modelling cardinality test rejecting non-unique to non-unique joins (i.e., accepting only unique to unique, unique to many, and many to unique joins).

FIG. 26 examples different ways of qualifying the potential for joinability in our PivotTables. A spectrum of those ways are exampled in FIG. 26 ranging from a completely manual set up (‘a/b/h’) to a fully automated set up and verification (‘a/g/h’). FIG. 26 examples a range of the ways the qualification is done with FIG. 27 exampling types of qualification tests (validations) and FIG. 25 exampling the different locations of the qualification (e.g., from data intake to within the PivotTable).

FIG. 26 starts with step ‘a’ accessing the data, that data can reside in spreadsheet cells (in-cell as exampled in FIG. 29A and FIG. 29B), can reside in non-spreadsheet cells (NSC) external data sources (e.g., databases on the same computer as the application or elsewhere in servers or other accessible storage devices as exampled in FIG. 28A and FIG. 28B respectively). Our technology supports combining data from different data sources and supports the spreadsheet located on a personal computer or a server. The data set up and connection can be done in many different ways. For example, data set up can be done by an Intake capability (as described in U.S. application Ser. No. 17/752,814 titled “Method and System for Spreadsheet Error Identification and Avoidance,”) within the spreadsheet application, or separate from it. Path ‘a/b/h’ is the most manual method relying entirely on a user (e.g., Intake) user to set up and make correct joins. At the other end of the spectrum is path ‘a/g/h’ in FIG. 26 which is a fully automated determination by our application (i.e., Intake or the spreadsheet) of valid joins applying many or all of the qualification validation tests in FIG. 27 with tie breaker logic in the event of competing joins between tables.

FIG. 26 path ‘a/c/d/h’ is a combination of human join key pair specification and our application verification of the validity of those selections. The user selects one or more data set to data set join key pairs in step ‘c’ and then in step ‘d’ our technology automatically tests the validity of each of those pairs using any of the ‘B’ through ‘G’ validation paths in FIG. 27. Once passing the validation tests the joinable key pairs can automatically finalize or be presented to the user for the final selection to the joinable list in step ‘h’.

FIG. 26 path ‘a/e/f/h’ is a different combination of the user (human) and our technology specification/validation. In step ‘e’ our technology creates all the across data set field/column join key combinations and then automatically tests the validity of each of those pairs using any of the validation paths in FIG. 27 passing the validated joins to step ‘f’ where the user decides which should be used to create the joinable list in step ‘h’. The user therefore has the final decision on whether a join is or is not added to joinable list. That joinable list sets a join qualification flag in our technology that then is used to enable visibility of the joinable fields in our selection lists (e.g., hints) and/or enable the PivotTable to join the data sets and use the joined data in executing the PivotTable.

As mentioned previously, our technology has the ability to have different join set up/qualification flag validation criteria for the selection lists and the formula error creation. As well as our technology can support different join set up/qualification flag validation criteria for the selection lists based on changes in the qualification done in different locations within our technology. This will be exampled in detail later, for a situation where the joins supported differ by where the joins set up. Where Intake qualification set join flags support data modelling cardinalities of unique to unique, unique to non-unique, and non-unique to unique only and joins set up within the PivotTable UI accepts all data modelling cardinalities. So, the user will see in selection lists the joinable data sets that are qualified with unique to unique and unique to non-unique joins (and vice versa) but can manually populate joins and fields that are non-unique to non-unique in the PivotTable joins specifier in the PivotTable input panel (or a related input panel) and have them execute successfully. Our technology even has a capability that after the manual creation of that non-unique to non-unique join to change the selection list flag so those joinable fields will become visible in the selection lists. Thus, our technology gives a breadth of flexibility in setting the qualification of joinable fields within the application.

FIG. 26 path ‘a/g/h’ is the most automated path where our Intake or spreadsheet application automatically creates all the across data set field/column join key combinations and then automatically tests the validity of each of those pairs using any of the validation paths in FIG. 27 passing the validated joins to step ‘h’ where all the validated join key joins are turned into joinable fields for use in the Pivot Table and joinable data selection lists (e.g., hints). This fully automated join qualification flag setting can be done within our spreadsheet application or prior to it in a data intake application. Note, in situations where there are more than one competing join key for the same join (which are truly competing joins not double or multiple joins as will be described later) our technology can determine which to employ for the qualification flag.

### Example Intelligent Join Intake UIs

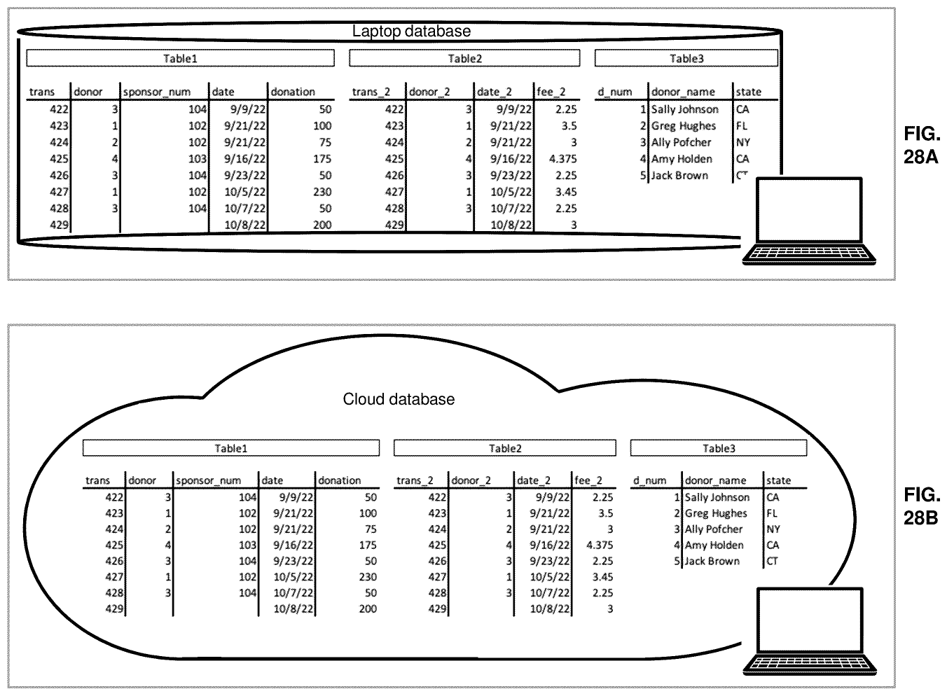

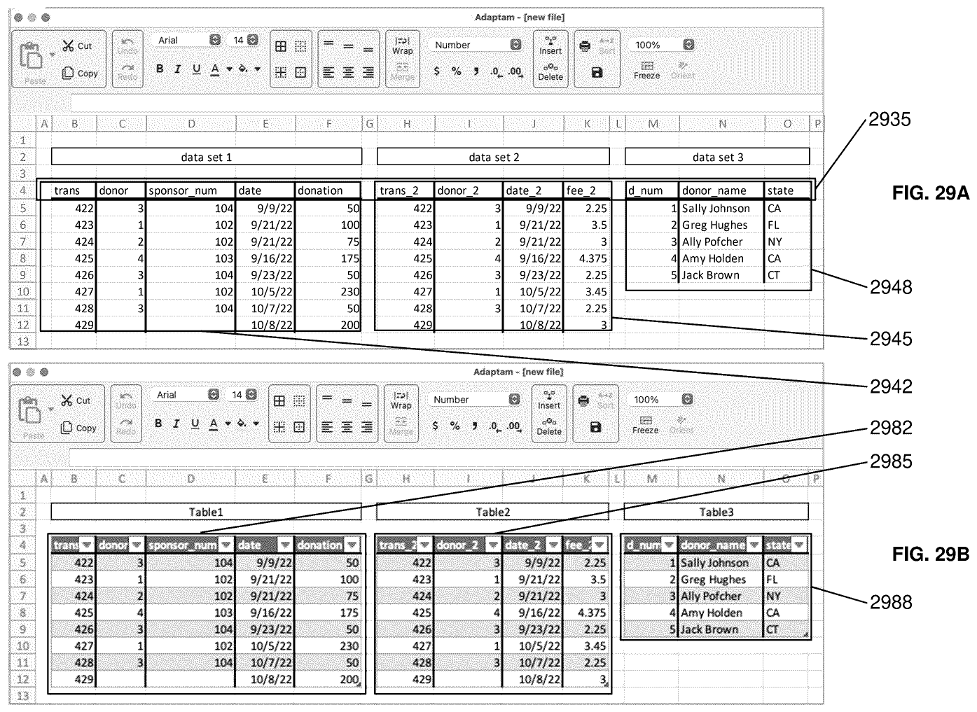

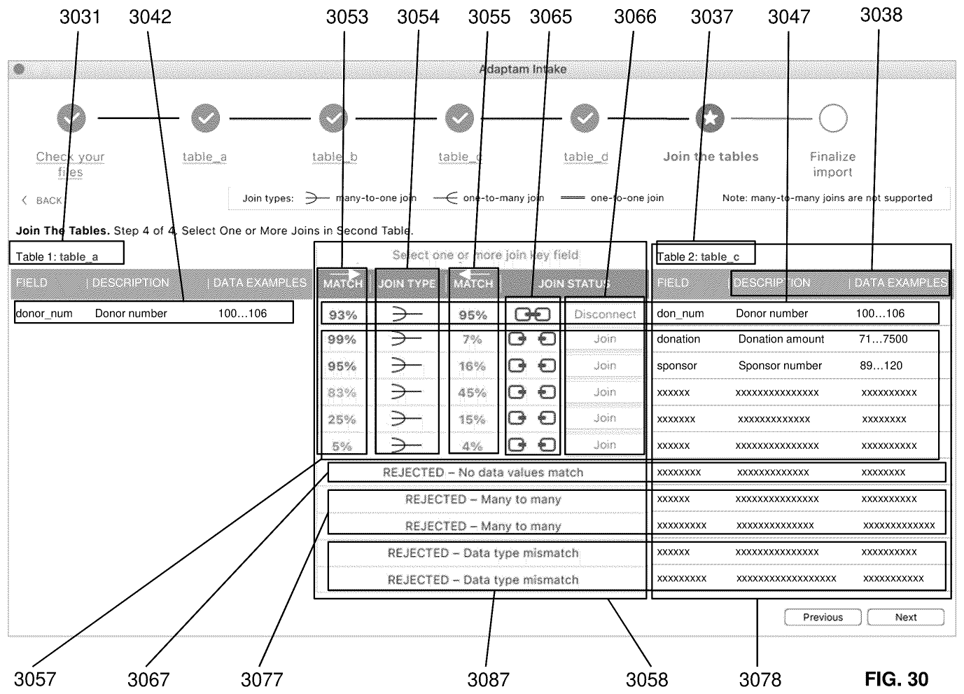

There are additional mix and match combinations of manual and automated join qualification, such as that exampled in FIG. 30, where the user specifies the first data set 3031 and its join key 3042 and the second data set 3037. Our technology then automatically screens all the fields in the second data set against the join validation criteria, in this example path ‘D’ in FIG. 27 with a data cardinality criteria of accepting only unique to unique and unique to non-unique (and vice versa). This embodiment presents the information on each potential join key match between one data set and one field and entire other data set. It gives the user extensive information 3058 on each potential join key combination and automatically rejects all the fields not passing the validation tests. In this embodiment it rejects all the fields/columns that that result in a many to many cardinality 3077 (a situationally specified rule). It also rejects fields/columns that result in a ‘Data type mismatch’ 3087 and fields/columns with no value matches 3067. The rest 3057/3047 are presented with matching (3053 and 3055) and join type information (3054) for the user to make the final decision on what field/column (if any) becomes the key (in this example ‘don_num’ 3047). Thereby exampling a manual then automated then manual way of arriving at the join keys.

FIG. 30 also examples one join qualification UI which is shown here as an external or within the spreadsheet Intake tool. However, its elements can be utilized in other situations (e.g., spreadsheet, worksheet or PivotTable join set up) and with different qualification validation tests. In this example the user has specified a data set ‘table_a’ 3031 and join key field/column ‘donor_num’ 3042 and the second join key data set ‘table_c’ 3037 and our application populates all the additional information. This example is a UI for FIG. 27 path ‘D’ validating every field (FIG. 27 step ‘1.’) in data set ‘table_c’ 3078 relative to the join key field ‘donor_num’ 3042 in ‘table_a’ 3031, Fields/columns in ‘table_c’ are rejected based on data type mismatches 3087 (FIG. 27 step ‘2.’). Fields/columns in ‘table_c’ are rejected based on no overlapping/match values 3067 (FIG. 27 step ‘3.’). Fields/columns in ‘table_c’ are rejected based on a data modelling cardinality rule 3077 (FIG. 27 step ‘4.’) which in this example is rejecting many to many cardinalities. Finally, users are given color coded one-way 3053 and two-way 3055 match values as there is no FIG. 27 step ‘3a.’ rejection criteria (e.g., a minimum percentage). Users are also automatically given helpful information such as the field/column data descriptions and data examples 3038 and the data modelling cardinality 3054 of the potential join. The UI also makes it easy for users to make a selection with join/disconnect buttons 3066 and easy to see status icons 3065. We provide to users the information they need to make a join decision and/or to understand an automated decision or suggestion. This capability pre-emptively stops user from setting up joins that will create no join of data between the two data sets (e.g., key data type mismatches and key data value mismatches) and pre-emptively stops users from setting up joins disallowed by the embodiment (e.g., key many to many joins). This UI also makes it easy for users to set up multiple joins active simultaneously between two data sets, a join capability we will describe later.

### Other Example Intelligent Join Set Up UIs

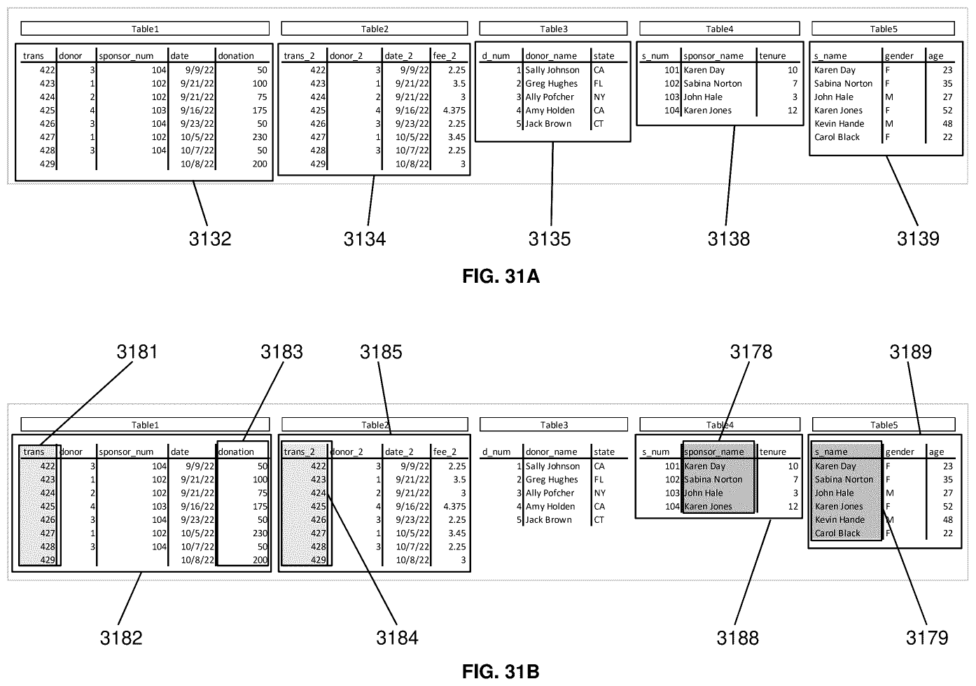

FIG. 31A through FIG. 37 examples different join setup UI variants with different combinations of join key information presented to the user, different levels of option blocking (e.g., from none to blocking all unsuccessful join options) and different join type options (e.g., beyond just the left outer join). Note, this is within a spreadsheet app which has a join capability for spreadsheet formulas as per U.S. Provisional Patent Application No. 63/525,138, and a join capability for spreadsheet visualizers as per U.S. Provisional Application No. 63/529,135, titled “Methods and Systems for Specifying and Using Joins Between Data Sets In A Spreadsheet Data Visualizer,” filed 5 Jul. 2023, which are incorporated by reference above. The spreadsheet wide setup of joins would apply to all the PivotTables within the spreadsheet with worksheet specific set ups applying to any PivotTable within that worksheet.

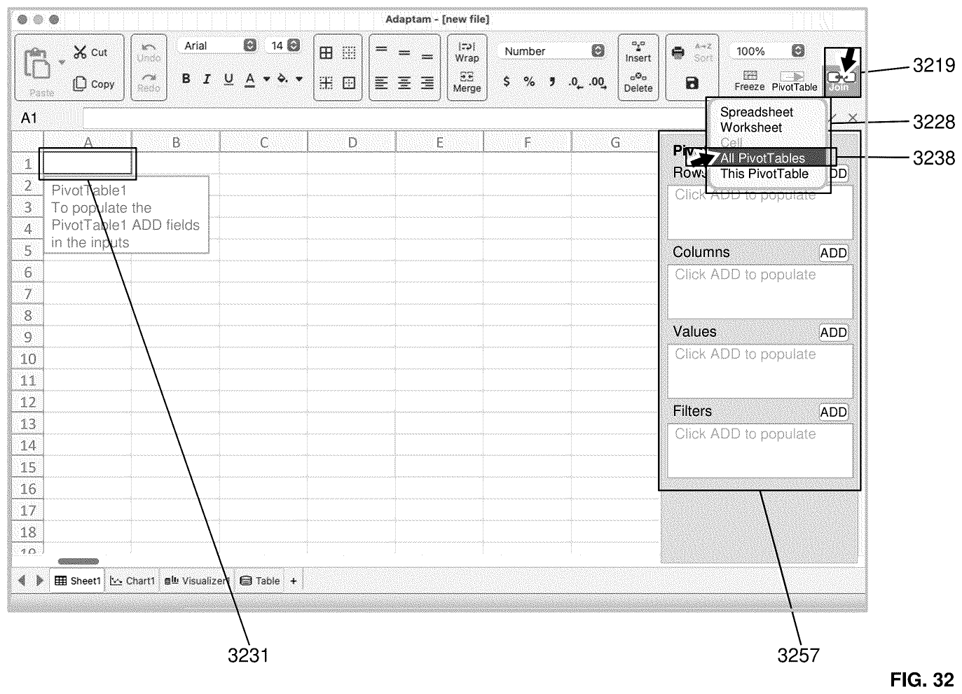

FIG. 31A examples the five data sets (3132, 3134, 3135, 3138, and 3139) available to the user in the examples in FIG. 32 through FIG. 37. FIG. 31B visually examples the user desired join keys (3178 and 3179 in orange) between the two data sets ‘Table4’ 3188 and Table5’ 3189. In this example the user has just begun to setup a PivotTable and realizes that they will want data from two different data sets that do not have a join already set up. They trigger setting up the join by clicking a ‘Join’ button 3219 in FIG. 32 on the spreadsheet ribbon. However, they could have just as easily triggered that from a spreadsheet menu selection or some other method. In this embodiment this opens a dropdown selector 3228 which allows the user to decide the scope of applicability of the join they are about to set up, namely ‘Spreadsheet’ wide, this ‘Worksheet’ wide, ‘All PivotTables’ or ‘This PivotTable’. The ‘Cell’ option is disabled because the highlighted cell ‘A1’ 3231 is a PivotTable with the PivotTable specialized set up 3257 not a regular spreadsheet cell. In this example the charity user selects the ‘All Pivot Tables’ 3238 option but could have easily selected any of the other active options, all of which would apply to this PivotTable.

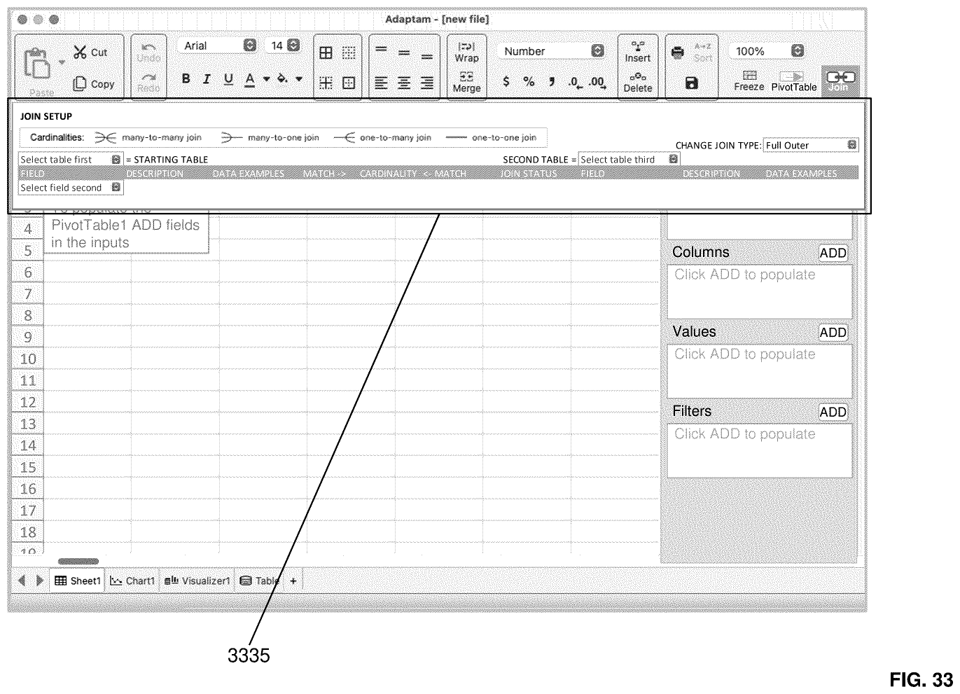

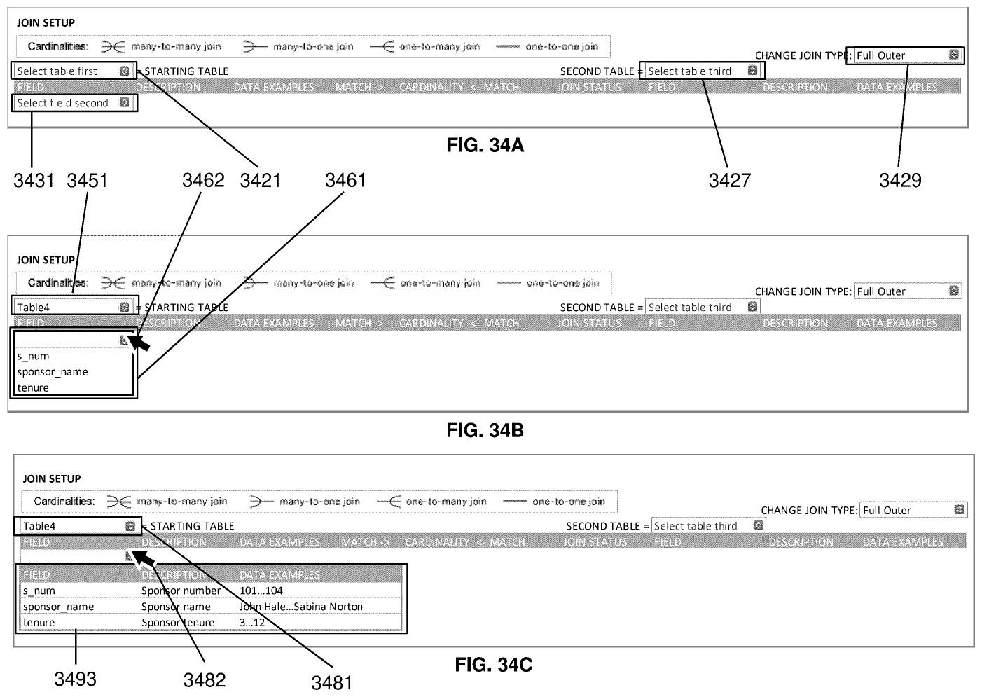

In this embodiment the click 3238 opens the “JOIN SETUP’ UI 3335 in FIG. 33. Where the user has three required inputs and one optional ‘CHANGE JOIN TYPE’ set up input as exampled in FIG. 34A. The first input 3421 supports selection of the first data set, the second input 3431 supports selection of the join key field for the first data set. The third input 3427 supports the selection of the other (second) data set to be joined. The fourth selection ‘AHANGE JOIN TYPE’ ‘Full Outer’ selection 3429, visible at this point, is the type of join to be done. In this embodiment it has a default setting of a ‘Full Outer’ join and if that is OK requires no change. However, as we will example later it gives the user the option to select a different join type (e.g., Inner, Left Outer or Right Outer). In different embodiments of our technology these inputs have different levels of intelligence and informative information. At their simplest they take typed input. Or they can be an intelligent dropdown or popup selector that lists only the applicable options. So, for example the first table selection 3421 would list only the data set (tables) available to the user. A more informative embodiment for example would have a selection list with the table name, the table description, its number of fields and its number of rows. Selection lists like those in our U.S. application Ser. No. 17/752,814 titled “Method and System for Spreadsheet Error Identification and Avoidance,” filed 24 May 2022. FIG. 34B examples a very simple selection list 3461 for the first join key input opened when the user clicks the selector button 3462. That selector list 3461 displays only the fields in the first table selected ‘Table4’ 3451. While FIG. 34C examples a more informative embodiment that when clicked 3482 displays the fields in the first table selected ‘Table4’ 3481 but also gives a ‘DESCRIPTION’ and ‘DATA EXAMPLES’ for each field in the selector list 3493 to better inform the user as to the data in the join key field they may select.

### Invalid Join Selection Screening and Blocking

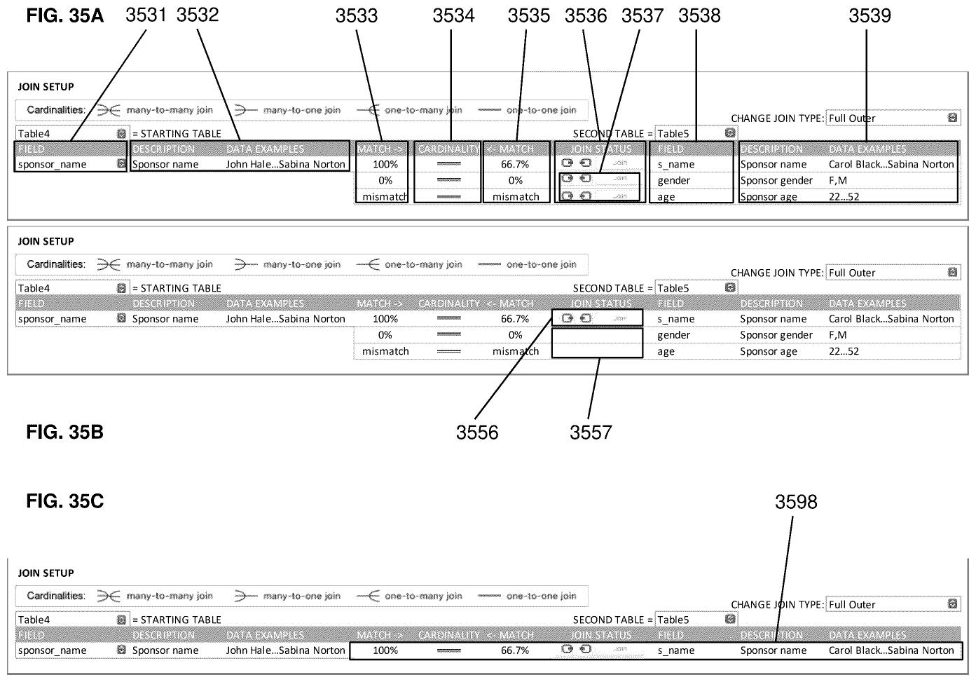

FIG. 35A examples an embodiment that not only gives the ‘DESCRIPTION’ of each field and their ‘DATA EXAMPLES’ 3539 for each potential ‘SECOND TABLE’ join key field 3538 but also gives helpful match (3533 and 3535) and cardinality 3534 information for the potential join. The embodiment exampled in FIG. 35A gives the user ‘DESCRIPTION’ and ‘DATA EXAMPLES’ information 3532 on the starting join key 3531 but does not eliminate options that do not work (giving ‘Join’ buttons for each potential join 3536). The embodiment in FIG. 35B not only provides both types of information (join key info and join info) but eliminates the ‘Join’ buttons 3557 (in contrast to 3537) for those joins which will not work because of data type or data value mismatches (leaving only the ‘Join’ button 3556 for those joins that will actually join data from both tables). The embodiment in FIG. 35C goes one step further and totally eliminates from visibility in the selection list the potential joins that will not work because of data type or data value mismatches thus leaving only the one potential join key field 3598 in this example.

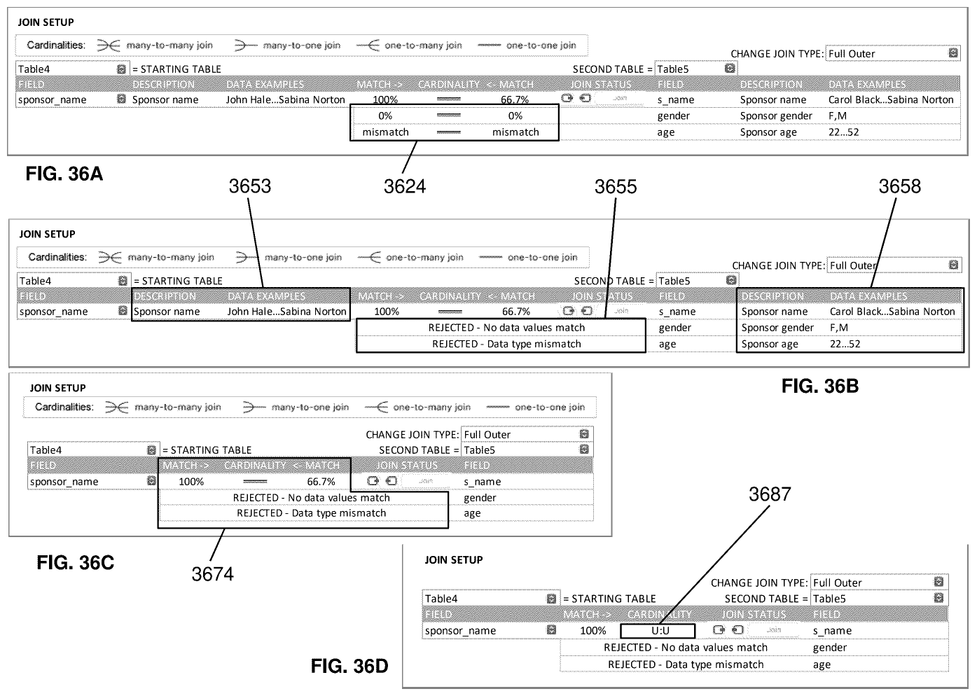

Our technology supports selection join key selection lists providing various levels of join key info, join info, and screening/blocking of data type or data value mismatches. Our technology also supports that screening/blocking extending to unacceptable cardinalities (as set by the application or a user) as exampled in FIG. 30 3077. Our technology supports, in different embodiments, different levels and variations of the join key and/or join info and different ways of implementing the invalid join screening/blocking as exampled in FIG. 36A through FIG. 36D.

### Invalid Join Selection Info Types

FIG. 36A examples the embodiment in FIG. 35B as a starting point for embodiment versions or variants with different ways of displaying the information of different amounts of information. FIG. 36B examples a variant of the embodiment in FIG. 36A where the data type and data value mismatch join information 3655 in FIG. 36B is presented in a different manner (versus 3624 in FIG. 36A), explaining why those join key field candidates are blocked (‘REJECTED’). FIG. 36C examples an embodiment where the join key ‘DESCRIPTION’ and ‘DATA EXAMPLES’ info is omitted (3653 and 3658 in FIG. 36B) but all the join info 3674 is presented to the user. FIG. 36D examples a variant of the embodiment in FIG. 35C where the ‘CARDINALITY’ info is presented in less graphic and more precise manner (e.g., ‘U:U’ 3687 where unique to unique is differentiated from the pure one-to-one ‘1:1’). Note, sometimes for simplicity of communication relative to standard convention a one-to-one join is used to mean unique to unique and not limited to what we have called a pure one-to-one join. We could continue to example different ways to display the join key info, join info, and screening or blocking of mismatches, but instead will move on to exampling the different join types supported by our technology.

### Join Types

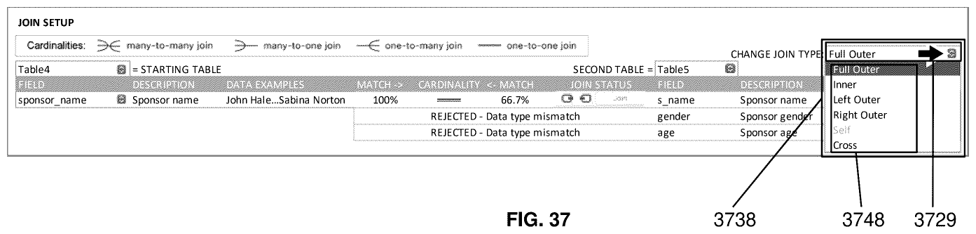

FIG. 37 examples some of the join types supported by our technology. As we will example later each of those join types 3748 work for any direction of the inputs in the PivotTable inputs (e.g., Values, Rows, Columns, and Filters). In this example embodiment the user accesses the list by clicking the button 3729 to get a dropdown selection list 3738. This selection could be done elsewhere and with different lists of join types but rather than further exampling that we will move onto exampling how our PivotTable technology supports the use of those set up/qualified joins. We will example how the joinable fields in our technology exhibit more information and screening/blocking in order to help the users avoid selections they do not want to make (e.g., because of lacking information) and selections that will not work (because those selections are presented to them despite the fact they will not work to join data across the datasets).

### More Intelligent PivotTable Field Selection Lists

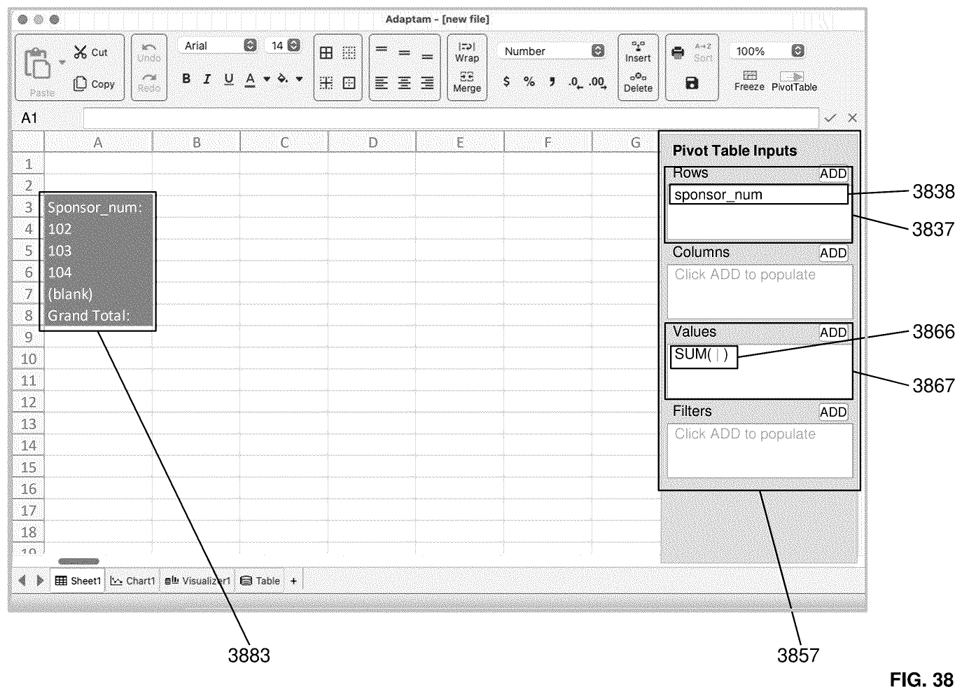

FIG. 38 through FIG. 42B example one PivotTable join setup via a number of different more intelligent PivotTable field selection lists working successfully for a join in our technology when the join and the PivotTable inputs are misaligned. That join is for the data sets exampled in FIG. 31A and FIG. 31B with only the join of ‘Table 1’ 3182 in FIG. 31B and ‘Table2’ 3185 in FIG. 31B qualified (set up) via the join keys ‘trans’ 3181 and ‘trans_2’ 3184 color coded yellow. So, the orange join 3178/3179 for the data sets 3188/3189 in FIG. 31B has not been set up.

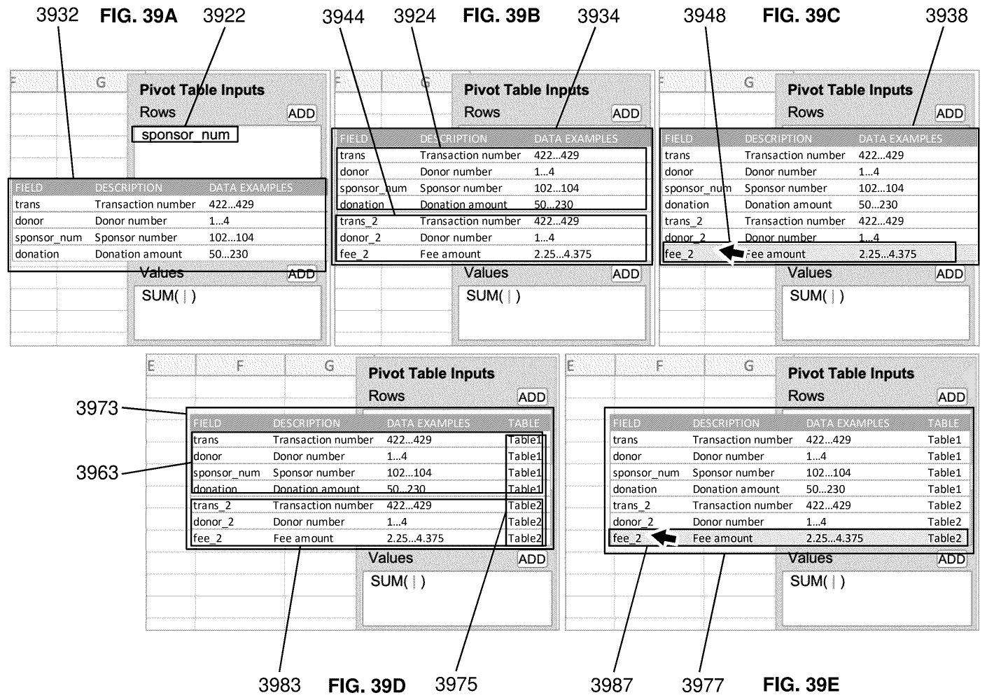

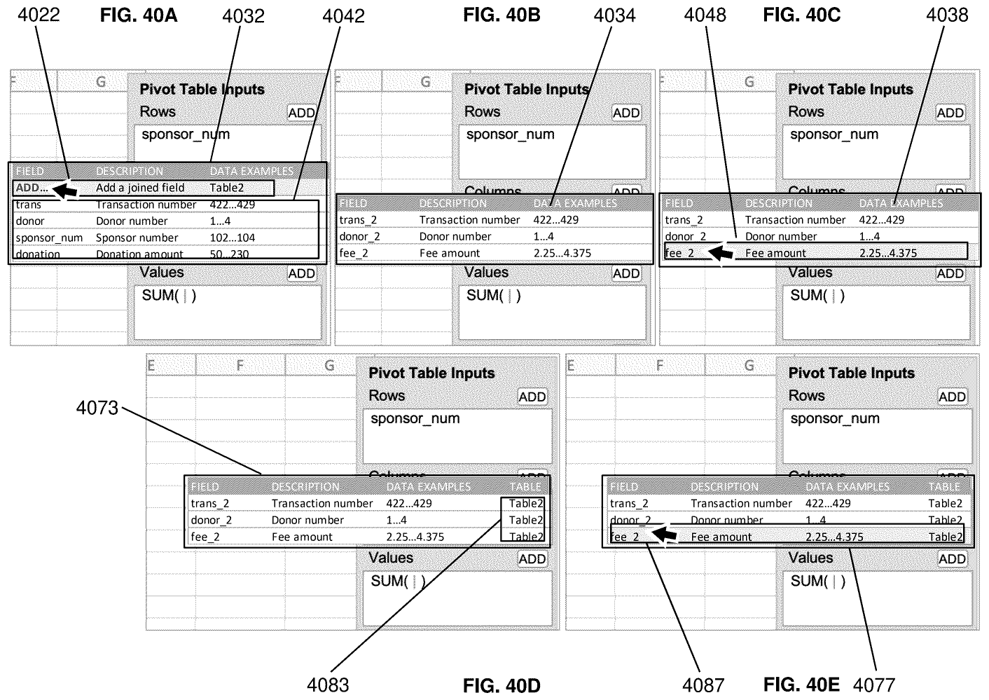

FIG. 38 examples a charity user starting to successfully create a PivotTable displaying the total fee amount (in this example ‘fee_2’ from ‘Table2’ 3185 in FIG. 31B) from the donations by sponsor (in this example ‘sponsor_num’ from ‘Table 1’ 3182 in FIG. 31B) in our technology which was unsuccessfully done in the Microsoft Excel Power Pivot PivotTable in FIG. 7. This will involve using data from both ‘Table 1’ 3182 in FIG. 31B and ‘Table2’ 3185 in FIG. 31B which our technology successfully joins whether the join and PivotTable inputs are aligned or misaligned. But before we example that successful misaligned PivotTable we will example the more informative selection lists which present more information and do not present join options that have not been set up (qualified). In FIG. 38 the user has already inputted ‘sponsor_num’ 3838 into the PivotTable input 3857 ‘Rows’ input 3837 with the result 3883. They have started to input a ‘SUM’ formula 3866 into the ‘Values’ input 3867. Rather than exampling just one selection list that automatically triggers, we will example some different embodiment options in FIG. 39B, FIG. 39D, and FIG. 40A.

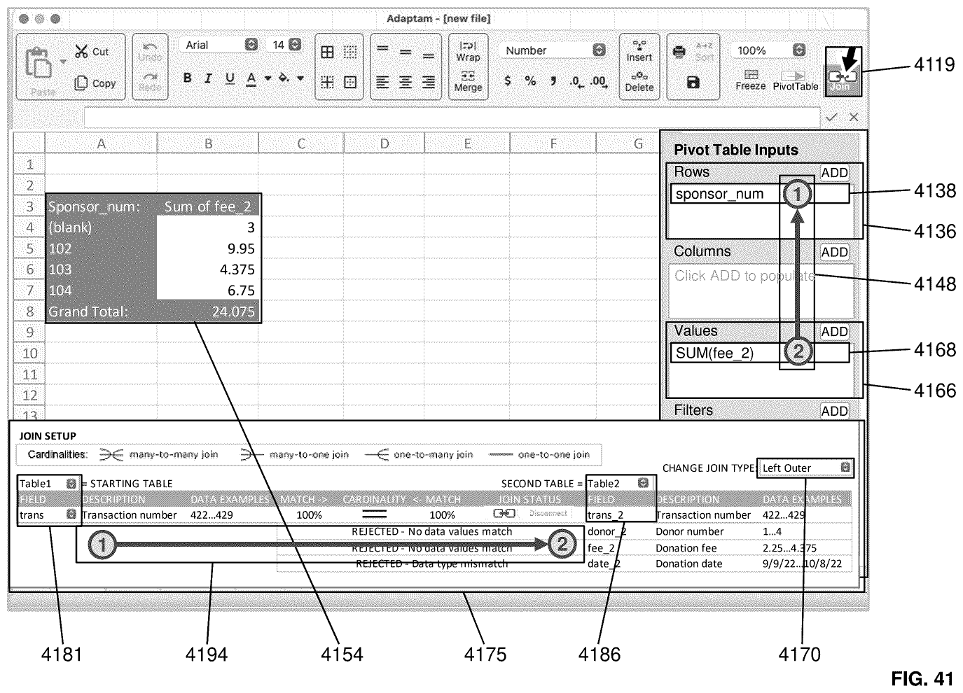

FIG. 39A examples an embodiment of our technology had there been no joins to the data set within which the field ‘sponsor_num’ 3922 resides (‘Table 1’ 3182 in FIG. 31B). However, because of the join between ‘Table1’ where ‘sponsor_num’ 3922 resides and ‘Table2’ the applicable fields from ‘Table2’ 3944 automatically show up with the fields from ‘Table1’ 3924 in the selection list 3934 as exampled in FIG. 39B. This embodiment displays all the joinable fields in a single selection list and in this situation, we say applicable joinable fields as the ‘SUM’ function limits the fields to only the numeric fields. FIG. 39D examples another variant of this single list embodiment where the selection list 3973 displays both fields from ‘Table1’ 3963 and ‘Table2’ 3983 with their respective ‘Table1’ and ‘Table2’ 3975 listings to give the user further information on what data is from where data set wise. In either situation the user sees the field ‘fee_2’ (3948 in FIG. 39C and 3987 in FIG. 39E) they want in the selection list (3938 in FIG. 39C and 3977 in FIG. 39E) and clicks it (3948 in FIG. 39C and 3987 in FIG. 39E) to complete the PivotTable in FIG. 41.

FIG. 40A through FIG. 40E examples alternative embodiments of our more intelligent PivotTable selection lists where the user instead of getting all the successfully joinable fields in a single selection gives access to them in successive lists. This embodiment is more helpful in situations where there are numerous fields in each data set and therefore it is easier to see the lists a table at a time.

FIG. 40A examples the selection list 4032 triggered by populating or typing the ‘SUM( )’ input 3866 in the PivotTable inputs 3857 in FIG. 3857. It not only shows the applicable fields/columns 4042 in ‘Table1’ (numeric fields because of ‘SUM’), but also a selection ‘ADD . . . ’ ‘Add a joinable field’ ‘Table2’ 4022 from another table that gives access to the applicable fields in the joinable ‘Table2’. Note, this embodiment like the others says applicable fields/columns because depending on where and how the selection is being used the fields/columns can be limited (e.g., field reuse in other inputs limited or data type limited by use within a function as is the situation here with ‘SUM’). Returning to this specific example, the user then clicks the ‘ADD . . . ’ 4022 selection which then automatically opens the selection list 4034 in FIG. 40B. That selection list 4034 displays all the numeric fields/columns in ‘Table2’. The user then sees the field/column ‘fee_2’ 4048 in the selection popup 4038 in FIG. 40C that they want and clicks it to join the data and move on to delivering the chart in FIG. 41. This set of selection lists displays the ‘DESCRIPTION’ and ‘DATA EXAMPLES’ information to help inform the user in their field/column selections. Another UI variant of this embodiment is exampled in FIG. 40D where the selection list 4073 was triggered by clicking the ‘ADD . . . ’ 4022 in FIG. 40A. This selection list 4073 also contains the ‘TABLE’ ‘Table2’ listings 4083 beside each ‘FIELD’. ‘DESCRIPTION’ and ‘DATA EXAMPLES’. With this additional information supplied to better inform the user in their field/column selection. As in the previous example, the user can cause the join of the two tables they desired by clicking the field/column ‘fee_2’ 4087 in the selection list 4077 in FIG. 40E to deliver the chart in FIG. 41.

### No Need for Directional Alignment—Two Data Set Joins

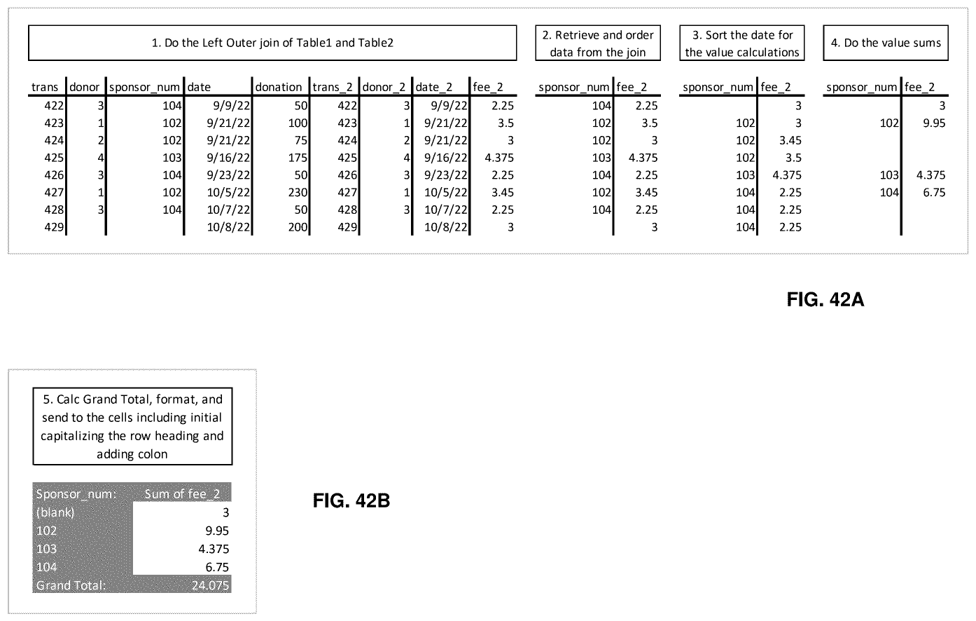

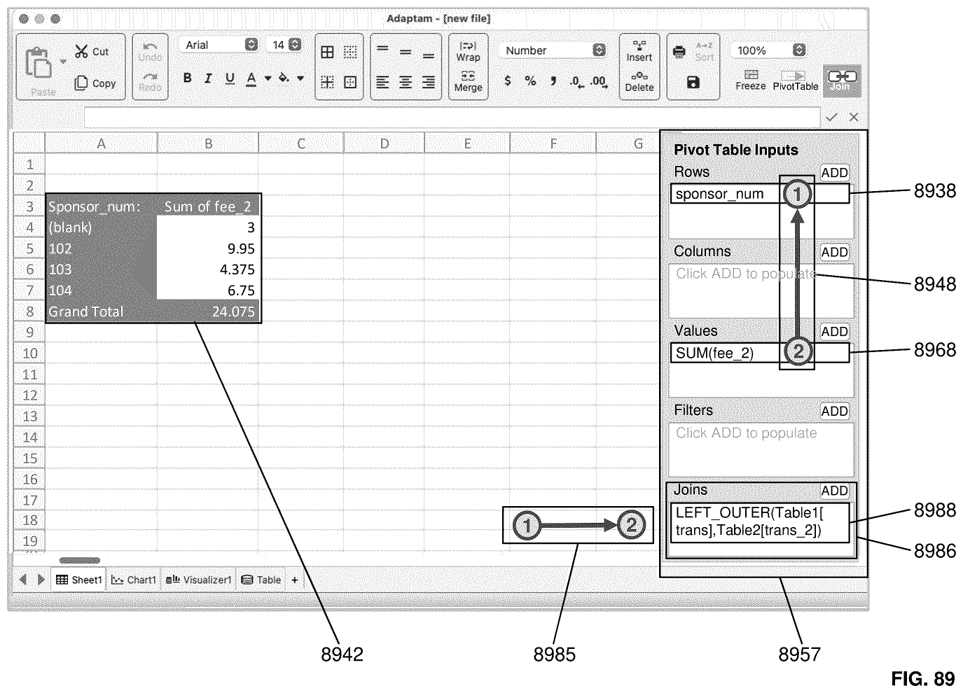

At this point we have exampled generating the PivotTable in FIG. 41 from four different selection list selections, 3948 in FIG. 39C, 3987 in FIG. 39E, 4048 in FIG. 40C, and 4087 in FIG. 40E. Our PivotTable data set join technology requires no alignment of the join direction (order of tables/keys in the join), and the direction of the PivotTable inputs as does Microsoft Power Pivot. FIG. 41 examples the exact same PivotTable in our technology as was exampled in FIG. 7 in Microsoft Power Pivot. The two data sets (us in FIG. 31B 3182 and 3185 and Microsoft Excel in FIG. 6 662 and 663) are the same. And the keys (us in FIG. 31B 3181 and 3184 and Microsoft Excel in FIG. 6 651 and 654) are the same in the joins (us in FIG. 41 4181 and 4186 and Microsoft Excel in FIG. 7 753). The joins go the same direction (us in FIG. 41 4194 and Microsoft Excel in FIG. 7 763) and the PivotTable ‘Values’ and ‘Rows’ setups go the same data set to data set direction (us in FIG. 41 4148 and Microsoft Excel in FIG. 7 787). Those joins are misaligned with the join direction 4194 going from ‘1 to 2’ and the ‘Values’ to ‘Rows’ PivotTable input direction 4148 going from ‘2 to 1’ (going from ‘SUM(fee_2) 4168 in the ‘Values’ input 4166 to ‘sponsor_num’ 4138 in the ‘Rows’ input 4136). However, our PivotTable generates the correct result FIG. 41 4154 while the Microsoft Excel Power Pivot PivotTable generates an incorrect Cartesian Product result FIG. 7 741/742. The generation of that correct result in our technology is illustratively exampled in FIG. 42A and FIG. 42B with our technology correctly executing the Left Outer join and using the result for the PivotTable data manipulations and calculations. Also, note in FIG. 41 the user clicked the ‘Join’ button 4119 to expose the join set up display 4175 to display the join. This embodiment has the joins not visible within the Pivot Table Inputs as exampled by the fact that there is no Join input within the Pivot Table Inputs 3857 as exampled in FIG. 38 and by the need in FIG. 41 to open the join popup 4175 to see the join. However, our technology works the same way not requiring alignment of the join and PivotTable input directions in embodiments where the join is visible in the Pivot Table Inputs 8957 as exampled in FIG. 89 8988 ‘LEFT_OUTER(Table1[trans],Table2[trans_2]])’ in the ‘Joins’ input/display 8986 in the ‘Pivot Table Inputs’ 8957. This example has the same ‘Rows’ ‘sponsor_num’ input 8938 and ‘Values’ ‘SUM(fee_2)’ input 8968 as FIG. 41. It has the same misalignment of the joins direction ‘1 to 2’ 8985 versus the ‘Values’ to ‘Rows’ input direction ‘2 to 1’ 8948 but generates the correct PivotTable result 8942.

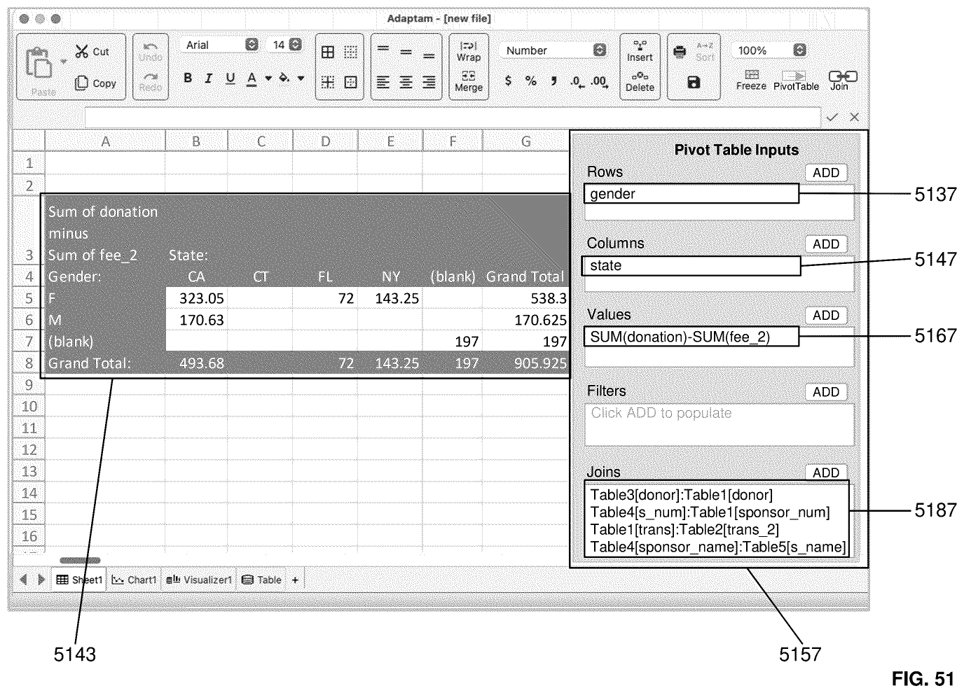

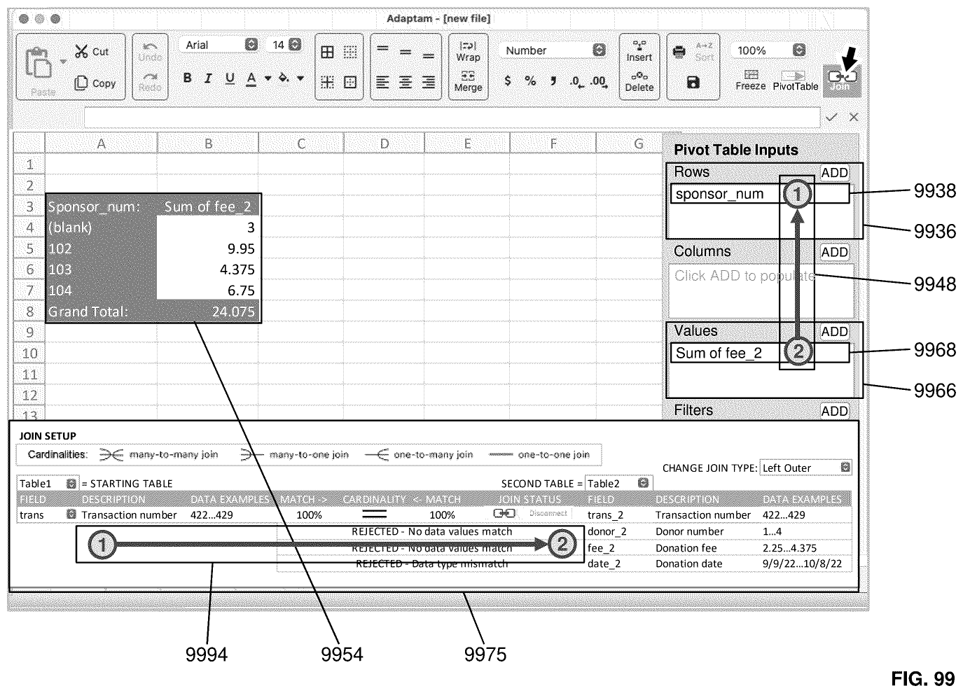

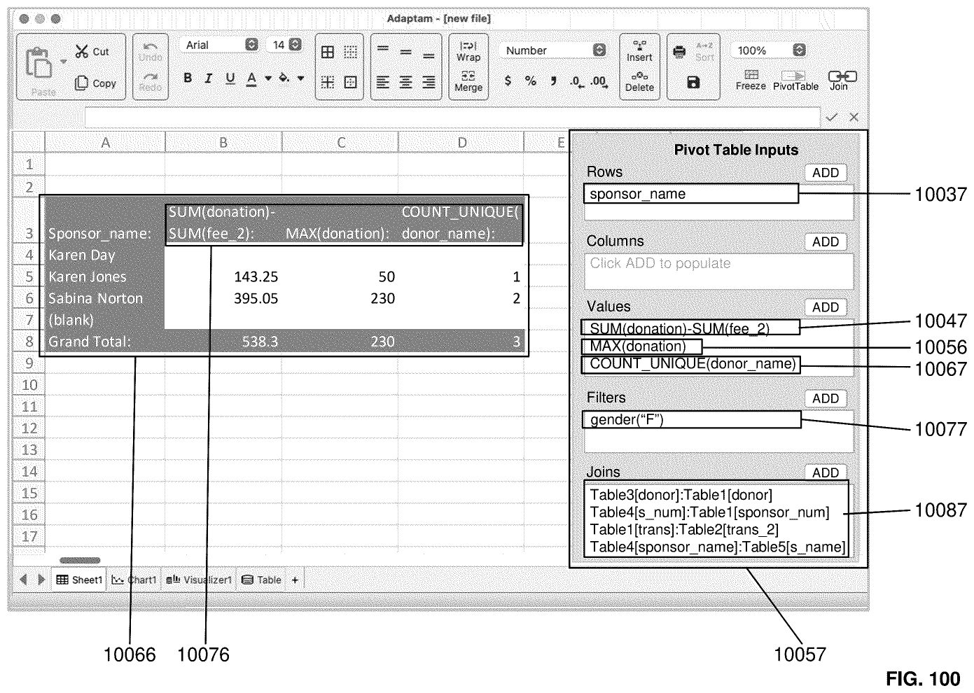

Note, our PivotTable ‘Values’ inputs in this embodiment look and operate a little differently than other spreadsheet PivotTables—more like regular cell formulas without the equals sign and thereby look a little different when doing the same thing. For example, the ‘Sum of fee_2’ 778 in FIG. 7 Microsoft Excel is doing the same thing as our ‘SUM(fee_2)’ 4168 in FIG. 41. This embodiment of our technology uses the more regular cell formula approach because that approach in our technology supports a broader range of formulas involving algebraic operators and more functions in a single ‘Values’ argument input as later exampled in FIG. 51 5167 and FIG. 100 10067 and 10047. However, a different embodiment of our technology supports ‘Values’ inputs that are like those employed in other spreadsheets including those in Microsoft Excel. FIG. 99 examples such an embodiment where the ‘Values’ input 9966 is populated as ‘Sum of fee_2’ 9968 but otherwise our technology functions the same way not requiring alignment of the join 9975 direction 9994 to the ‘Values’ 9966/9968 to ‘Rows’ 9936/9938 input direction 9948. As in this example they are misaligned (‘1 to 2’ 9994 versus ‘2 to 1’ 9948) yet the PivotTable result 9954 is determined correctly (as it was in FIG. 41).

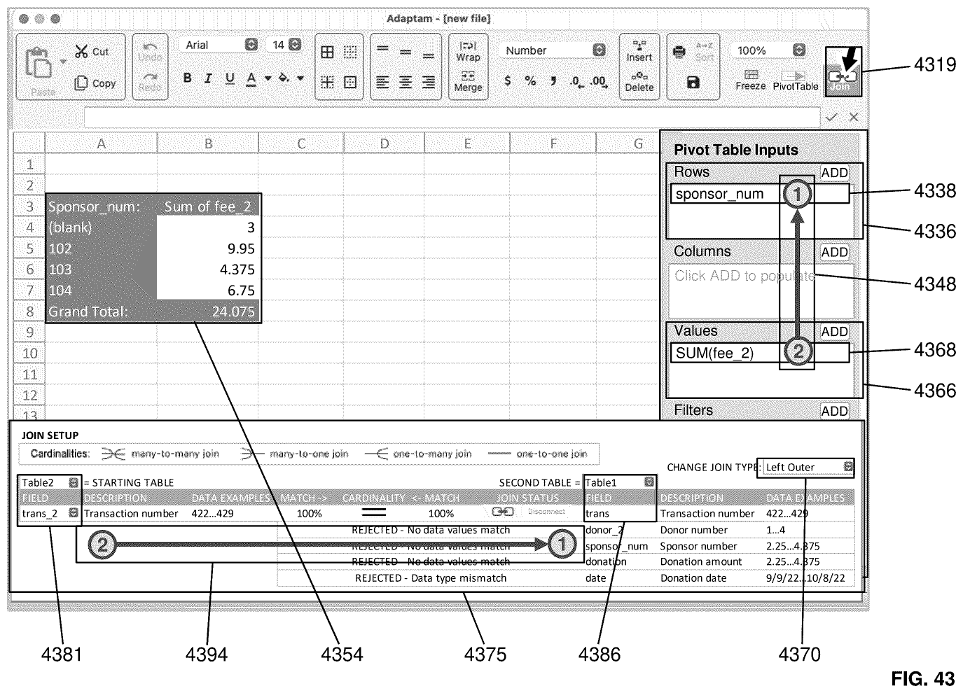

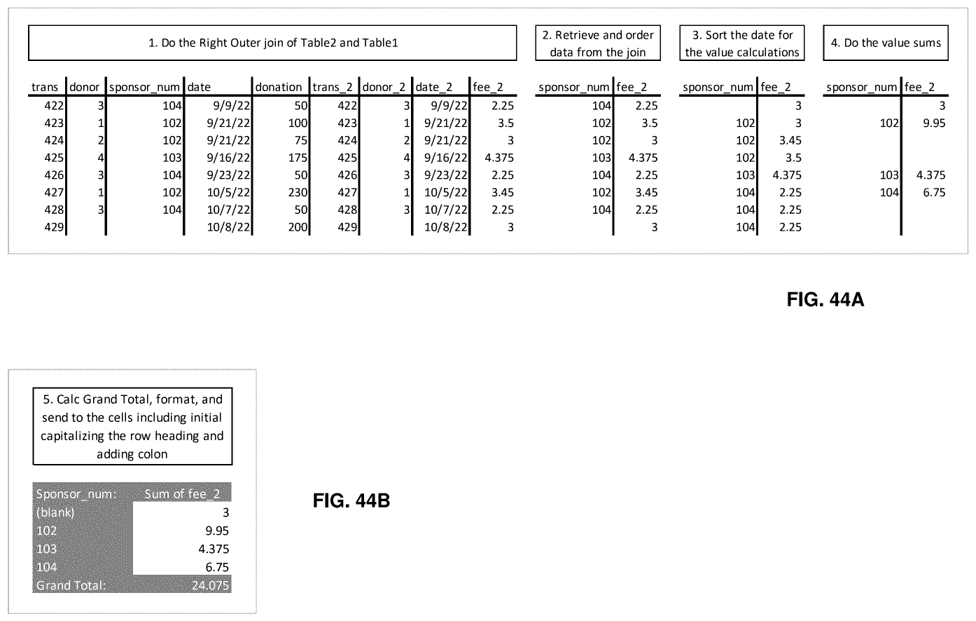

FIG. 43 examples the opposite direction (order of tables/keys in the join) join giving the same correct PivotTable result in our technology. ‘Table2’ and ‘trans_2’ 4381 is now the starting data set and key (where ‘Table1’ and ‘trans’ 4181 were in FIG. 41) and ‘Table1’ and ‘trans’ 4386 is the second data set and key (where ‘Table2’ and ‘trans_2’ 4181 were in FIG. 41). Those joins are now aligned with the join direction 4394 going from ‘2 to 1’ and the ‘Values’ to ‘Rows’ PivotTable input direction 4348 also going from ‘2 to 1’ (going from ‘SUM(fee_2) 4368 in the ‘Values’ input 4366 to ‘sponsor_num’ 4338 in the ‘Rows’ input 4336). The additional difference is that the ‘Left Outer’ 4170 join in FIG. 41 is now replaced with a ‘Right Outer’ 4370 join in FIG. 43. That join needs to be reversed to give the exact same join, which does not make a difference in this example because of the true one to one (i.e., no extra rows not found in the other data set in either data set) cardinality relationship between the two tables but would make a difference in other cardinality types. Because our technology works for all data cardinalities, we correctly switched the join type. Although our technology generates the correct outcome (with no misalignment problems) no matter what join type is used. Note, we also want to be clear as sometimes the one-to-one terminology is used for situations that are unique to unique but not true one-to-one because they contain nulls and/or contain values not found in the other data set. The generation of that correct PivotTable result in our technology is illustratively exampled in FIG. 44A and FIG. 44B with our technology correctly executing the Right Outer join and using the result for the PivotTable data manipulations and calculations to give the result 4354 in FIG. 43. Also, note in FIG. 43 the user clicked the ‘Join’ button 4319 to expose the join set up display 4375 to display the join.

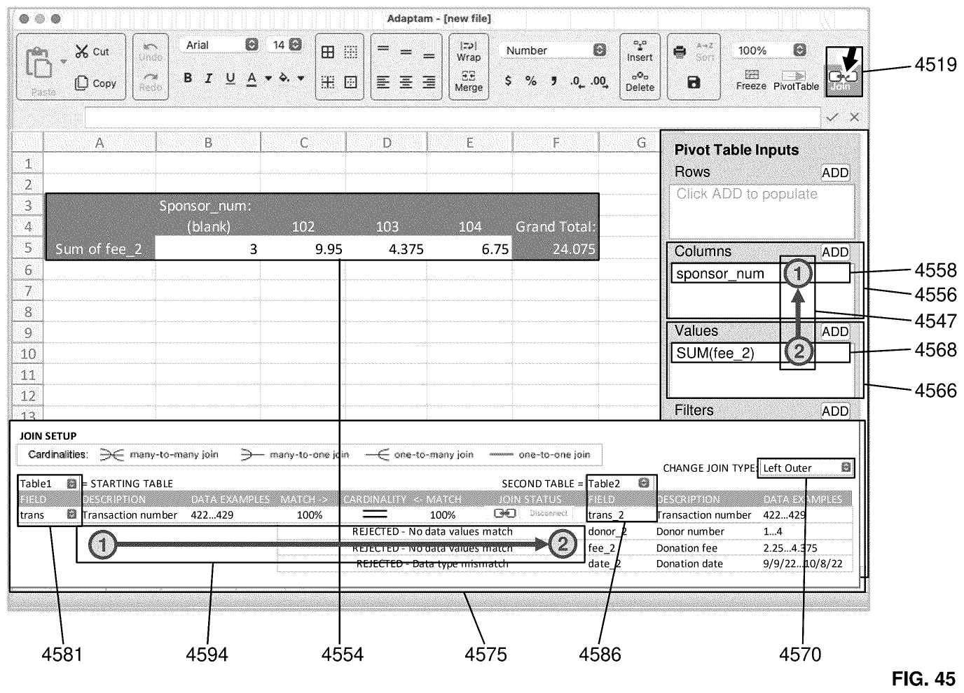

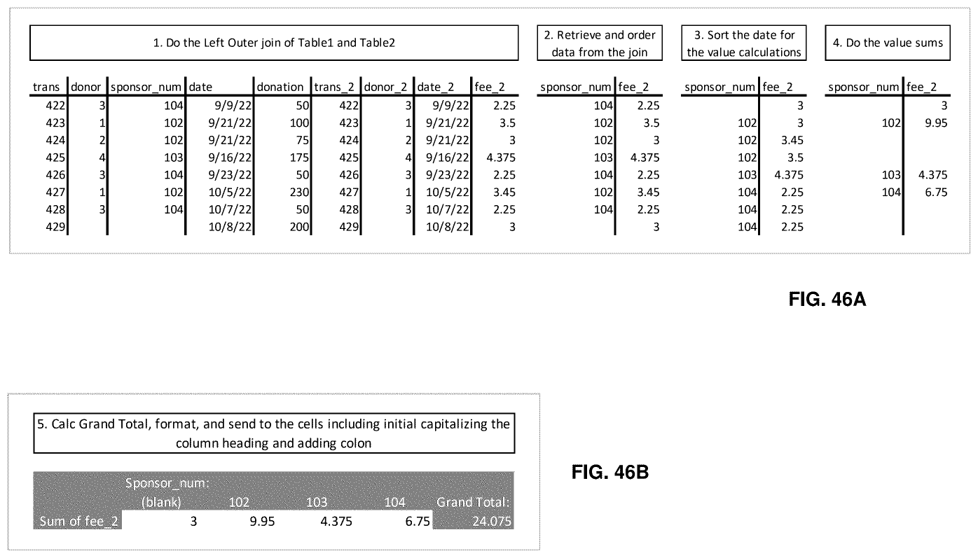

FIG. 45 examples the exact same PivotTable in our technology as was exampled in FIG. 11 in Microsoft Power Pivot. The two data sets (us in FIG. 31B 3182 and 3185 and Microsoft Excel in FIG. 6 662 and 663) and keys (us in FIG. 31B 3181 and 3184 and Microsoft Excel in FIG. 6 651 and 654) are the same in the joins (us in FIG. 45 4581 and 4586 and Microsoft Excel in FIG. 11 1153). The joins 1163 in FIG. 11 (Excel) and 4594 FIG. 45 (us) both go the same direction and the PivotTable ‘Values’ and ‘Columns’ setups both go the same data set to data set direction (us in FIG. 45 4547 and Microsoft Excel in FIG. 11 1187). Those directions (4594 and 4547) result in a misalignment as the join direction 4594 goes ‘1 to 2’ while the PivotTable input ‘Values’ to ‘Columns’ direction is the opposite of ‘2 to 1’ 4547 (going from ‘SUM(fee_2) 4568 in the ‘Values’ input 4566 to ‘sponsor_num’ 4558 in the ‘Rows’ input 4556). However, our PivotTable generates the correct result FIG. 45 4554 while the Microsoft Excel Power Pivot PivotTable generates an incorrect Cartesian Product result FIG. 11 1141/1142. The generation of that correct result in our technology is illustratively exampled in FIG. 46A and FIG. 46B with our technology correctly executing the Left Outer join and using the result for the PivotTable data manipulations and calculations. Also, note in FIG. 45 the user clicked the ‘Join’ button 4519 to expose the join set up display 4575 to display the join (‘Table1’ ‘trans’ 4581 to ‘Table2’ ‘trans_2’ 4586 employing a ‘Left Outer’ join 4570).

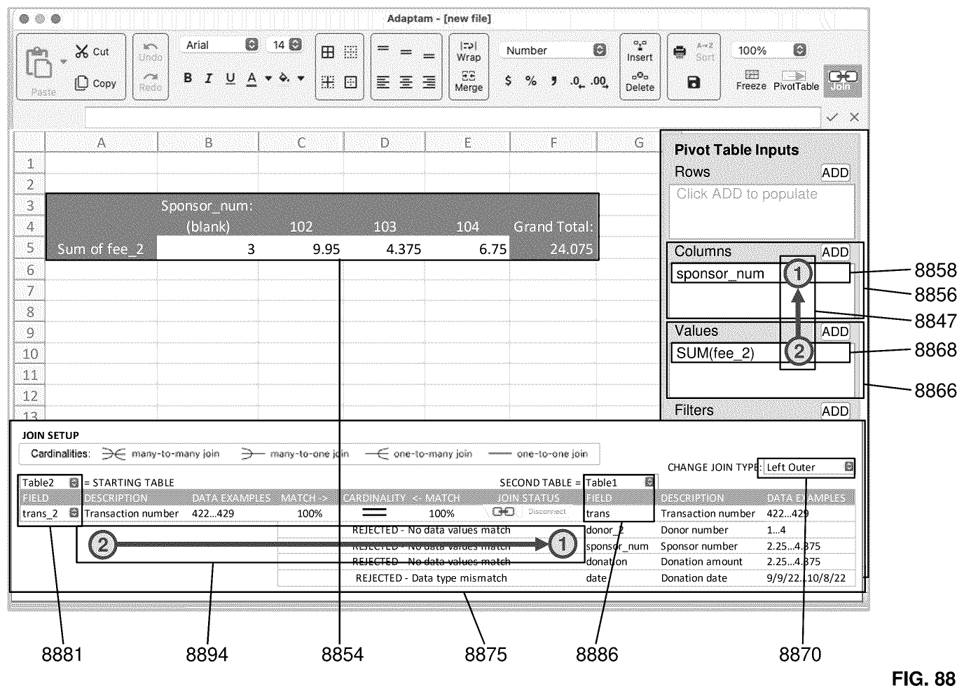

FIG. 88 examples the exact same PivotTable inputs (‘Columns’ input 8856 of ‘sponsor_num’ 8858 and ‘Values’ input 8866 of ‘SUM(fee_2)’ 8868) as FIG. 45 but with a join going the opposite direction 8894. A join from ‘Table2’ 8881 to ‘Table1’ 8886 also employing a ‘Left Outer’ join 8870. Thus, both directions 8894 and 8847 are ‘2 to 1’ and thereby aligned. This also generates the correct PivotTable output 8854 which also happens to be the same result as in FIG. 45 4554 because the same two keys are used in both joins and the keys are a true one to one so reversing the join does not change the join result. With a true one-to-one join a Left Outer and Right Outer give the same result, as will an Inner and a Full Outer. In other data situations the reversal of the join without changing the join type can change the result, but our technology will give the correct result in each situation not an incorrect Cartesian Product.

Our technology always delivers the correct PivotTable results regardless of the alignment of the joins and the joined fields in the PivotTable ‘Rows’, ‘Columns’, ‘Values’, and Filters inputs provided the joins have been prequalified or set up. However, if the joins do not exist our technology definitely lets the user know with an ERROR message rather than delivering a result with an apparent Cartesian Product and some UI suggesting ‘Relationship between tables may be needed as previously exampled for Microsoft Excel.

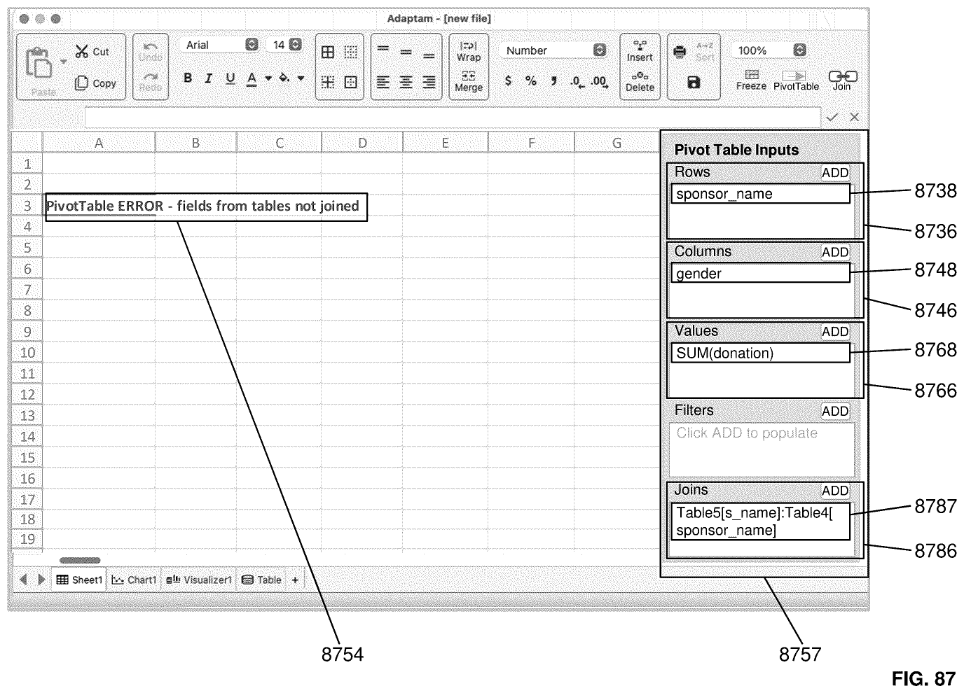

FIG. 87 examples our technology employing the data sets exampled in FIG. 31B where the user has prequalified or set up the orange highlighted join of ‘Table4’ 3188 and Table5’ 3189 employing the join keys ‘sponsor_name’ 3178 and ‘s_name’ 3179 as shown in the ‘Joins’ input/display 8786 ‘Table5[s_name]:Table4[sponsor_name]’ 8787 in the PivotTable inputs 8757 in FIG. 87. The inputs of ‘sponsor_name’ 8738 in the ‘Rows’ input 8736 and ‘gender’8748 in the ‘Columns’ input 8746 successfully work because they are from the joinable data sets ‘Table4’ and ‘Table5’, respectively. However, when the user manually types ‘donation’ into ‘SUM(donation) 8768 in the ‘Values’ input 8766 our PivotTable technology generates the error message ‘PivotTable ERROR—fields from tables not joined’ 8754 in cell ‘A3’. This is because ‘donation’ is a field from ‘Table1’ which does not have an existing join to either ‘Table4’ or ‘Table5’. Our technology in this embodiment definitively tells the user that they have attempted to use data together in the PivotTable inputs that does not have existing joins either directly or via chained/sequenced joins.

While we could example more situations, for brevity we will instead move onto further exampling our intelligent join selection lists before moving onto how our technology works for chained/sequenced joins where the alignment issue is even a larger problem for getting a correct result.

### Intelligent Join Selection Lists Broadly Applicable in Our Technology

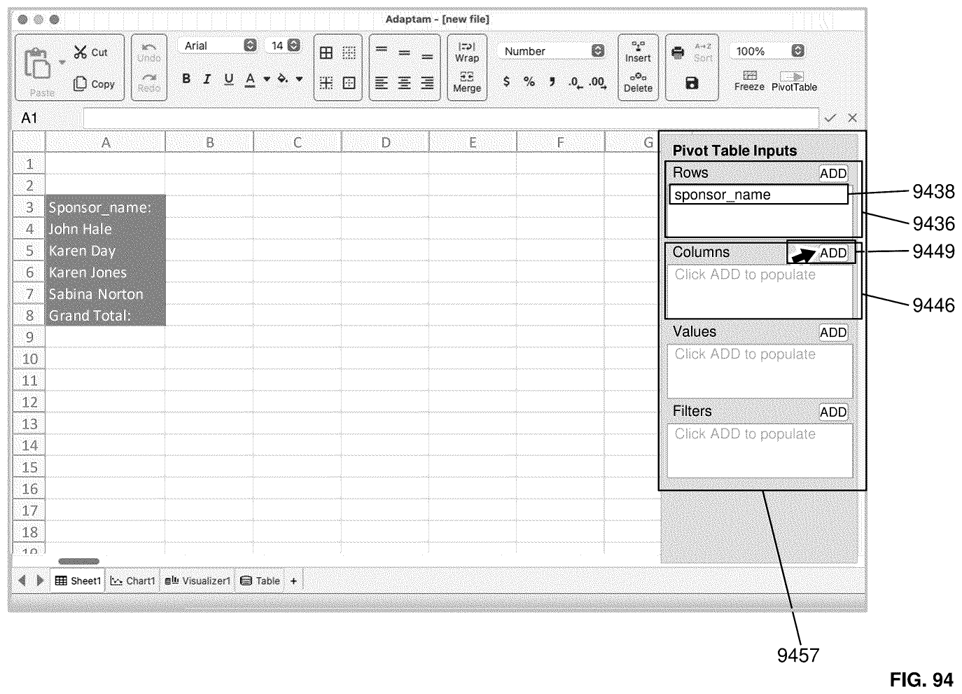

Our previous more intelligent joinable fields selection list examples in FIG. 39B through FIG. 40E were for an input into a ‘Values’ formula, however our technology works for all the ‘Rows’, ‘Columns’, ‘Values’ and ‘Filters’ PivotTable inputs. It works for settings where the applicable fields are not limited by functions or previous selections, limited by previous selections, limited by functions, and limited by combinations of the limitations. FIG. 94 through FIG. 96E examples the use of our technology in different PivotTable inputs for selection lists which provide the user with more information with which to make their selections and proactively block them from setting up PivotTables that will not work because of invalid joins. There are many different PivotTable input UIs, for conciseness we have used one configuration so as to focus on what our technology adds without the distraction of different UIs, however our technology would similarly work for other UI configurations.

### Single Selection List of Joinable Fields

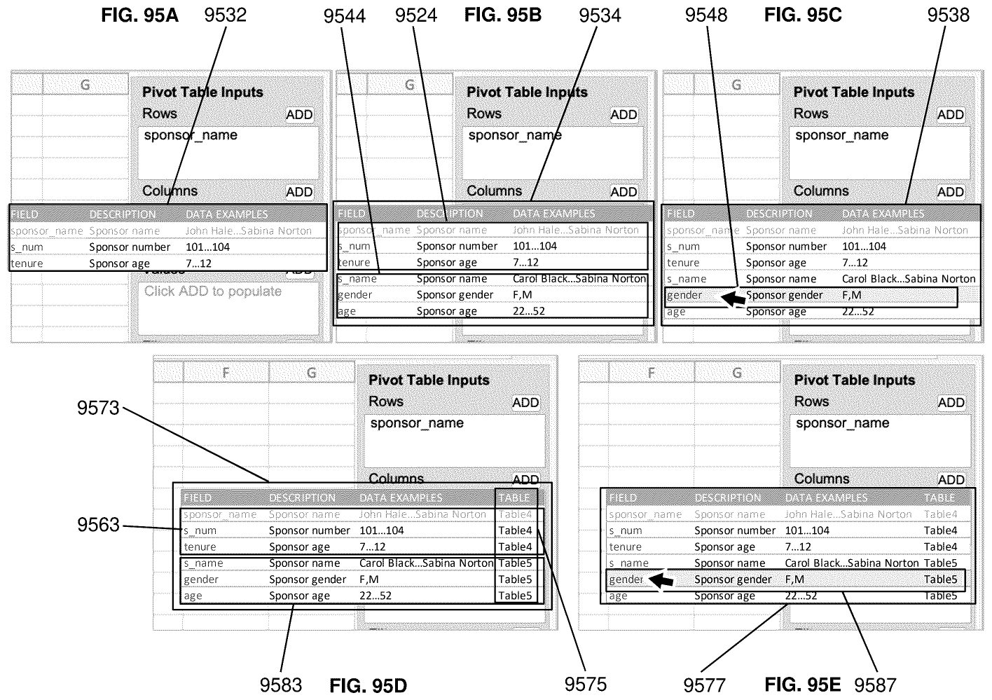

FIG. 94 examples a user having selected a field ‘sponsor_name’ 9438 as a ‘Rows’ input 9436 within the PivotTable inputs 9457. This establishes the data set that ‘sponsor_name’ 9438 resides within as the source table. However, our technology then automatically identifies any other data sets joined to that data set for use in the PivotTable inputs. When the user clicks the ‘ADD’ button 9449 to add a field in the ‘Columns’ input 9446 if there were no other data sets joined to the data set containing ‘sponsor_name’ 9438 then the user would get the selection list 9532 in FIG. 95A. Which only contains the fields in the data set containing ‘sponsor_name’ 9438 in FIG. 94. However, because this example has the join with the orange keys (3178, and 3179) in FIG. 31B, ‘Table4’ 3188 and ‘Table5’ 3189 are joined together. As ‘sponsor_name’ 9438 in FIG. 94 is in ‘Table4’ 3188 in FIG. 31B and joinable with ‘Table5’ 3189 in FIG. 31B, the ‘Table5’ fields 9544 are displayed with the ‘Table4’ fields 9524 in the selection list 9534 exampled in FIG. 95B. Our technology automatically displays the applicable fields from any joinable data set. Note we say applicable, as the fields may be limited by the situation such as rules where fields in ‘Rows’ cannot be in ‘Columns’ or limited by data type by functions used within the ‘Values’ input. Continuing with our charity worker example in FIG. 95C the user selects ‘gender’ 9548 as a ‘Columns’ input in the selection list 9538 which will then automatically populate in the ‘Columns’ input and trigger a join of the data sets ‘Table4’ and ‘Table5’ to create the PivotTable result.

FIG. 95D examples a different variant of the prior embodiment where the selection list 9573 contains and additional column ‘TABLE’ 9575 identifying which data set each field is from, in this example the original ‘Table4’ 9563 and joinable ‘Table5’ 9583. So, beyond the added ‘DESCRIPTION’ and ‘DATA EXAMPLES’ information our technology in this embodiment adds the ‘TABLE’ information to aid the user is selecting the field they desire. As before, our technology also only displays the fields that are joinable and applicable in this particular input, not presenting any fields that will not work. As before the charity worker in FIG. 95E selects ‘gender’ 9587 as a ‘Columns’ input in the selection list 9577 which will then automatically populate in the ‘Columns’ input and trigger a join of the data sets ‘Table4’ and ‘Table5’ to create the PivotTable result.

### Multiple Joined Fields Selection Lists

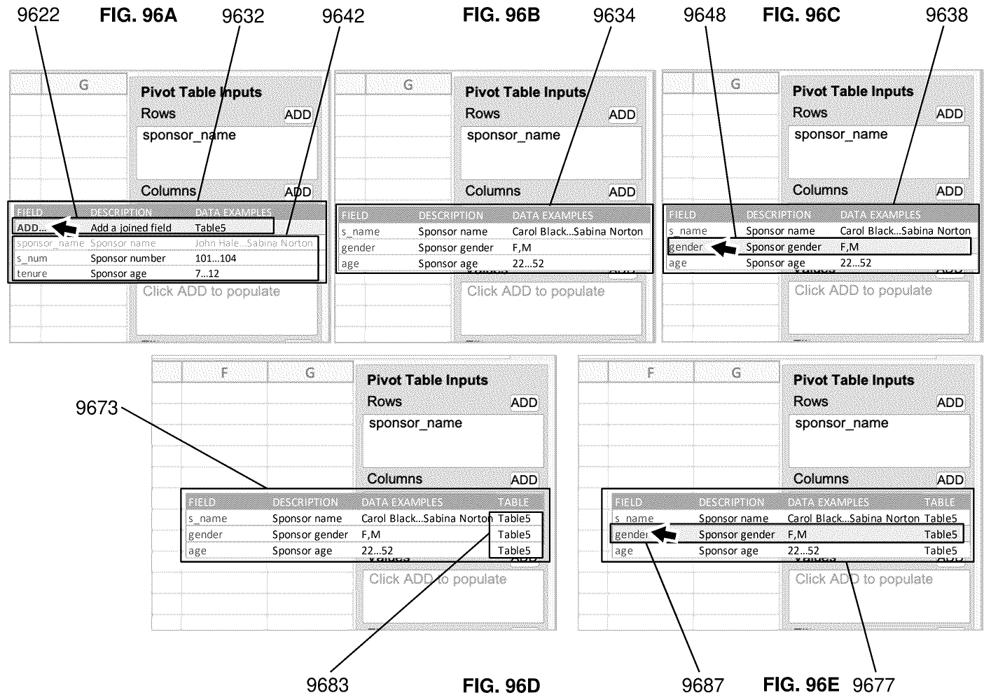

FIG. 96A through FIG. 96E examples a different embodiment and variant where instead of showing the user all the joinable fields in a single selection list, our technology displays access to the joinable fields. This embodiment exists because in many real-world situations where there are over forty fields in each data set, displaying eighty or more fields can be confusing, so instead the user has access to see and then select from the joinable data set by itself.

FIG. 96A examples a selection list 9632 triggered by clicking the popup button 9449 in ‘Columns’ input 9446 of the PivotTable inputs 9457 in FIG. 94. It not only shows the fields/columns 9642 in ‘Table4’ (with the previously selected field/column ‘sponsor_name’ inactive/grayed out), but also a selection ‘ADD another table’ 9622 that gives access to the applicable fields in the joinable ‘Table5’. Note, this embodiment like the others says applicable fields/columns because depending on the selection used the fields/columns can be limited (e.g., field reuse in other inputs limited or data type limited by use within a function). Returning to this specific example, the user then clicks the ‘ADD . . . ’ 9622 selection which then automatically opens the selection list 9634 in FIG. 96B. That selection list 9634 displays all the fields/columns in ‘Table5’, which are all usable in this input. The user then sees the field/column ‘gender’ 9648 in the selection popup 9638 in FIG. 96C that they want and clicks it to join automatically populate it in the ‘Columns’ input and trigger a join of the data sets ‘Table4’ and ‘Table5’ to create the PivotTable result. This set of selection lists displays the ‘DESCRIPTION’ and ‘DATA EXAMPLES’ information to help inform the user in their field/column selections. Another UI variant of this embodiment is exampled in FIG. 96D where the selection list 9673 was triggered by clicking the ‘ADD . . . ’ 9622 in FIG. 96A. This selection list 9673 also contains the ‘TABLE’ ‘Table5’ listing 9683 beside each ‘FIELD’. ‘DESCRIPTION’ and ‘DATA EXAMPLES’. With this additional information supplied to better inform the user in their field/column selection. As in the previous example, the user can cause the join of the two tables they desired by clicking the field/column ‘gender’ 9687 in the selection list 9677 in FIG. 96E to automatically populate it in the ‘Columns’ input and trigger a join of the data sets ‘Table4’ and ‘Table5’ to create the PivotTable result.

While we could continue to example different selection lists use in the different PivotTable Inputs, different ways for the user to make the selections, and using those in different PivotTable UIs, but for brevity's sake we will instead move onto exampling how our joins always work for PivotTables without the need for direction alignment between the join and the relationship between the ‘Values” field being evaluated and the joined “Rows’, ‘Columns’ and/or ‘Filters’ inputs for chained joins.

### No Need for Directional Alignment—Chained Joins

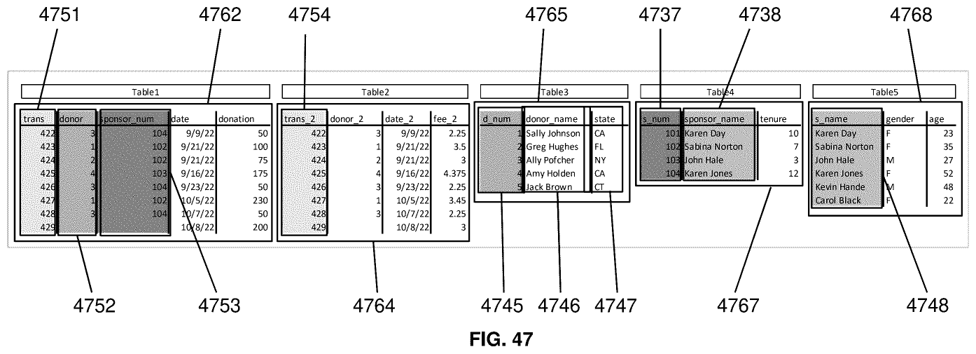

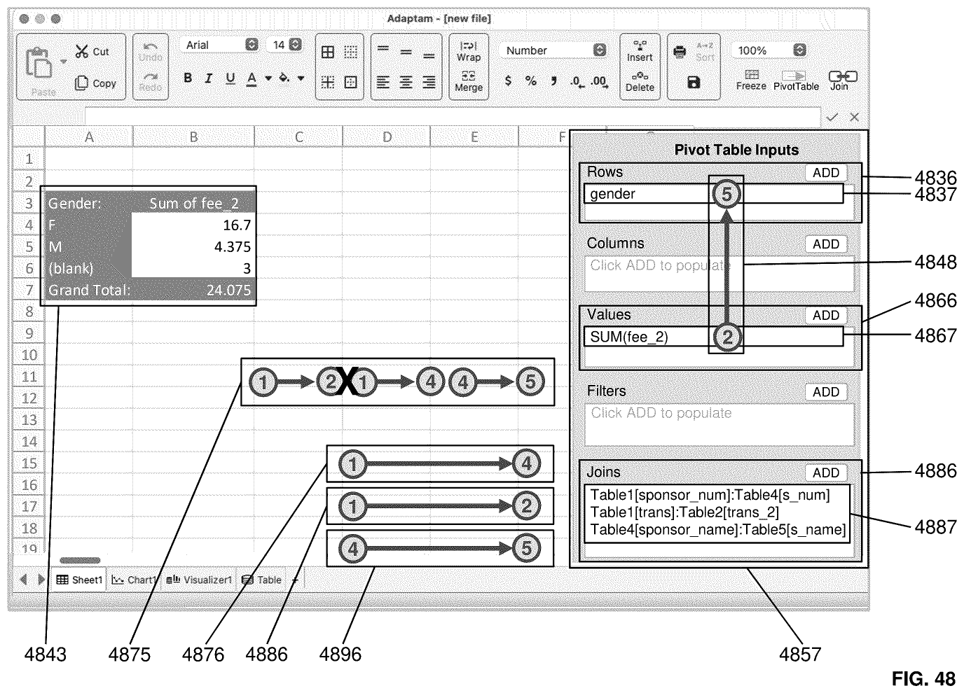

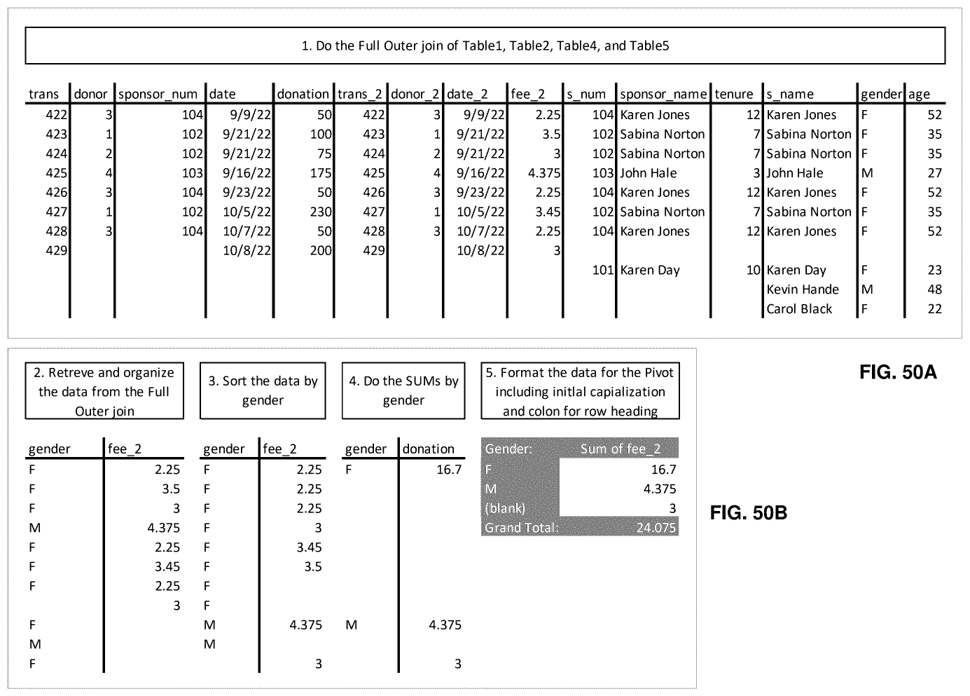

Our PivotTable data set chained/sequenced join technology requires no alignment of the join direction (order of tables/keys in the join) and the direction of the PivotTable inputs where as Microsoft Power Pivot requires alignment. FIG. 48 examples the exact same PivotTable in our technology as was exampled in FIG. 14 in Microsoft Power Pivot. The four chain/sequence joined data sets (us in FIG. 47 4762, 4764, 4767, and 4768 and Microsoft Excel in FIG. 6 662, 663, 667, and 668) and keys (us in FIG. 47 4751/4754, 4753/4737, and 4738/4748 and Microsoft Excel in FIG. 6 651/654, 653/637, and 638/648) are the same in the joins (us in FIG. 48 4887 and Microsoft Excel in FIG. 14 1453). Each of the joins go the same direction (us in FIG. 48 4876, 4886, and 4896 and Microsoft Excel in FIG. 14 1463, 1473, and 1483) and the PivotTable ‘Values’ and ‘Rows’ setups go the same data set to data set direction (us in FIG. 48 4848 and Microsoft Excel in FIG. 14 1487). Each share the same specified join to PivotTable input direction misalignment exampled for us in FIG. 48 4875 and in Microsoft Excel in FIG. 14 1493). The ‘1’ to ‘2’ specified join does not go head to tail with the ‘1’ to ‘4’ join. That misalignment causes the Microsoft Excel Power Pivot PivotTable to generate a wrong cartesian product result in FIG. 14 1441/1442. However, with that same misalignment in the specified joins our PivotTable generates the correct result FIG. 48 4843. The generation of that correct result in our technology is illustratively exampled in FIG. 50A and FIG. 50B with our technology correctly executing in this example a Full Outer join and using the results for the PivotTable data manipulations and calculations. Note, our technology would have generated a correct result for a left outer join. FIG. 48 examples that in an embodiment where the joins 4887 are visible in our PivotTable inputs 4857 in an input dedicated to ‘Joins’ 4886.

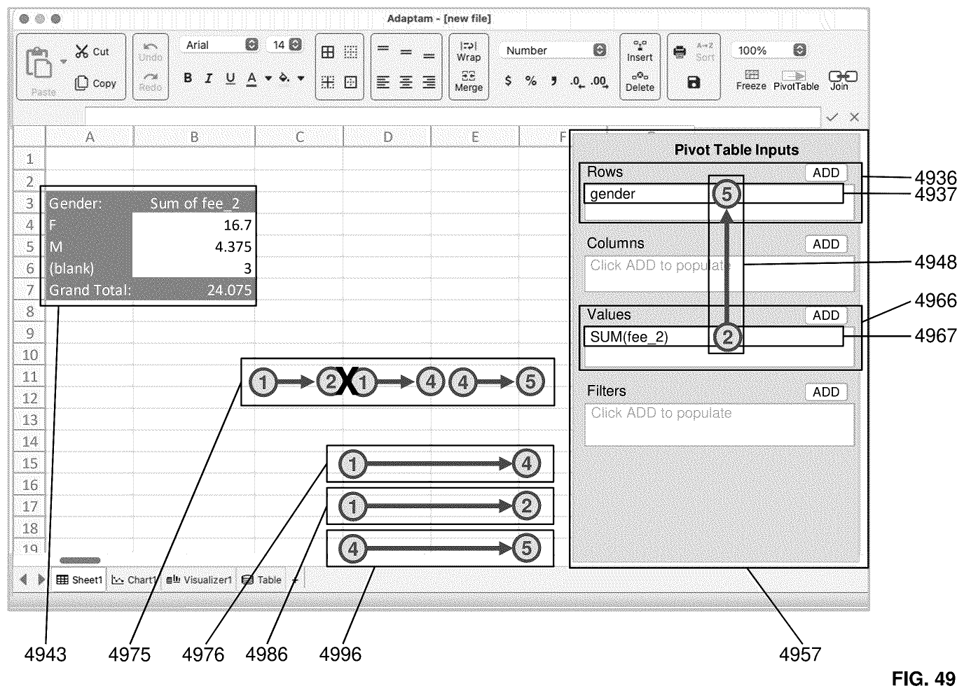

FIG. 49 examples the exact same PivotTable as in FIG. 48 with the exception being in FIG. 48 the join specifications 4887 are visible and in FIG. 49 they are invisible in the ‘Pivot Table Inputs’ 4857. The result is identical (4943 in FIG. 49 versus 4843 in FIG. 48). The joins are identical as exampled by the superimposed join directions (FIG. 49 4976, 4986, 4996, and 4975 and FIG. 48 4876, 4886, 4896, and 4875) and the superimposed PivotTable input directions (FIG. 49 4948 and FIG. 48 4848) being the same. The ‘Rows’ (FIG. 49 4936 and FIG. 48 4836) of ‘gender’ (FIG. 49 4937 and FIG. 48 4837) and ‘Values’ (FIG. 49 4966 and FIG. 48 4866) of ‘SUM(fee_2)’ (FIG. 49 4967 and FIG. 48 4867) are the same. Our technology works with visible or invisible joins.

### No Need for Directional Alignment—Complex Totally Misaligned Chained Joins

Our technology also works for more complex and totally misaligned PivotTable chained/sequenced joins as exampled in FIG. 51. This PivotTable makes use of all the colored joins in FIG. 47 across all five data sets as shown in the ‘Joins’ 5187 in the ‘Joins’ input in the ‘Pivot Table Inputs’ 5157 in FIG. 51. The ‘Row’ ‘gender’ 5137 and ‘Column’ ‘state’ 5147 two-dimensional PivotTable output requires joins across all five data sets to correctly calculate the ‘Values’ ‘SUM(donation)-SUM(fee_2)’ 5167 and arrive at the result 5143. Which our technology does despite the fact that none of the joins and chained/sequenced joins are aligned (head to tail) to work as Microsoft Excel PowerPivot PivotTables require.

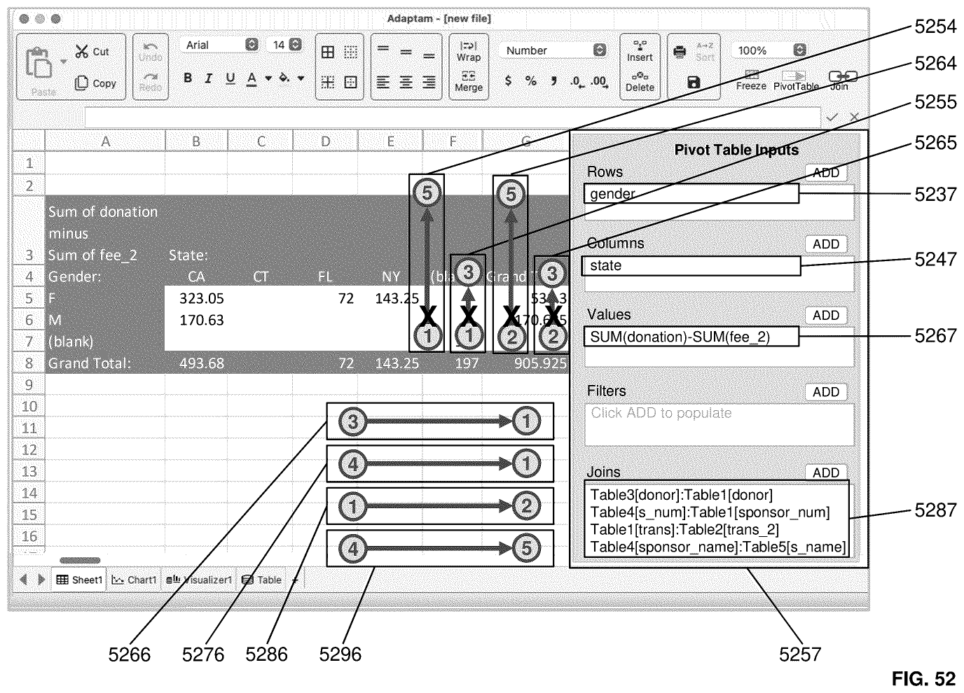

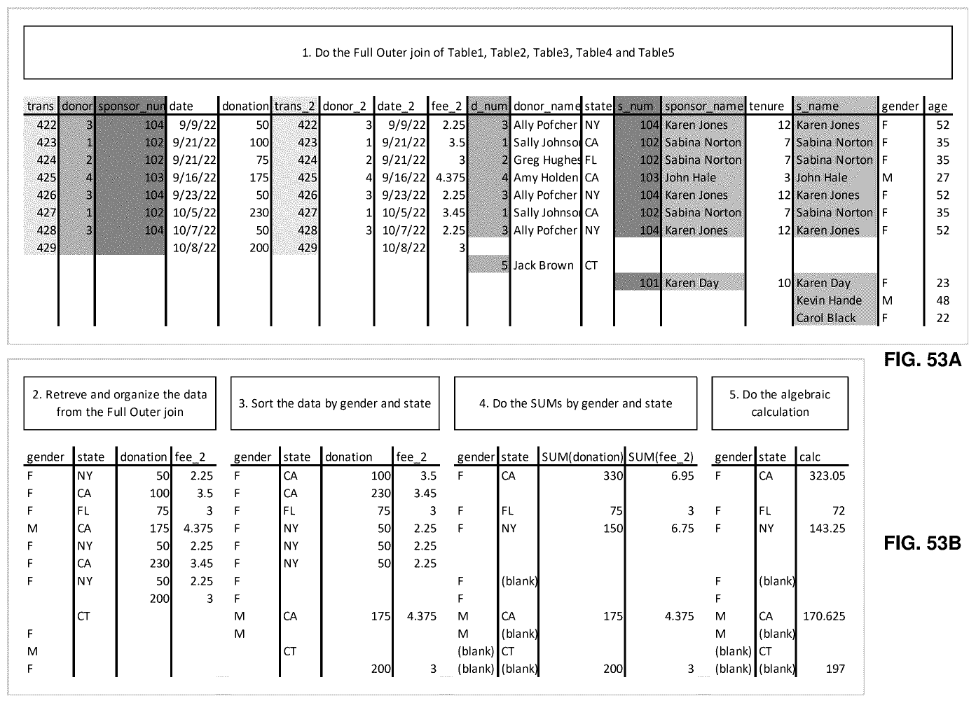

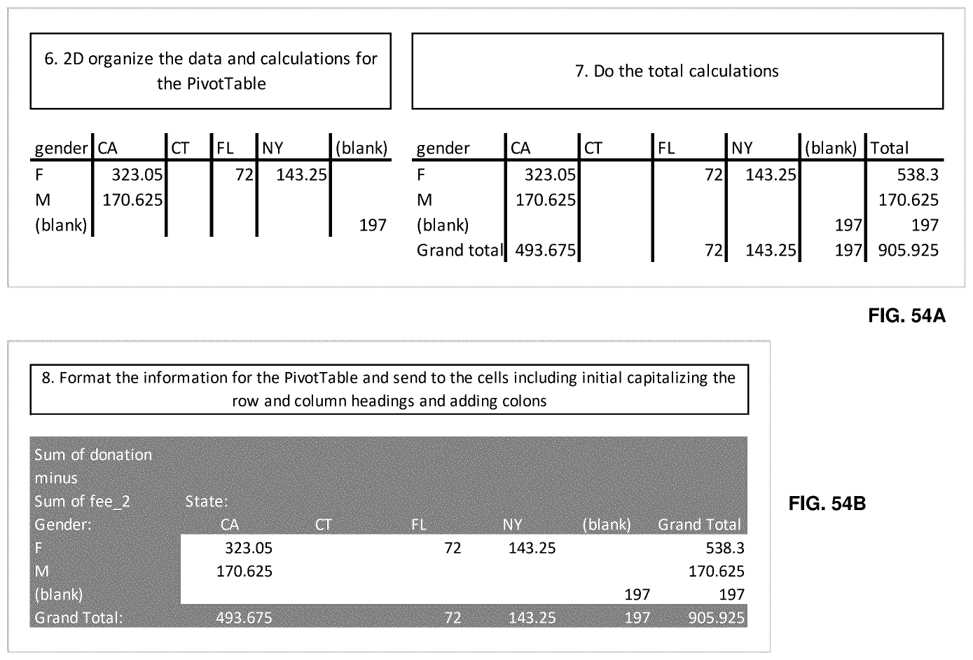

This is exampled in FIG. 52 via the looking at the alignment of the superimposed join directions (5266, 5276, 5286, and 5296) directions for the joins 5287 which so do not align head to tail and do not align with any of the PivotTable input ‘Values’ to ‘Rows’ or ‘Columns’ directions (5254, 5255, 5264, and 5265) also superimposed on FIG. 52. The ‘SUM(donation)’ 5267 direction 5254 to ‘gender’ 5237 does not work because it requires a ‘1’ to ‘4’ then a ‘4’ to ‘5’ and the ‘1’ to ‘4’ does not exist (instead it is a ‘4’ to ‘1’ 5276). The ‘SUM(donation)’ 5267 direction 5255 to ‘state’ 5247 does not work because it requires a ‘1’ to ‘3’ not a ‘3’ to ‘1’ 5266. The ‘SUM(fee_2)’ 5267 direction 5264 to ‘gender’ 5237 does not work because it requires a ‘2’ to ‘1’, then a ‘1’ to ‘4’ and then a ‘4’ to ‘5’ and the ‘2’ to ‘1’ (instead is a ‘1’ to ‘2’ 5286) and ‘1’ to ‘4’ (instead is a ‘4’ to ‘1’ 5276) do not exist. The ‘SUM(fee_2)’ 5267 direction 5264 to ‘state’ 5247 does not work because it requires a ‘2’ to ‘1’ and then a ‘1’ to ‘3’ not a ‘1’ to ‘2’ 5286 and then not a ‘3’ to ‘1’ 5266. Our technology always delivers the correct PivotTable results regardless of the alignment of the joins and the joined fields in the PivotTable ‘Rows’, ‘Columns’, ‘Values’, and ‘Filters’ inputs as illustratively exampled in steps one to eight in FIGS. 53A, 53B, 54A, and FIG. 54B for the results 5143 in FIG. 51.

Note, the ‘Values” input ‘SUM(donation)-SUM(fee_2)’ 5167 in FIG. 51 uses our previously mentioned approach of inputting ‘Values’ more as typical cell formulas (without the equals sign) rather than the mode employed by other spreadsheet PivotTables. In this situation supporting more complicated multi-function ‘Values’ inputs.

While we could example more complex chained/sequenced situations, for brevity we will instead move onto exampling how our technology works for multiple joins active at one time between two data sets.

### Chained Join Selection Lists

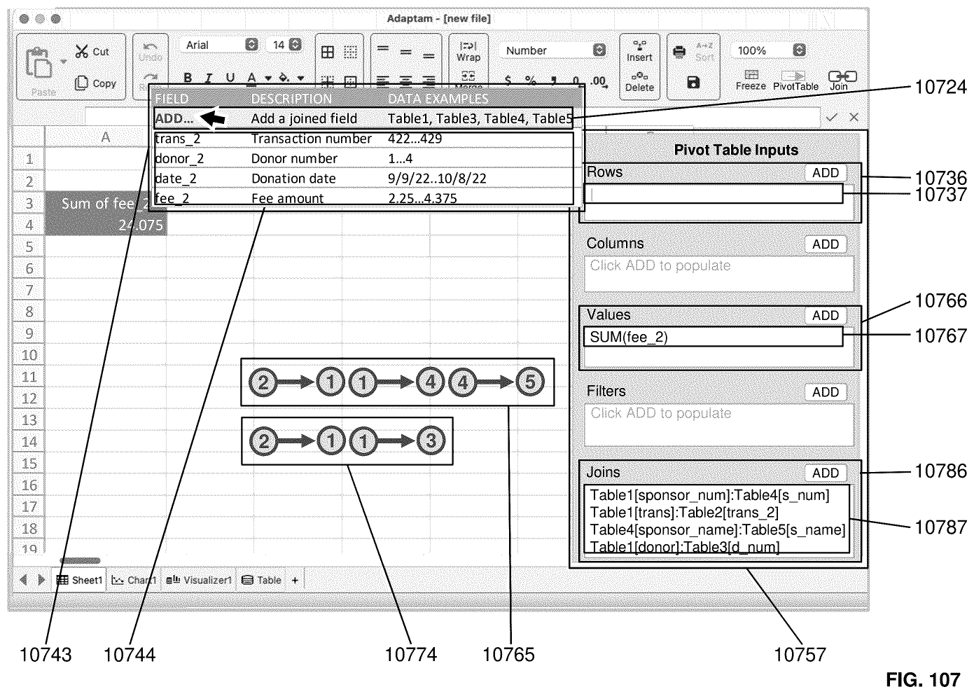

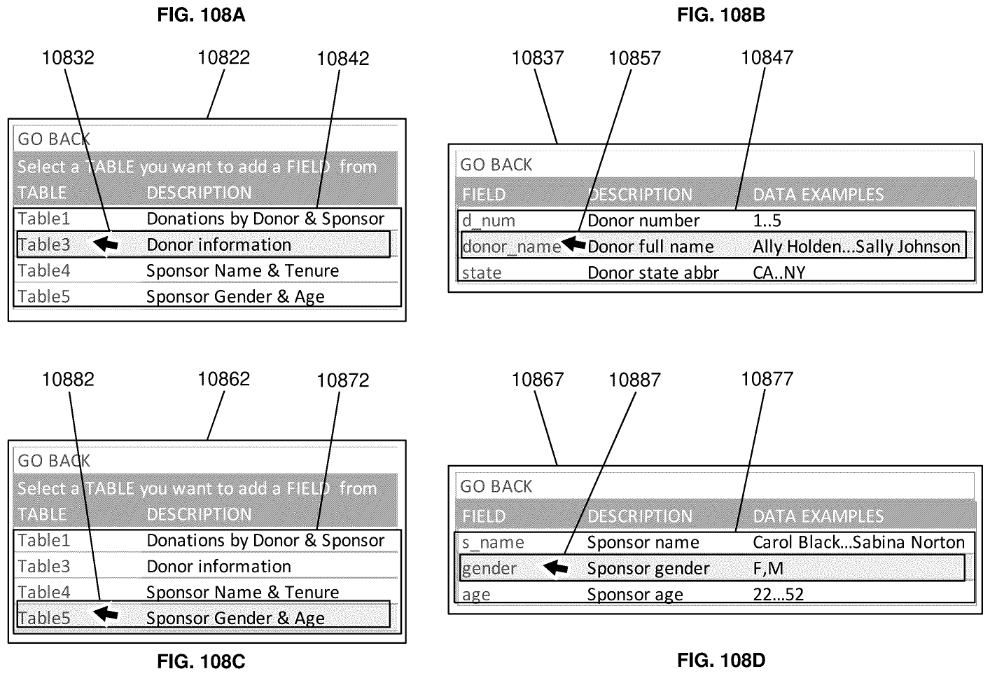

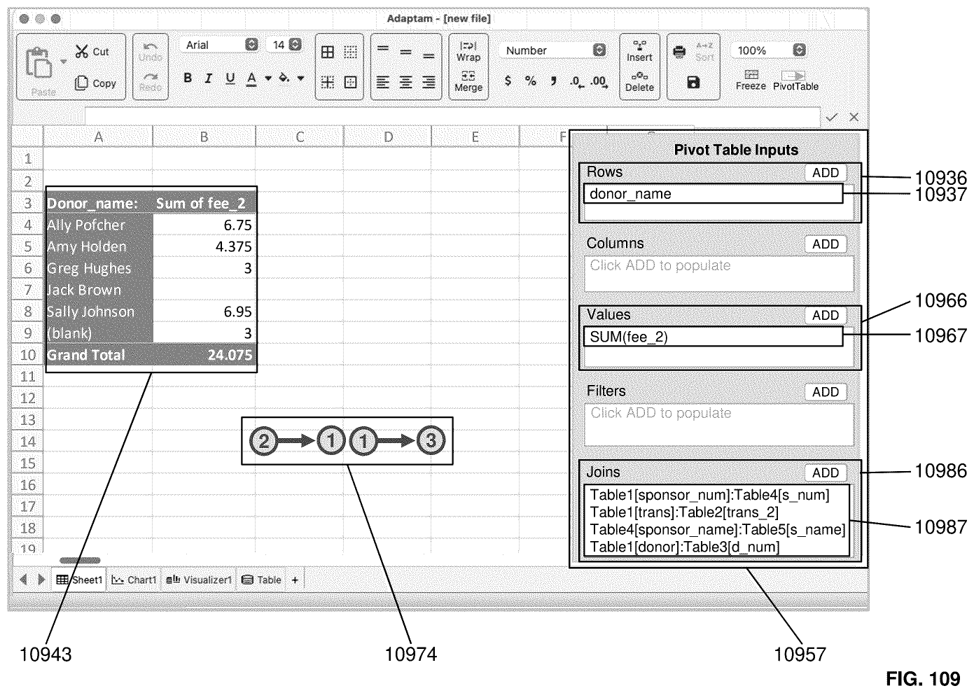

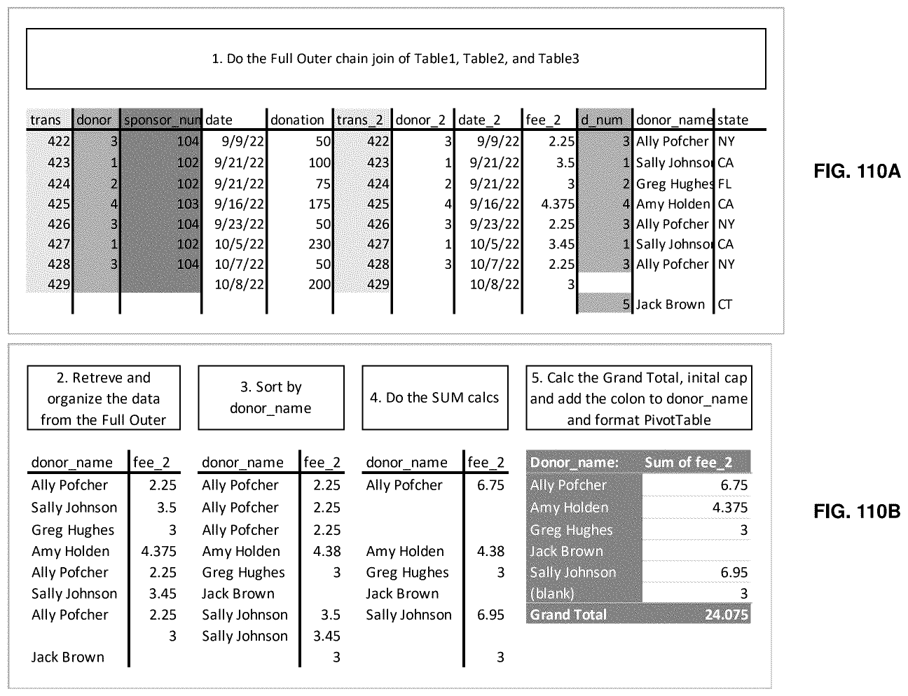

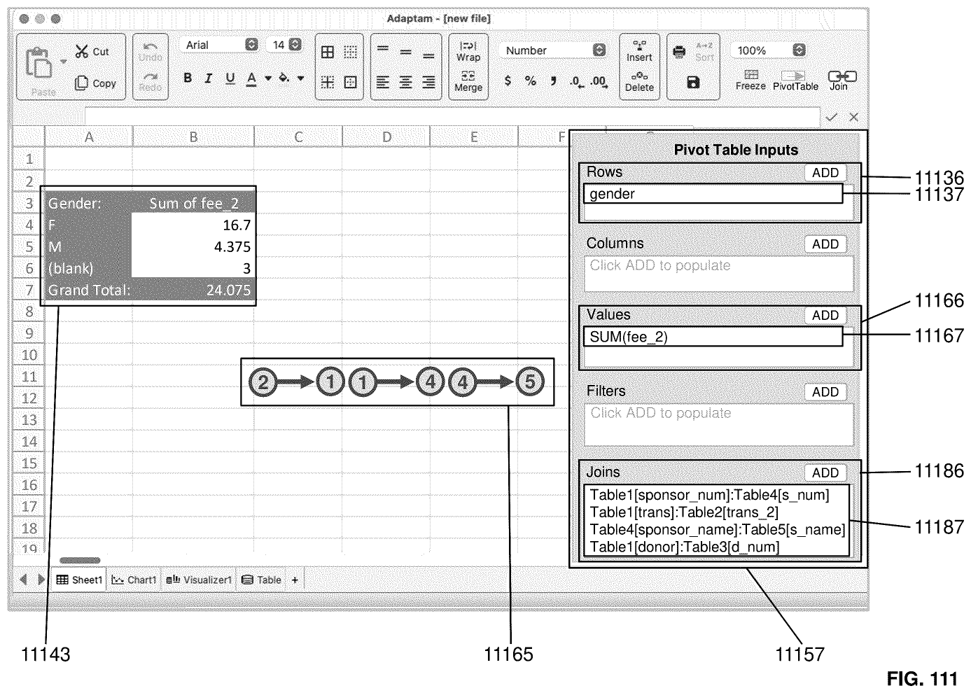

As previously exampled our technology supports many different variants of joined field selection list. FIG. 107 through FIG. 110B and FIG. 48 examples multiple selection list uses of starting from the chained join setup in FIG. 107. The user has begun to setup a Pivot Table employing the data sets in FIG. 47 employing the color-coded joins invoked by the joins 10787 in FIG. 107 shown in the ‘Joins’ input 10786 in the ‘Pivot Table Inputs 10757. The user has inputted ‘SUM(fee_2) 10767 into the ‘Values’ input 10766 and when they place the cursor 10737 into the ‘Rows’ input 10736 this embodiment automatically populates the selection list 10743 displaying the fields 10744 in the same table as the field ‘fee_2’ already populated in the Pivot Table inputs and an ‘ADD . . . ’ selection 10724 that makes accessible all the other joinable fields. Those fields are in the tables as illustratively indicated by the chained joins 10774 and 10765 starting with ‘Table2’ (‘2’). To access those joinable fields the user clicks the “ADD . . . ’ selection 10724 selection to get the selection list 10822 in FIG. 108A and 10862 in FIG. 108C (which are both the same simply supporting two different examples). Those selection lists display the joinable tables 10842 in FIG. 108A and 10872 in FIG. 108C with in this embodiment a ‘DESCRIPTION’ of each table (although in other embodiments the selection list could have more information, e.g., number of fields per table and/or number of rows per table, or just the list of tables). FIG. 108A examples the user selecting ‘Table3’ 10832 to then automatically open in this embodiment the selection list 10837 in FIG. 108B. That selection list displays the chain joinable fields 10847 in ‘Table3’ from which the user selects ‘donor_name’ 10857 which then populates where the cursor was 10937 in the ‘Rows’ input 10936 in FIG. 109. This automatically triggers the population of the Pivot Table output 10943 having used the chain join illustratively diagrammed in 10974 for the ‘Values’ formula ‘SUM(fee_2)’ 10967 in the ‘Values’ input 10966. This example employed some of the joins 10987 shown in the ‘Join’ input 10986 in the ‘Pivot Table Inputs’ 10957, however our technology also supports it working with the non-visible joins described previously and exampled in FIG. 49 versus FIG. 48 (with the visible joins). The Pivot Table result 10943 is automatically delivered using the illustrative chain join in FIG. 110A which is then used in the steps in FIG. 110B.

Returning to FIG. 108C for an alternative to the selection made in FIG. 108A had the user instead selected ‘Table5’ 10882 from amongst the joinable data sets 10872 within the selection list 10862. This automatically triggers the selection list 10867 in FIG. 108D. That selection list displays the chain joinable fields 10877 in ‘Table5’ from which the user selects ‘gender’ 10887 which then populates where the cursor was as exampled in 11137 in the ‘Rows’ input 11136 in FIG. 111. This automatically triggers the population of the Pivot Table output 11143 having used the chain join illustratively diagrammed in 11165 for the ‘Values’ formula ‘SUM(fee_2)’ 11167 in the ‘Values’ input 11166. This example employed some of the joins 11187 shown in the ‘Join’ input 11186 in the ‘Pivot Table Inputs’ 11157, however our technology also supports it working with the non-visible joins described previously and exampled in FIG. 49 versus FIG. 48 (with the visible joins). The Pivot Table result 11143 is automatically delivered using the illustrative chain join in FIG. 50A which is then used in the steps in FIG. 50B.

While we could example more chained join selection list variants supported by our technology, for brevity's sake we will instead move onto exampling how our technology works for multiple joins active at one time between two data sets.

### Multiple Joins Between Two Data Sets

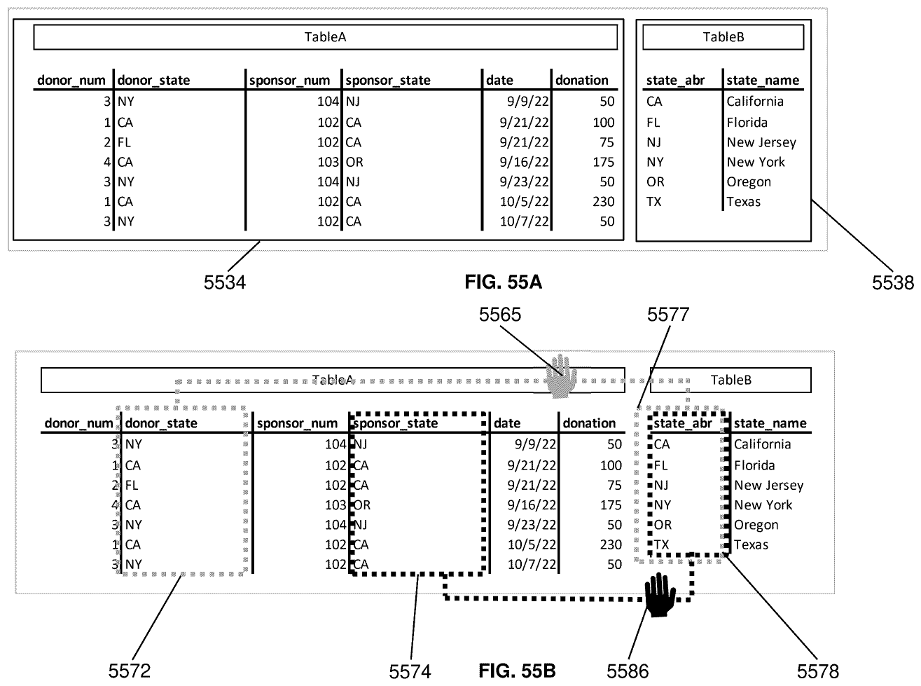

Our technology works for multiple potential join key pairs between the same two data sets at the same time. Something that is not possible in Microsoft Excel as identified in their support in FIG. 3C that states ‘To build accurate calculation, Excel needs a single join path from one table to the next. Therefore, only one relationship between each pair of tables is active at a time.’ in the Microsoft Excel technology. FIG. 55A through FIG. 64B examples our spreadsheet PivotTable double joining two data sets as part of the PivotTable result. Therefore, having more than one relationship between each pair of tables active at one time. We will now example having two such relationships active at one time although our technology can support more than two active at one time.

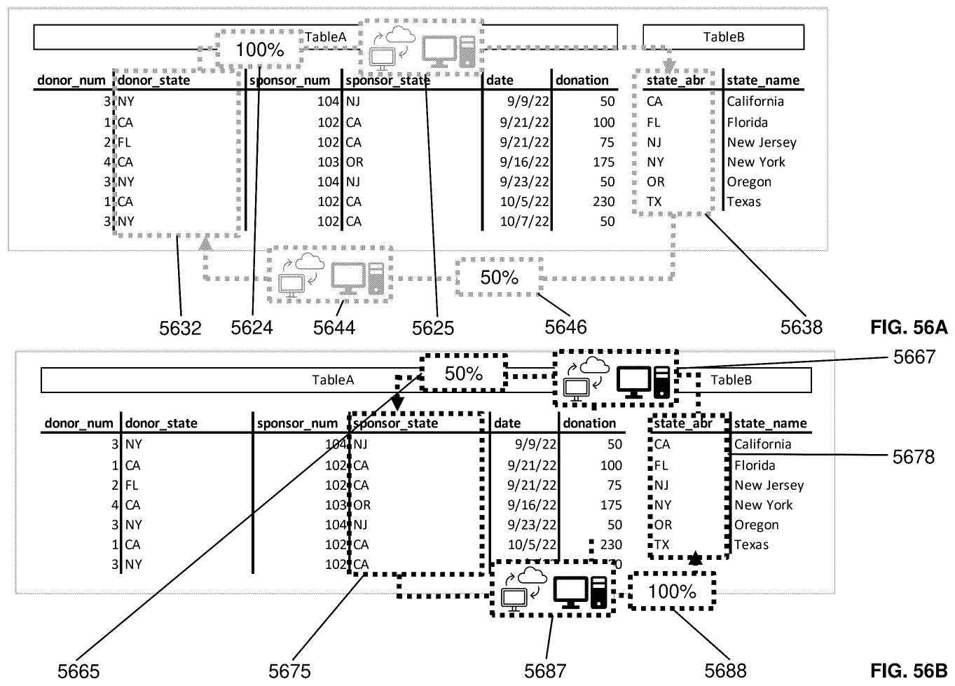

FIG. 55A examples the charity user using two data sets, ‘TableA’ 5534 and ‘TableB’ 5538. They have two potential pairs of join key pairs 5572/5577 and 5574/5578 which are manually specified by the user 5565 and 5586 as exampled in FIG. 55B. It is worth noting that 5577 and 5578 are actually the same join key (note, sharing a join key in one of the data sets is a requirement of how our technology works) used for two different joins which are color coded and therefore separately labelled. That manual specification could then be verified by our technology in different embodiments along the lines previously discussed (e.g., FIG. 27). FIG. 56A and FIG. 56B illustratively example those same two joins (with join keys 5632/5638 and 5675/5678) being automatically generated and validated 5624/5646 and 5665/5688 (as exampled by match percentages) on the user's computer, in the cloud or some combination of the two 5625/5644 and 5667/5687. The data types are the same for each join key pair, one of each join key pair is unique, and the values matches are all ‘50%’ or higher (as shown in 5624/5646/5665/5688), thus passing the one-way and two-way match requirements set for this embodiment (e.g., >=50%). Those setup and validation actions could be done using any of the previously exampled appropriate UIs. Note the join keys 5638 and 5688 are the same therefore fulfilling the requirement for sharing one of the join keys across the joins.

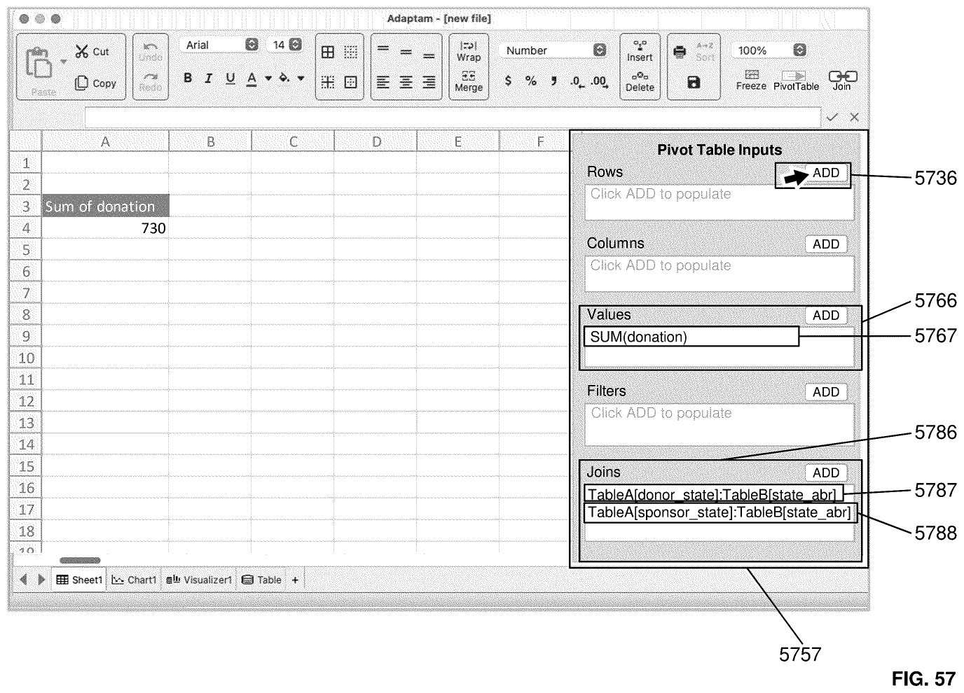

FIG. 57 through FIG. 64B examples our charity user using the double joined data within one of our PivotTables. They would like to display in a PivotTable the total donations by donor state of residence (‘Rows’) then further broken by their sponsor state of residence (‘Columns’). With the two double joins prequalified (flagged) before this PivotTable so that the selection lists automatically display the double joinable fields with an added capability within our technology of automatically changing the naming of the double joined fields to reflect which double join is employed. This embodiment utilizes our technology automatically revising those fields/column names. Other embodiments allow the user who prequalified the joins to specify the name of the joins used to modify the field names.

We will now example the user creating a PivotTable using one of the previously exampled types of selection lists (i.e., similar to the selection lists in FIG. 39D and FIG. 39E) in employing the double joined fields. In FIG. 57 the user has already populated ‘SUM(donation)’ 5767 in the ‘Values’ input 5766. The double joins 5787 and 5788 between ‘TableA’ and ‘TableB’ are visible in the ‘Joins’ input 5786 within the PivotTable inputs 5757. It is important to note that the double joins share one data set and join key in common, ‘TableB[state_abr]’ in this example and then have the other two join keys different, as shown by ‘TableA[donor_state]’ and ‘TableA[sponsor_state]’ in this example. This is a requirement of this embodiment that one data set and join key combination is shared and the other data set join keys are different. Note, if the user were to set up three joins between the two data sets, then all three joins would have one data set and one join key in common and all three matching join keys would have different fields in the other data set.

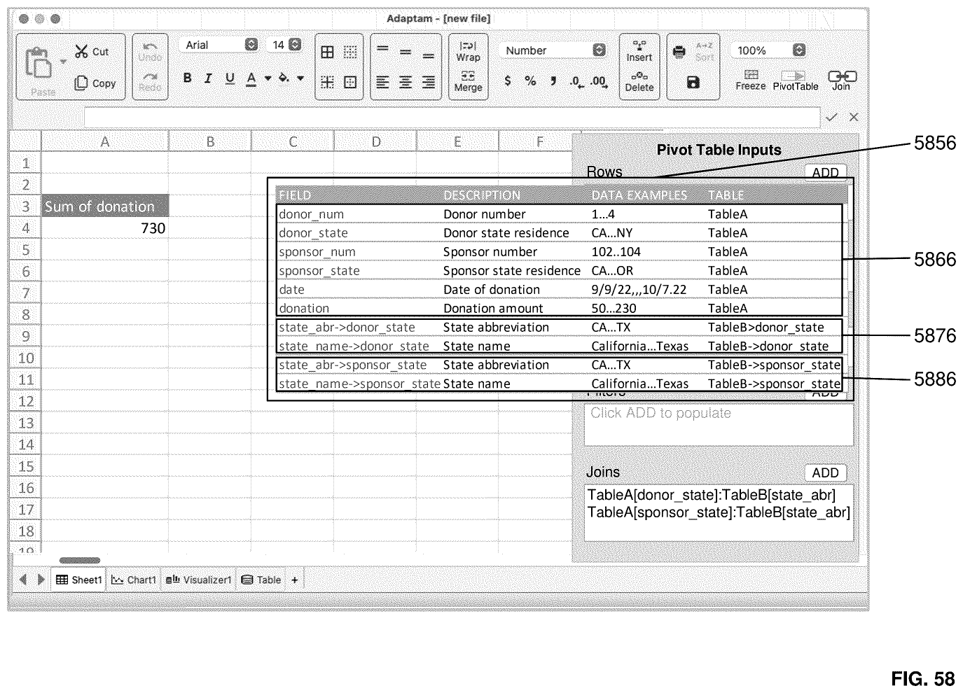

The user then decides to add a ‘Rows’ in this embodiment clicking the ‘ADD’ button 5736 in FIG. 57 to automatically get the selection list 5856 exampled in FIG. 58. This selection list automatically gives the user all the fields 5866 in the data set (‘TableA’) containing the field ‘donation’ and all the fields in other data sets joinable to ‘TableA’. Because ‘TableA’ is double joined to ‘TableB’ it does not display in this embodiment the regular ‘TableB’ fields, but the two sets of double joined ‘TableB’ field 5876 and 5886. Our technology has automatically differentiated those two different sets of ‘TableB’ fields in this embodiment by appending a label that identifies the join that produces it. In this embodiment that is the ‘->’ arrow like set of characters followed by the join key field in ‘TableA’ used for it (the join). That join key is a unique identifier in this situation because the join key in ‘TableA’ is different for the two different joins. So, the first listed set of ‘TableB’ fields/columns 5876 has the join key identifier ‘donor_state’. The second listed set of ‘TableB’ fields/columns 5886 has the join key identifier ‘sponsor_state’. Note, in this embodiment the join key field names and the ‘->’ set of characters have been automatically appended to each of the fields/columns (e.g., ‘state_abr->donor_state’) as well as the data set name (e.g., ‘TableB->donor_state’) to uniquely identify the two different joins.

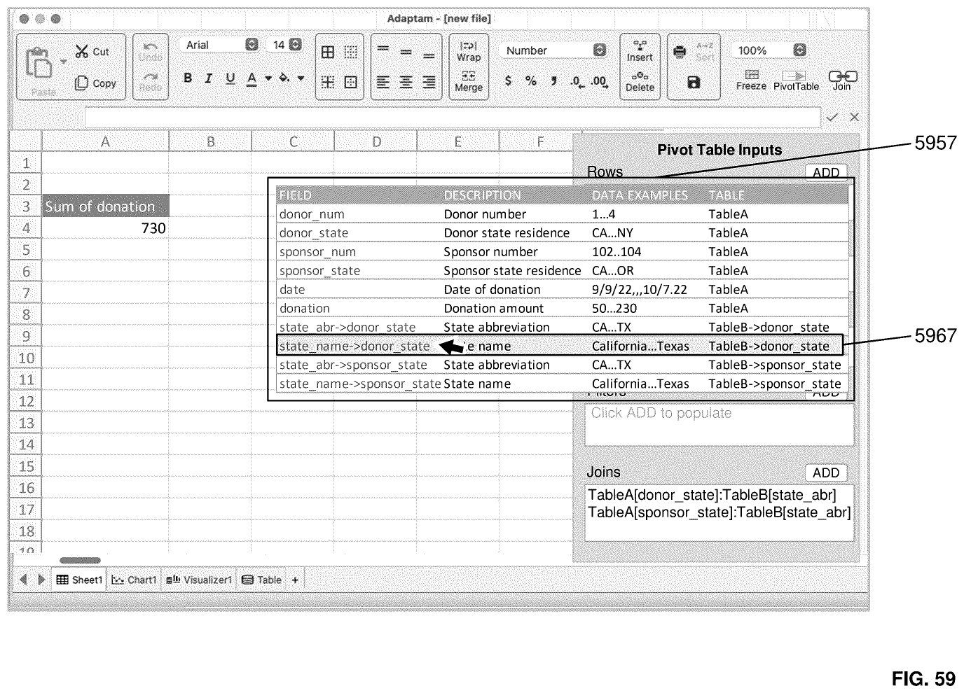

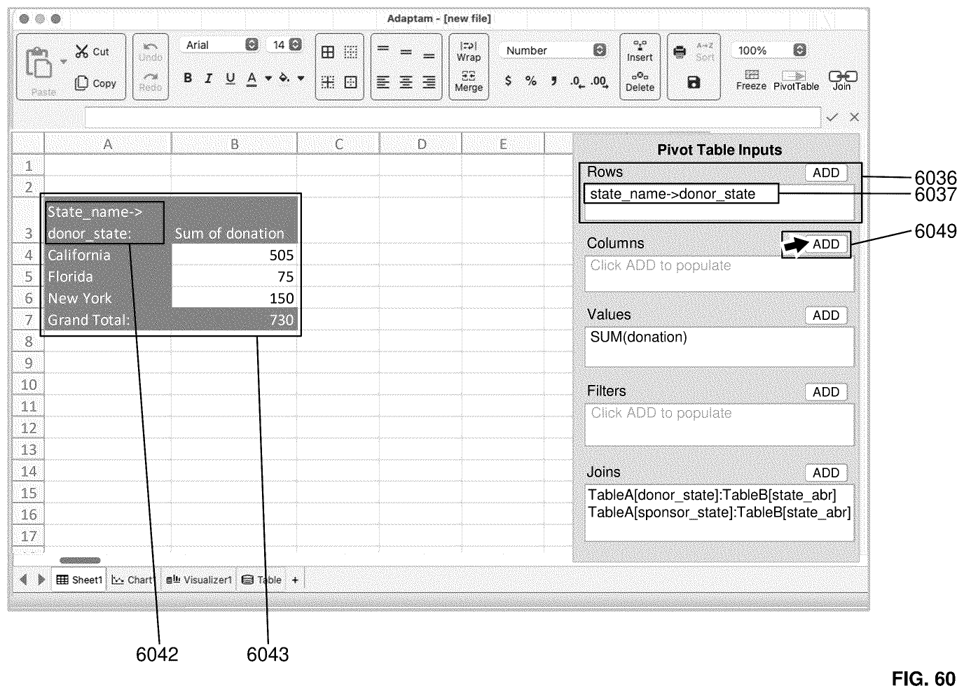

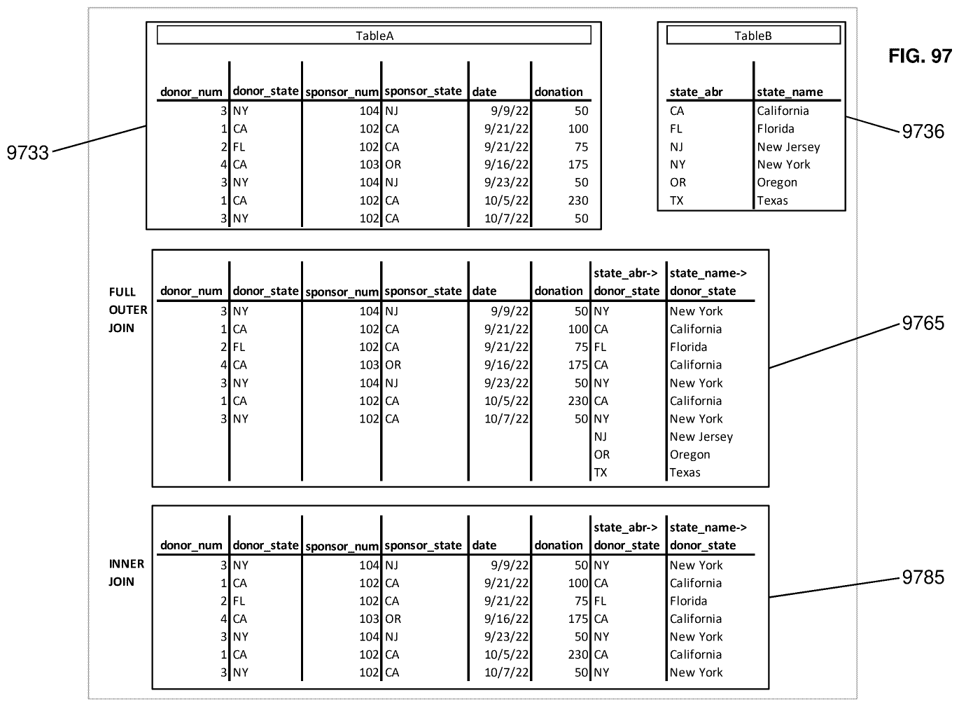

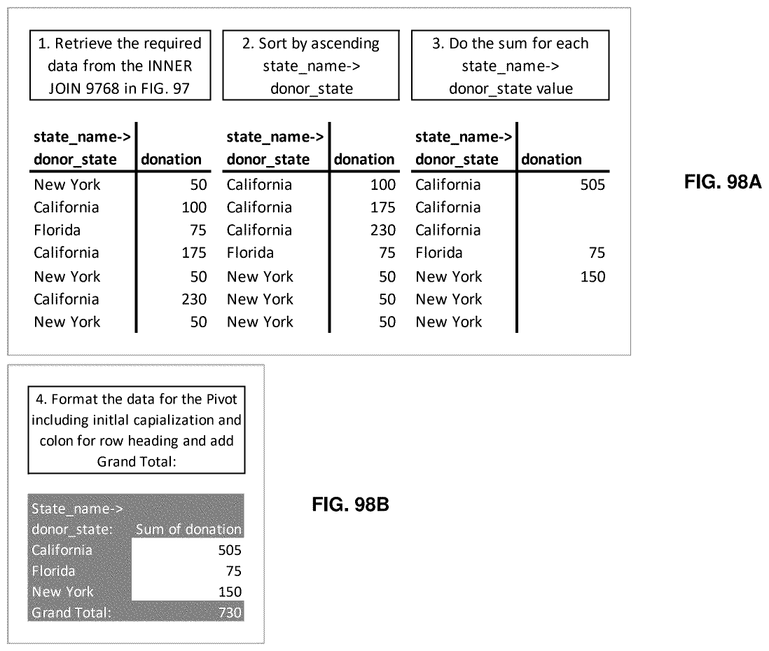

In this example the user selects ‘state_name->donor_state’ 5967 in the selection list 5957 in FIG. 59 which populates the field/column as shown in ‘state_name->donor_state’ 6037 in the ‘Rows’ input 6036 in FIG. 60. This gives the PivotTable result 6043, and in this embodiment populates the ‘Rows’ input ‘state_name->donor_state’ 6037 initial capitalized and followed by a colon ‘State_name->donor_state:’ 6042 in the PivotTable result 6043. At this point the user has generated a PivotTable using one of the two double joined “TableB’ data sets. FIG. 97 illustratively examples our technology executing the single double join of ‘TableA’ 9733 and ‘TableB’ 9736 for the ‘donor_state’ join for both a ‘FULL OUTER JOIN’ 9765 and a ‘INNER JOIN’ 9785. FIG. 98A and FIG. 98B then illustratively examples our technology using the relevant ‘INNER JOIN’ data to do the PivotTable manipulations and calculations to generate the result 6043 in FIG. 60. The user could have as easily used the other double join or as we will example next use both double joins.

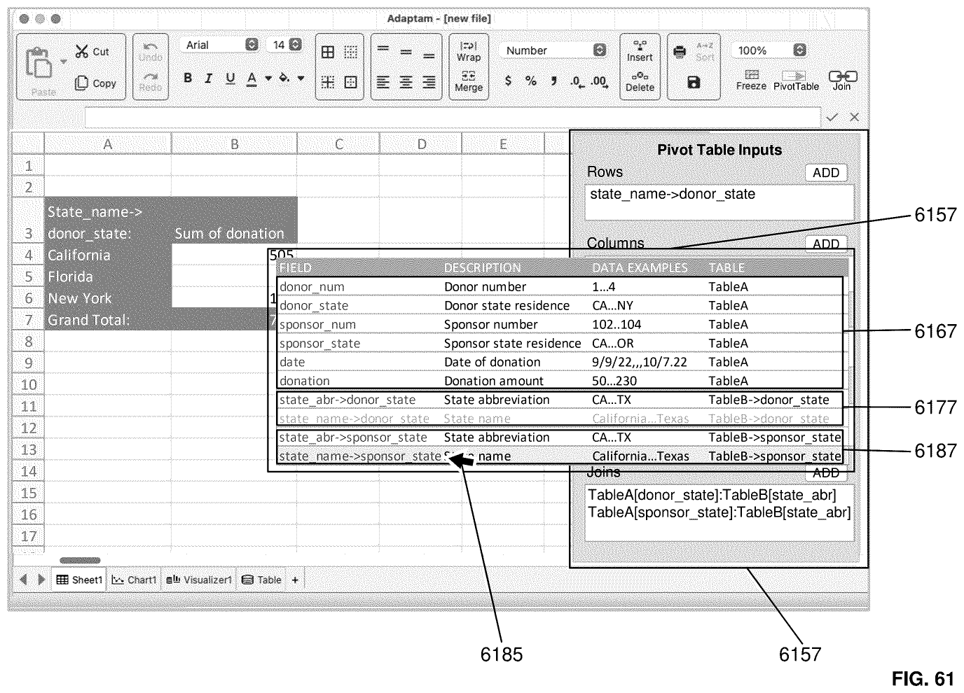

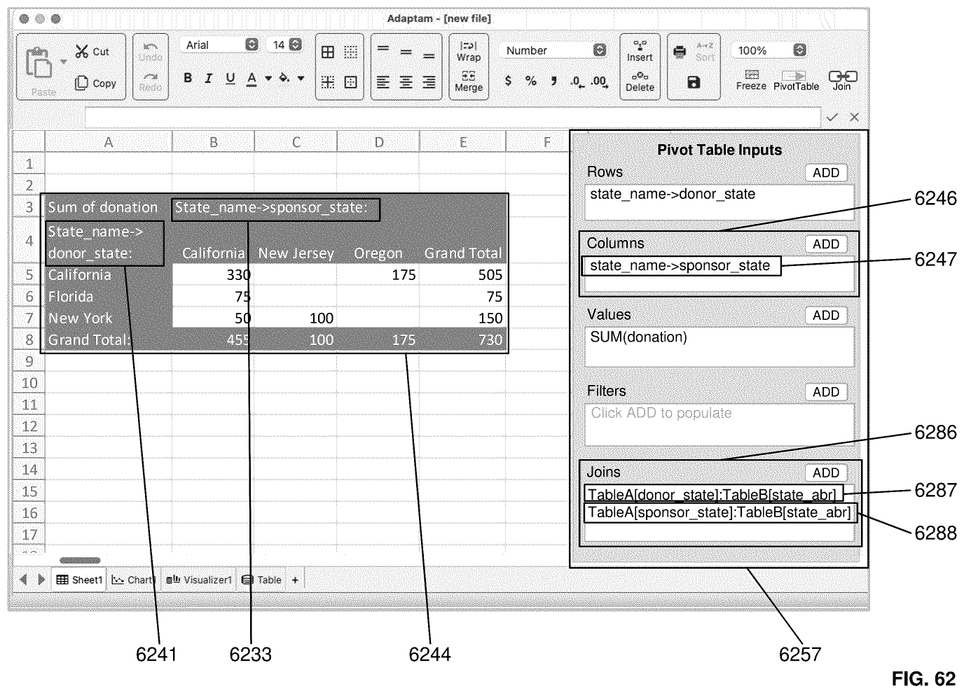

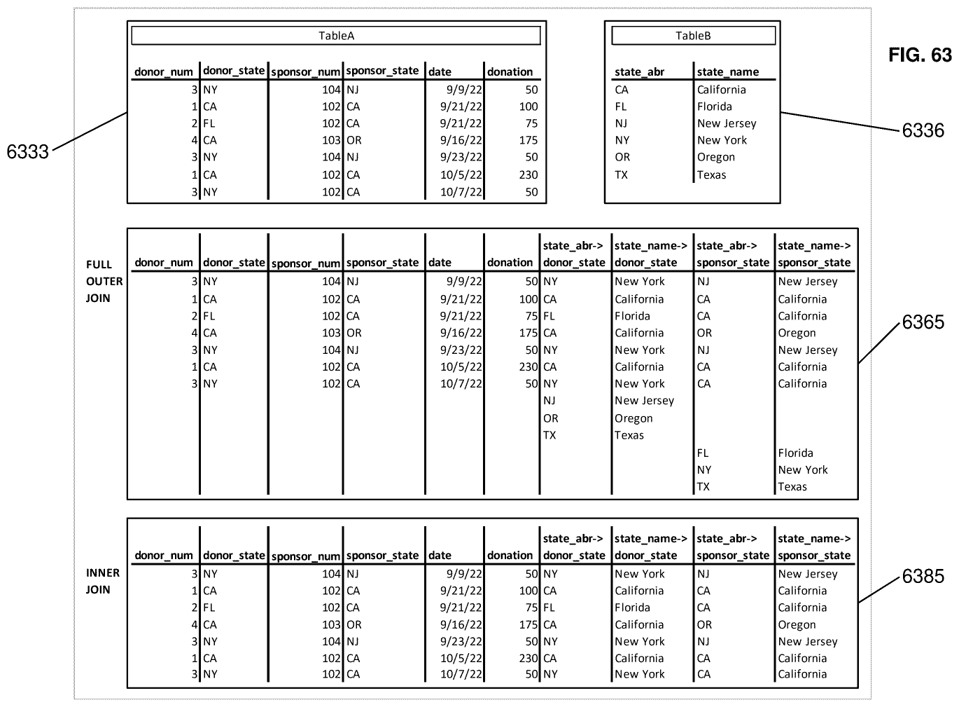

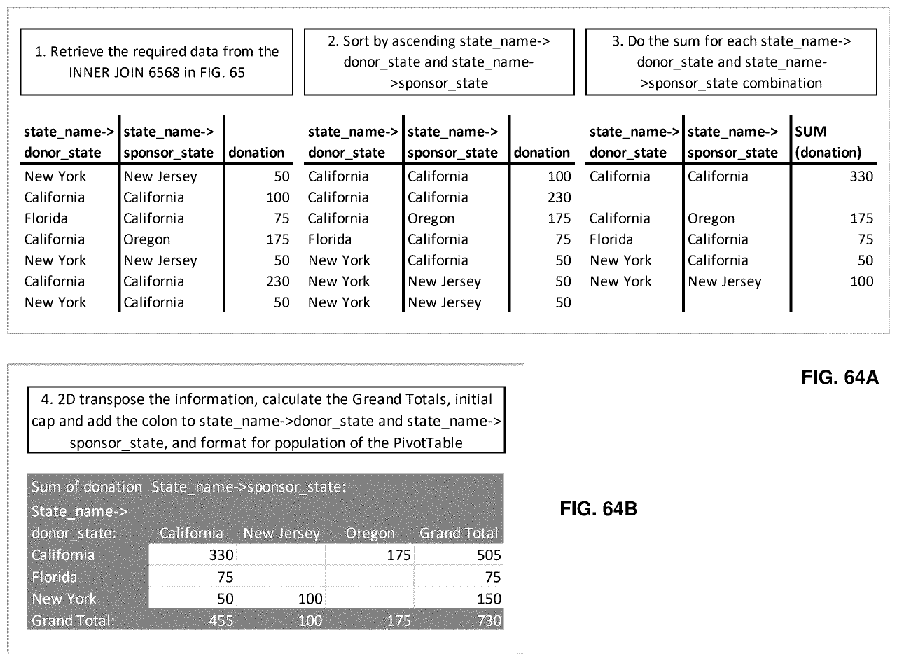

The user continues on because they want to also break the results by sponsor state, which will in this example involve employing the other double join. They click on the ‘Columns’ ‘ADD’ button 6049 that opens the selection list 6157 in FIG. 61 working for the ‘Columns’ input within the PivotTable inputs 6157. Like before that selection list contains all the joinable fields from ‘TableA’ 6167 and the two joins 6177 and 6187 of ‘TableB’. Because in this embodiment ‘state_name->donor_state’ in 6177 was used in the ‘Rows’ inputs it is disabled (grayed out) but otherwise the user has access to all the joinable fields/columns. They see the sponsor state field/column ‘state_name->sponsor_state’ 6185 and click to populate the field/column ‘state_name->sponsor_state’ 6247 into the ‘Columns’ input 6246 and generate the PivotTable result 6244 in FIG. 62. Our technology has automatically executed the chained/sequence join of ‘TableB’ twice to ‘TableA’ as illustratively exampled in FIG. 63 and then used the joined data in illustrative calculations/actions in FIG. 64A and FIG. 64B to generate the PivotTable result 6244 in FIG. 62.

Note, that FIG. 63 examples the coexistence of the two double joins illustratively exampled in a ‘FULL OUTER JOIN’ 6365 of all the columns/fields of two data sets, ‘TableA’ 6333 and ‘TableB’ 6336. While 6385 examples a ‘INNER JOIN’ double join of all the columns/fields of two tables, ‘TableA’ 6333 and ‘TableB’ 6336. Recognizing that in most of situations our pivot table joining technology is using a subset of the joined fields/columns in the PivotTable as is the situation in FIG. 62. Also note in this embodiment our technology automatically populates the ‘Columns’ input ‘state_name->sponsor_state’ 6247 initial capitalized and followed by a colon ‘State_name->sponsor_state:’ 6233 in the PivotTable result 6244 to go along with the ‘Rows’ heading 6241 previously populated.

At this point the user has the PivotTable they desire. Our technology took the two prequalified joins (flag) between data sets ‘TableA’ and ‘TableB’ and in this embodiment automatically generated the joined fields and tables with altered names (to differentiate the two double joins), made them available in selection lists. and once selected automatically executed the chained/sequenced double join to deliver the PivotTable 6244 in FIG. 62. While this example used prequalified joins, the joins could have been inputted in this PivotTable inputs 6257 in the ‘Joins’ input 6286 or some other way of populating the joins 6287 and 6288. Note, those double joins could be inputted or listed using any of a number of different join syntaxes or join function syntaxes described herein.

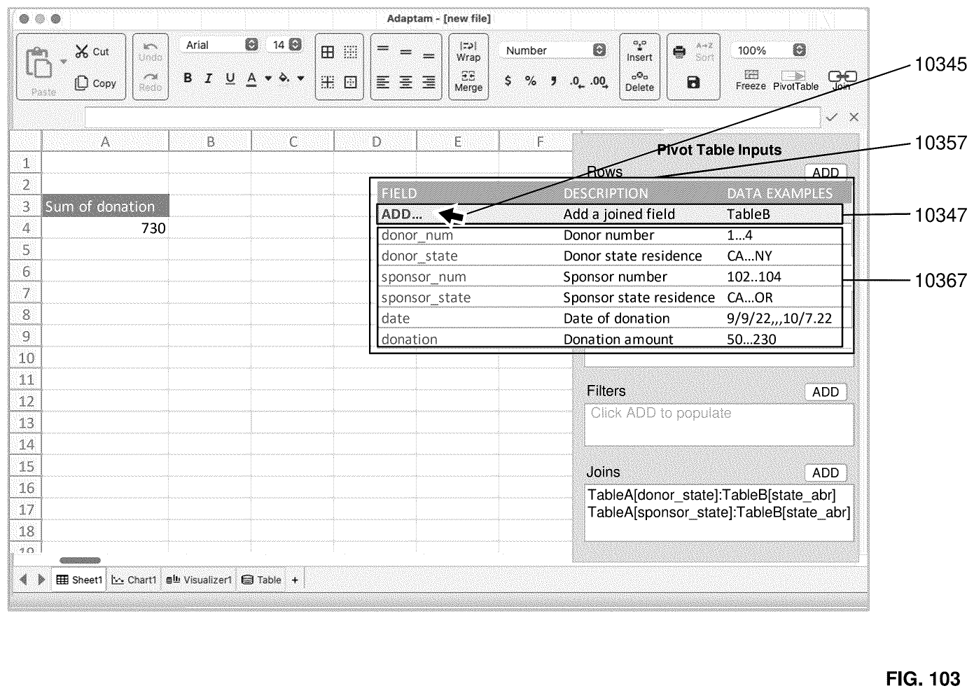

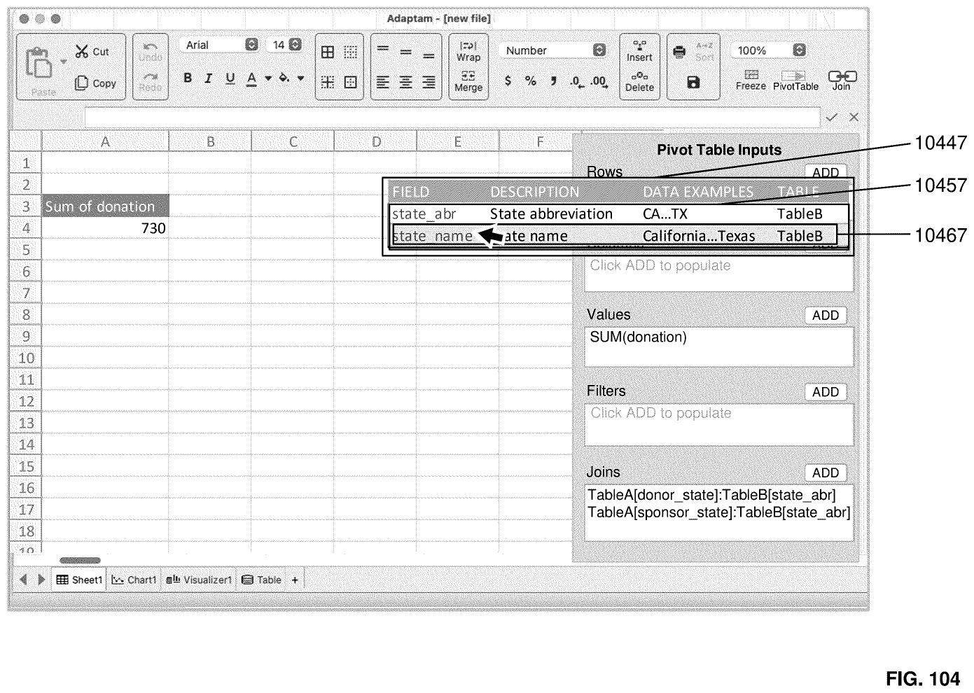

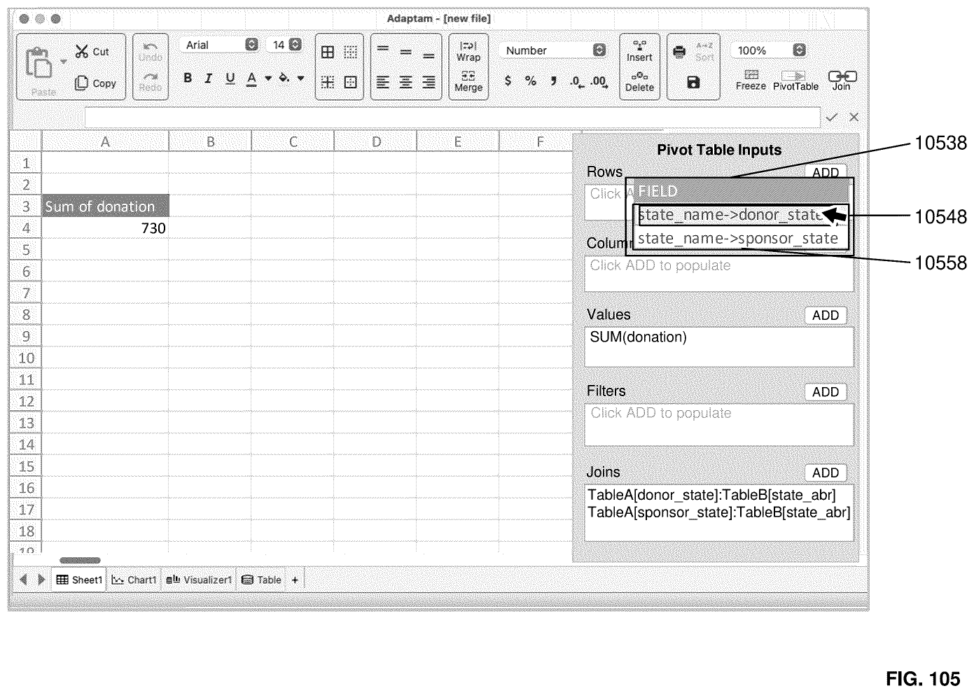

Our multiple joins between two tables creates many different ways for our technology to present the prequalified joins to the user in our selection lists. In FIG. 58, FIG. 59, and FIG. 61 the selection lists (5856, 5967, and 6157) present the full list of field and double joined field options at one time. However, they could be done more sequentially as exampled in FIG. 103 FIG. 104, and FIG. 105. FIG. 103 examples an alternative for what happens when the user clicks the ‘ADD’ button 5736 in FIG. 57. In this embodiment of the selection lists the user is then presented with the selection list 10357 in FIG. 103. This selection list 10357 contains the fields 10367 which are in the same table as the ‘donation’ field in ‘SUM(donation) input 5767 in FIG. 57 and instead of showing all the other joinable fields it displays an ‘ADD . . . ’ line 10347 which the user clicks 10345 to open the selection list 10447 in FIG. 104. That selection list 10447 displays the joinable fields and descriptive information about those fields. Although had there been multiple tables it could have shown a table selector list from which they could select what data set they would like to select from. In this example the selection list 10447 displays the two fields 10457 in ‘TableB’ (the only joinable data set). The user then selects ‘state_name’ 10467 which then automatically opens the selection list 10538 in FIG. 105. That selection list 10538 displays the two double join options 10558 for the field ‘state_name’, specifically ‘state_name->donor_state’ and ‘state_name->sponsor_state’. This embodiment has made the last selection the one where the user decides which of the double (or multiple if more than two) joins to use. In this example the user selects ‘state_name->donor_state’ 10548 which then delivers the results 6043 shown in FIG. 60.

While we could example different double join examples, more ways of populating those double joins, and different types of selection lists, for brevity's sake we will move onto exampling further automation that sometimes occurs in these double (or more) joins between two data sets. There are two important situations, one where user selections result in the automatic replacement of a non-joined field with one of its double (or more in situations with triple or more joins) join fields and the second where it is impossible for our technology to do an automatic replacement but instead automatically prompts a user replacement selection (of a non-multi joined variant of field in a multi-joined dataset).

### Multiple Joins Between Two Data Sets—Automated Field Replacement

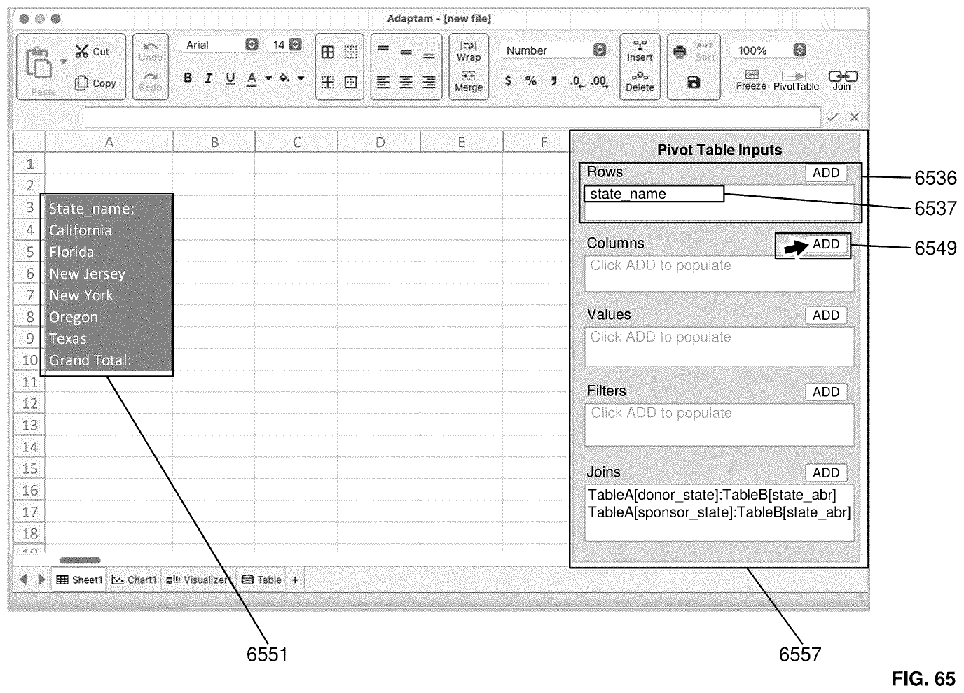

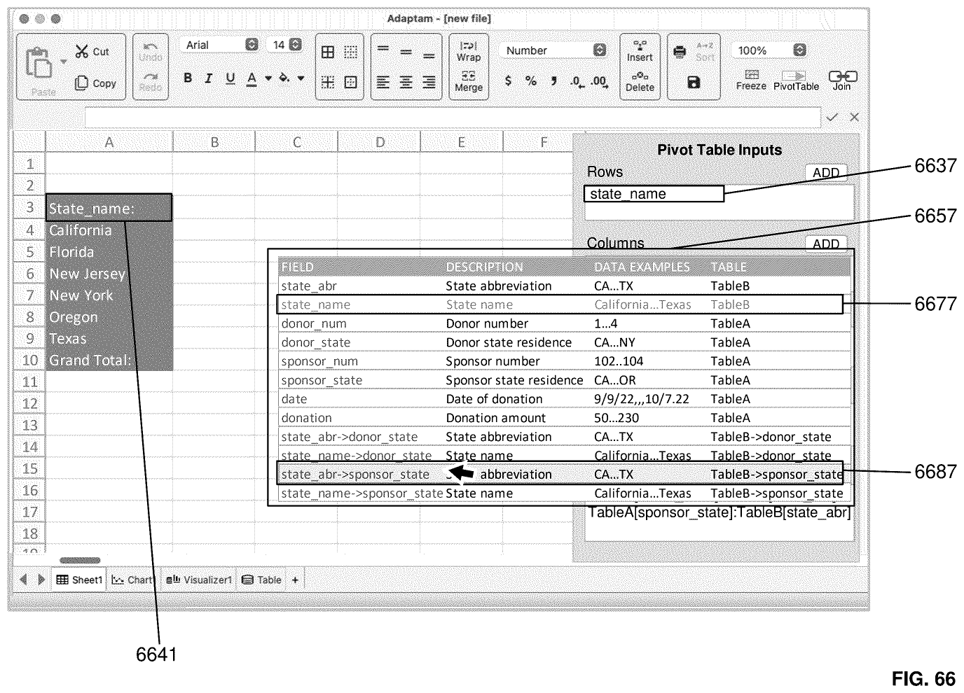

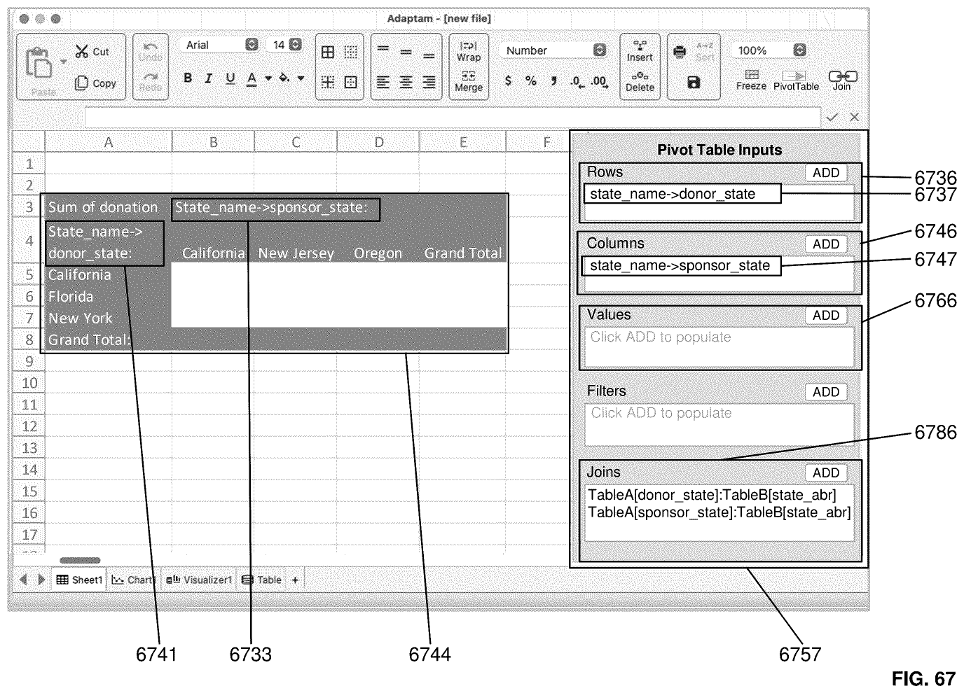

There are situations where a user starts with the regular version of one of the fields in a double joined data set and then selects as a PivotTable input one of the fields in the data set on the other side of the double join. In a few of those situations our technology is able to automatically replace the regular version field as exampled in FIG. 65 through FIG. 67 where the user wants to create the PivotTable in FIG. 62. The difference is the user started populating the regular version of ‘state_name’ 6537 in the ‘Rows’ input 6536 of the PivotTable inputs 6557 to get the result 6551. They then clicked the ‘Columns’ ADD button 6549 which automatically opened the selection list 6657 in FIG. 66. Because in this embodiment the same field cannot be used in both a ‘Rows’ and a ‘Columns’ the field ‘state_name’ 6677 is disabled. The user sees that the field that they want ‘state_name->sponsor_state’ and selects it 6687. Because a double joined field cannot exist in a PivotTable with a regular version field from the same data set, the ‘state_name’ field 6637 must be changed to a double joined version. That is automatically done by our technology in this situation because there is only one version of the double joined ‘state_name’ available because the other one was just selected 6687. Therefore, our technology automatically substitutes ‘state_name->donor_state’ 6737 in the ‘Rows’ input 6736 in FIG. 67 for ‘state_name’ 6637 in FIG. 66 as it populates ‘state_name->sponsor_state’ 6747 in the ‘Columns’ input 6746 in the ‘Pivot Table Inputs’ 6757. In this embodiment it also replaces ‘State_name:’ 6641 in FIG. 66 in the PivotTable output 6744 in FIG. 67 with ‘State_name->donor_state:’ 6741 while it populates ‘State_name->sponsor_state:’ 6733 for the horizontal heading label/title.

In this embodiment the joins 6786 are visible but our technology also supports double joins that are not visible in the ‘PivotTable Inputs’ 6757. The user would then finish the PivotTable adding the ‘Values’ input or inputs 6766 as exampled previously to deliver the outcome in FIG. 62. As this automatic replacement capability is only applicable in a small number of situations we will move on to example the broader set of situations our technology supports automatically prompting the user to select a replacement.

### Multiple Joins Between Two Data Sets—Ambiguous Situation Field Replacement

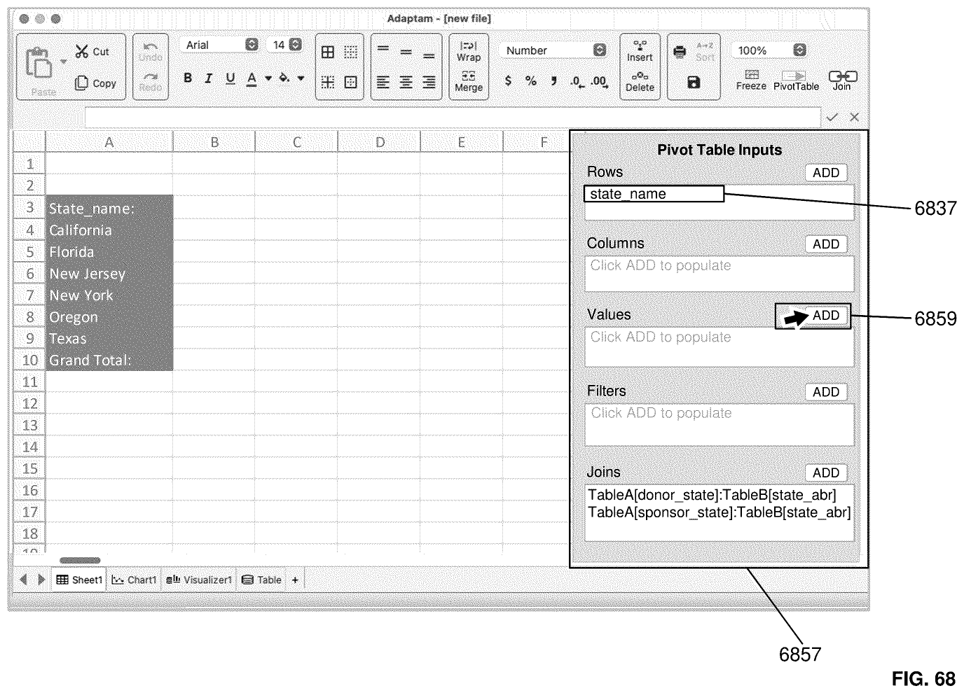

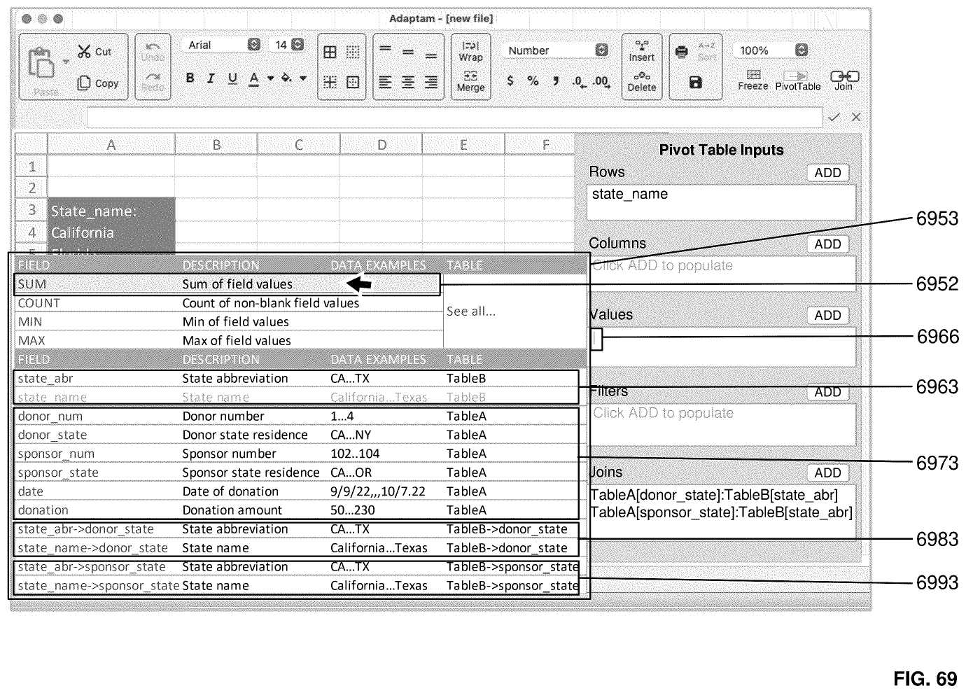

FIG. 68 through FIG. 72 examples one of those ambiguous situations where a regular version of a double joined field replacement is required and is automatically prompted for user decision because only the user could decide with complete certainty on which of the multiple join fields to select. In FIG. 68 the charity user, again using the data sets in FIG. 55A through FIG. 56B, wants to create a PivotTable totalling the donations per state of donor residence. They start by populating ‘state_name’ 6837 in the ‘Rows’ input within the ‘Pivot Table Inputs’ 6857. They then click the ‘ADD’ button 6859 for the ‘Values’ input which automatically opens the selection list 6953 in FIG. 69 for input into the ‘Values’ box with the cursor 6966. Because ‘Values’ inputs include both fields and functions it displays function selects as well as the regular ‘TableB’ fields 6963 and all the joinable fields which includes the ‘TableA’ fields 6973, the ‘TableB->donor_state’ fields 6983, and the ‘TableB->sponsor_state’ fields 6993. Note, our PivotTables do not require a range function (e.g., SUM, COUNT, or MAX) in the “Values’ input but can accommodate fields by themselves which is then why the selection list 6953 contains both functions and fields.

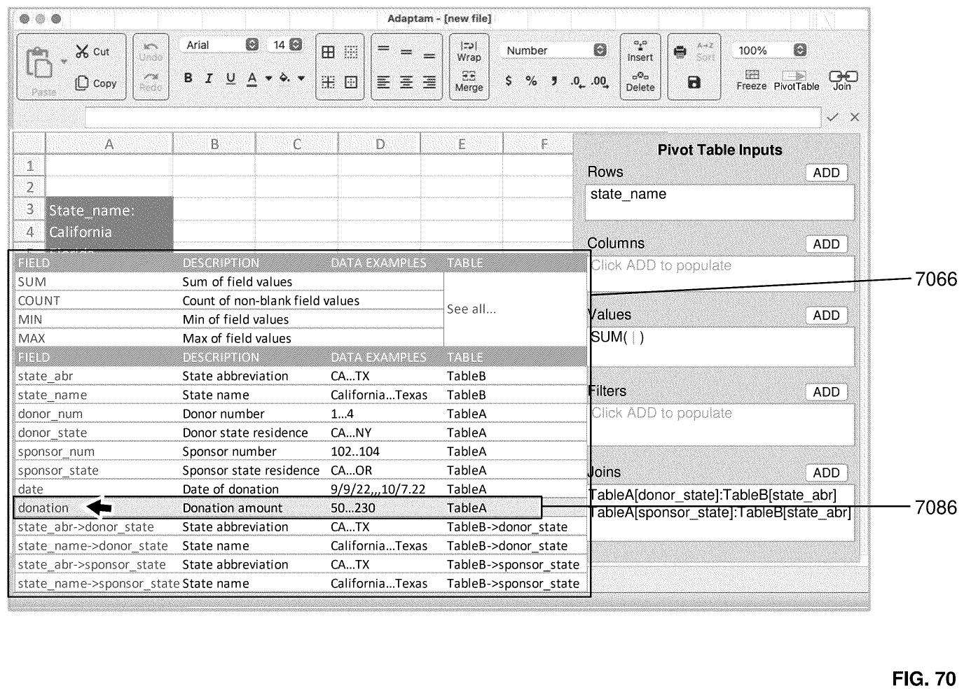

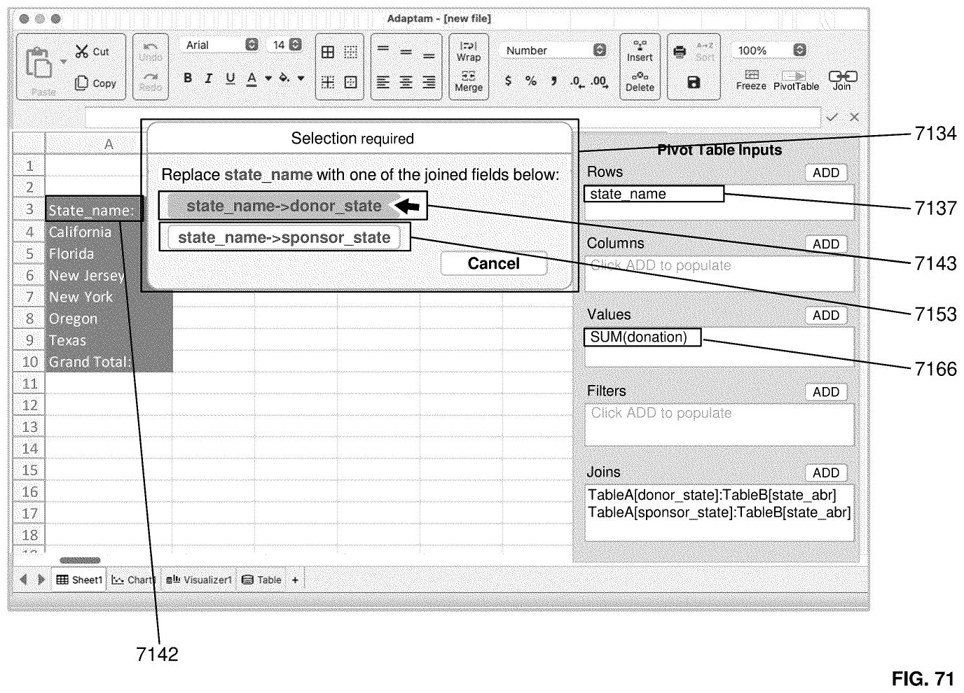

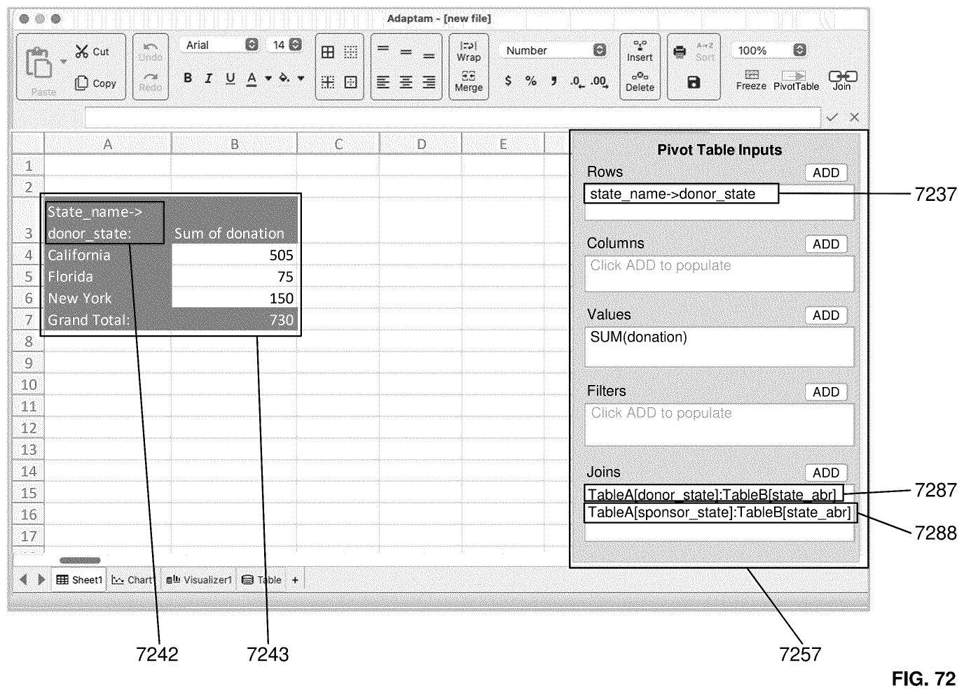

In this example the user selects ‘SUM’ 6952 which reopens the selection list 7066 in FIG. 70 where the user selects to ‘SUM’ ‘donation’ 7086 which in this embodiment of our PivotTable technology is done by creating the ‘SUM(donation)’ formula as shown in FIG. 71 7166. At this point the user has triggered a join between ‘TableA’ (‘donation’) and ‘TableB’ (‘state_name’) but ‘TableB’ is double joined to ‘TableA’ and there is no way for our technology to know which join the user wants. Therefore, our technology automatically opens a UI (in this example a popup 7134 exampled in FIG. 71) giving the user the alternatives ‘state_name->donor_state’ 7143 and ‘state_name->sponsor_state’ 7153 for replacement of the ‘Rows’ input ‘state_name’ 7137. The popup 7134 is just one of many different UIs supported by our technology to present the options for user selection. In this example the user selects ‘state_name->donor_state’ 7143 which then automatically changes the ‘Rows’ input from ‘state_name’ 7137 in FIG. 71 to ‘state_name->donor_state’ 7237 in FIG. 72. This also automatically executes the PivotTable generating the result 7243 and automatically replacing ‘State_name:’ 7142 in FIG. 71 to ‘State_name->donor state:’ 7242 in the FIG. 72 PivotTable results 7243.

These multiple joins between two table automatic replacement and automatically prompted user selection of fields work in our technology when the joins are visible in the PivotTable inputs 7257, as in 7287 and 7288 in FIG. 72, or are invisible. They also work whether the joins are prequalified before this PivotTable or are set up within it. The joins and PivotTable manipulations and calculations using the joined data to generate the results 7243 in FIG. 72 work as previously illustratively exampled and explained in FIG. 97, FIG. 98A, and FIG. 98B.

While we could example multiple additional join situations supported in our technology with more than two joins between the same two data sets, they work in a similar manner and have similar replacement issues. So instead, we will move onto exampling a cardinality situation that does not occur in two table joins but occurs in three or more chained/sequenced join situations.

### Three or More Data Set Joins Situational Selection List Potential Joins

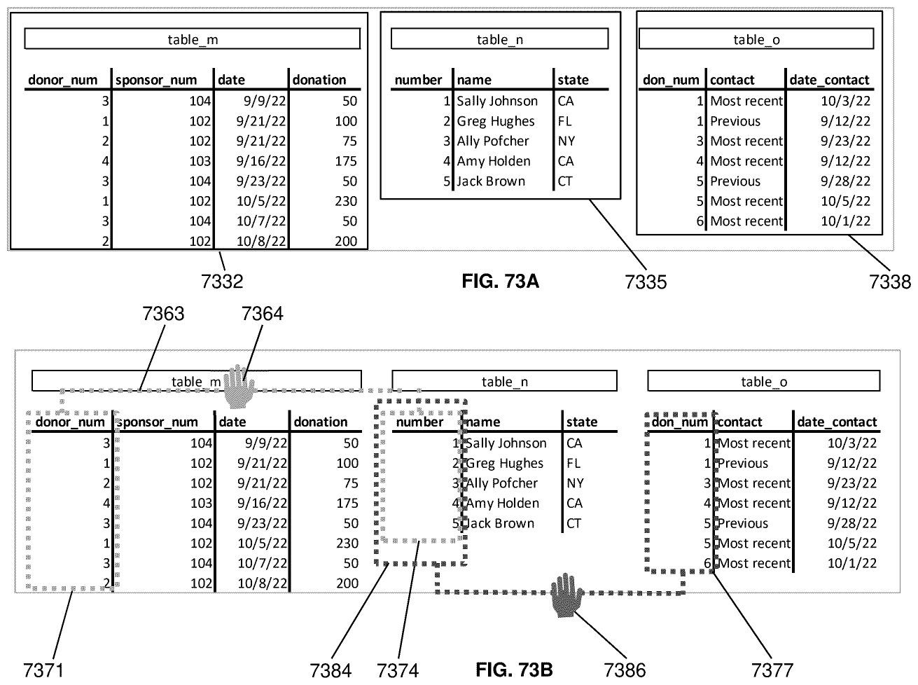

FIG. 73A through FIG. 79 examples a situation that does not occur in two data set joins but can occur in three or more data set chained/sequenced joins, where there is a cardinality rule of blocking non-unique to non-unique (many to many) joins. That is accepting only unique to unique and unique to many (and vice versa) cardinality joins. The situation is where a chained/sequenced join turns individually unique to non-unique join key pair joins into a chained/sequenced non-unique to non-unique join (many to many) key pair joins. In this situation, an embodiment of our selection lists can initially offer multiple joinable data sets in the selection list but once one of the fields from one of the data sets that then chains/sequences to become a many to many join is populated in the PivotTable inputs the other data set is no longer visible in the selection lists and option to join that data set automatically goes away. Embodiments supported by our technology then can differ in what they do. For example, one embodiment can generate an error if the user goes ahead and populates a field from that disappearing data set. Another embodiment can allow the user to complete the chained/sequenced join and populate the field in the formula for a successful chained/sequenced join use but do it without the aid of selection list. A third embodiment allows the user to reinstate the join through adding it back and once that is done support it with selection lists.

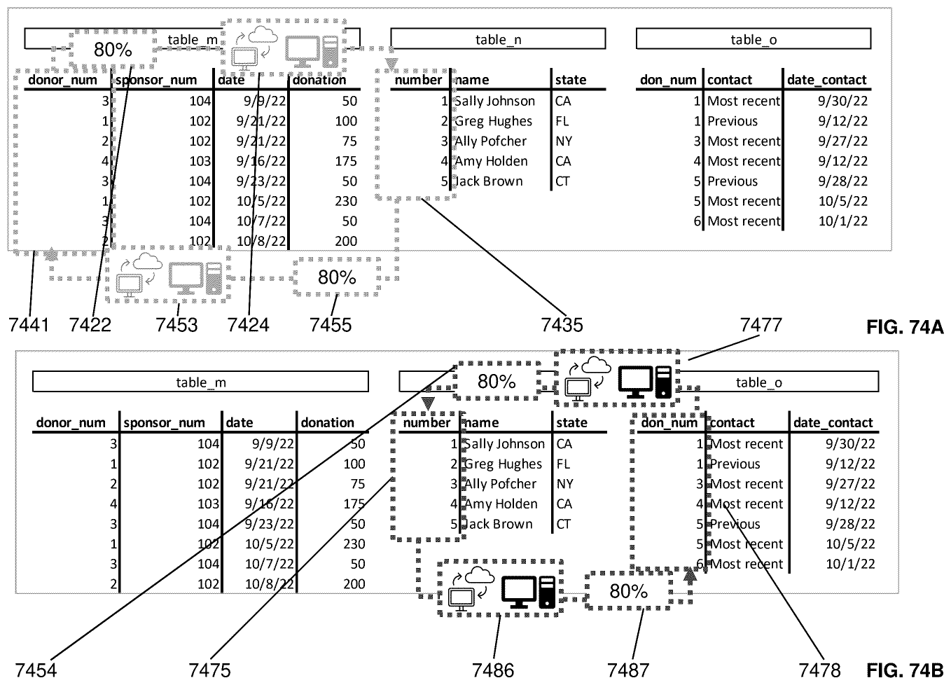

FIG. 73A examples three data sets ‘table_m’ 7332, ‘table_n’ 7335, and ‘table_o’ 7338. There could be more data sets available to the user, but we will focus on these three because they are joinable to each other. FIG. 73A data sets ‘table_m’ 7332 and ‘table_n’ 7335 have potential join keys 7371/7374 in FIG. 73B where join key ‘donor_num’ 7371 is non-unique and ‘number’ 7374 is unique. ‘Table_n’ 7335 and ‘table_o’ 7338 in FIG. 73A have potential join keys 7384/7377 in FIG. 73B where join key ‘don_num’ 7377 is non-unique and ‘number’ 7384 is unique. In FIG. 73B these join key pairs are manually specified by the user 7364/7386. That manual specification could then be verified by our technology in one or more different embodiments along the lines previously discussed and exampled in FIG. 27. FIG. 74A and FIG. 74B illustratively examples those same two potential joins being automatically generated, and qualification validated (7422/7455 and 7454/7487) on the user's computer, in the cloud or some combination of the two 7424/7453 and 7477/7486. The data types are the same for each join key (7441/7435 and 7475/7478) pair, all the join key pairs are unique to non-unique, and the values matches are all ‘80%’ (as shown in 7422/7455/7454/7487), thus passing the one-way and two-way match requirements set for this embodiment (e.g., 75%). Those setup and qualification validation actions could be done using any of the previously exampled appropriate UIs or alternatives in our spreadsheet application or a separate data intake tool. They could be done fully automatic or semi-automatic or multiple combinations with a user or our application making the final determination on the joins.

The user now has the qualification flag set for both of the unique to non-unique data set joins before this PivotTable. In this embodiment that qualification flag setting supports selection lists and PivotTable results that are unique to unique and unique to non-unique (and vice versa) cardinality joins but not non-unique to non-unique joins. The situation in this example is while both individual joins are unique to non-unique when they are chained/sequenced that chained/sequenced join is a non-unique to non-unique. Therefore, in this embodiment our technology does not support that chained/sequenced join for either selection lists or successful PivotTable results generation. The rationale for this qualification setting is to protect the unsophisticated user from partial Cartesian Products created in the join that can distort values such as the total amount of donations (e.g., increasing the total donations above the amount actually given).

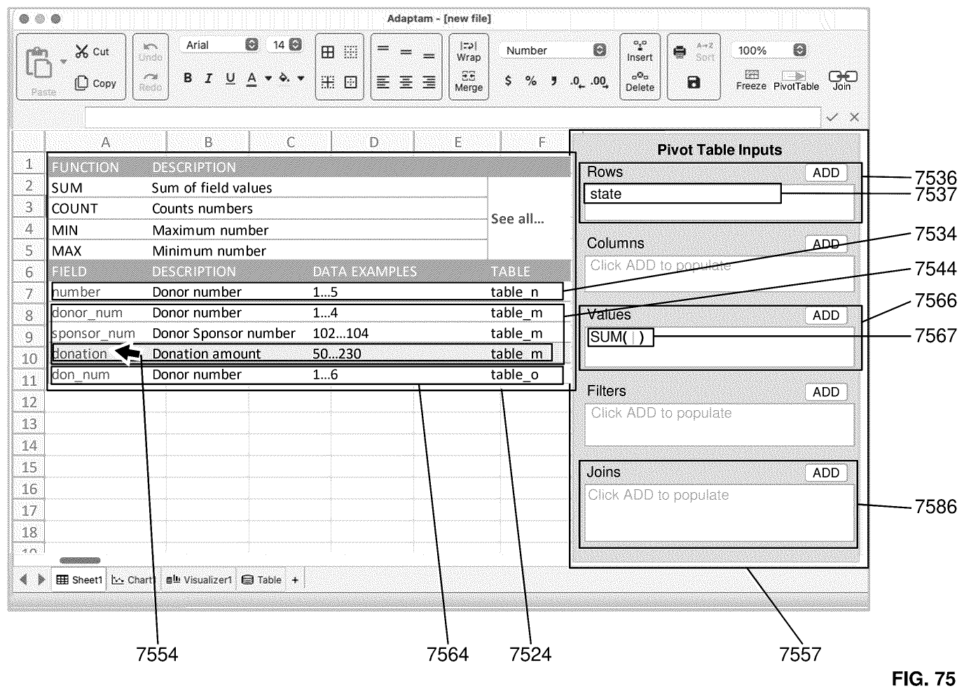

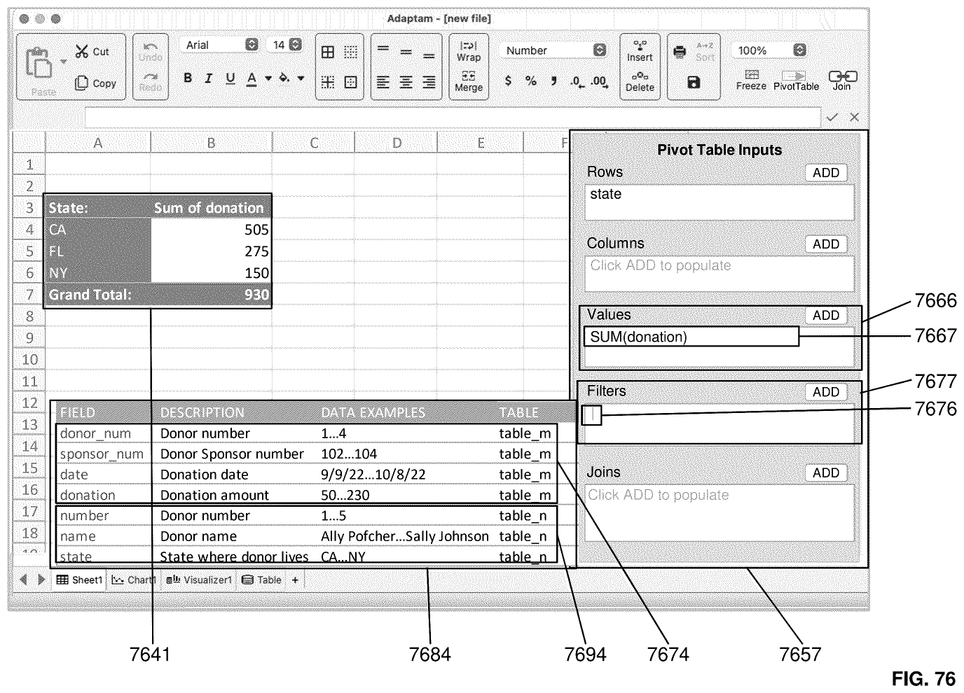

The way this works in our applications is exampled in FIG. 75 and FIG. 76 using one consistent set of selection lists, although the selection lists could have been any of the applicable ones described or exampled herein or otherwise applicable. The charity user wants to set up a PivotTable of the total donations by state for each donor contacted before ‘Oct. 1, 2022’. In FIG. 75 the user has started the process in the ‘PivotTable Input’ 7557 sidebar populating ‘state’ 7537 in the ‘Rows’ input 7536. They then populated ‘SUM( )’ 7567 into the ‘Values’ input 7566 which opened the selection list 7524 displaying all the applicable data fields/columns for the field ‘state’ 7537. The selection list 7524 displays all the numeric fields in the data set ‘table_n’7534 which are in the same data set as the field ‘state’ 7537 and all the numeric fields in the data sets joinable to ‘table_n’, which are the data sets ‘table_m’ 7544 and ‘table_o’ 7564 (because each data set is joinable by an acceptable cardinality join). The selection list also displays the applicable functions because our technology allows functions within functions in the ‘Values’ 7566 inputs. Note, in this embodiment joins set up pre the ‘Pivot Table Inputs’ 7557 ‘Joins’ input 7586 are not visible in that box, only joins added within that input are visible there. However, in other embodiments those pre-qualified joins would automatically populate in the ‘Joins’ box 7586.

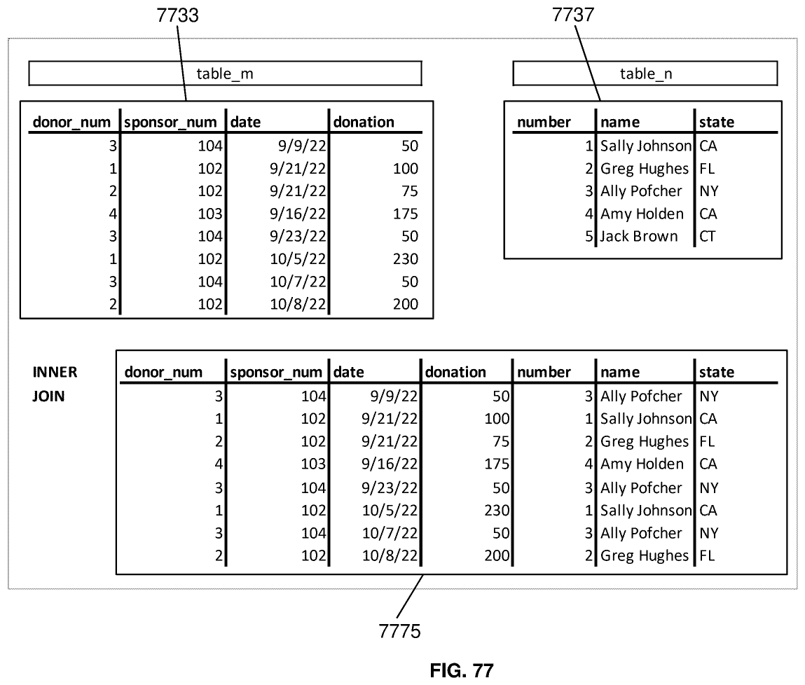

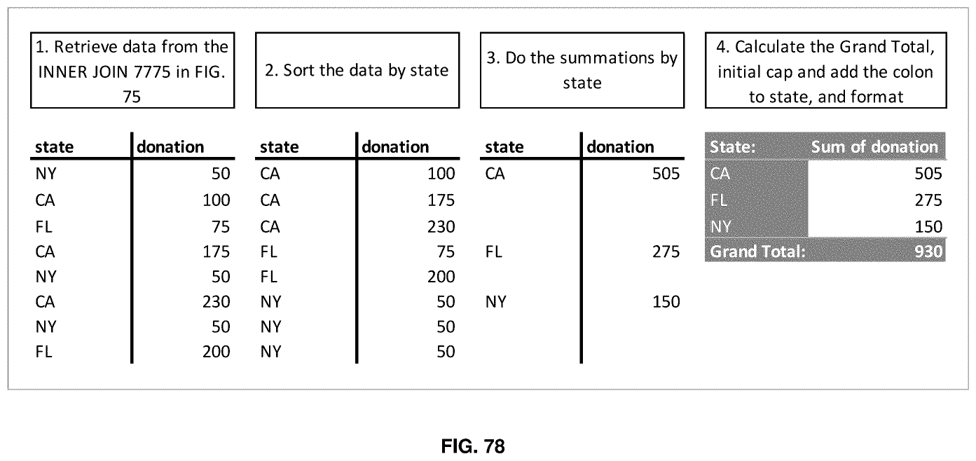

The user then selects (clicks) 7554 the field/column ‘donation’ to populate it 7667 within the ‘SUM(donation)’ in the ‘Values’ input 7666 within the ‘Pivot Table Inputs’ 7657 in FIG. 76. This populates the PivotTable result 7641 via the illustrative data set ‘INNER JOIN’ 7775 of ‘table_m’ 7733 and ‘table_n’ 7737 in FIG. 77 and then the illustrative PivotTable data manipulation and calculation use of the joined data in FIG. 78.

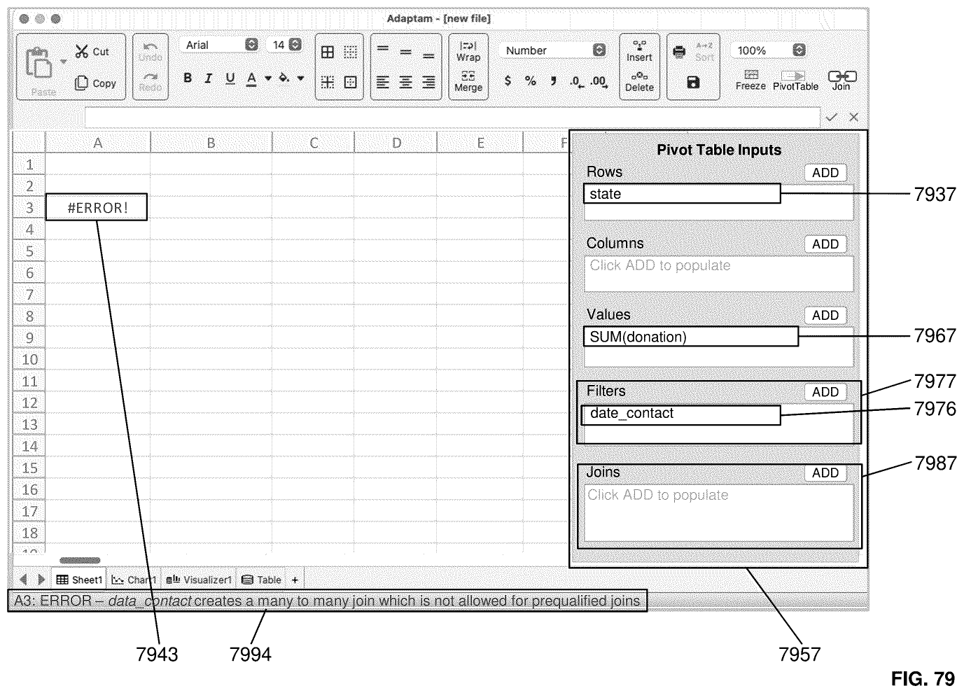

However, because of the qualification flag set limitation of no non-unique to non-unique cardinality joins (only unique to unique, unique to non-unique, and non-unique to unique), when the user opens the next input 7676 (in this example in the ‘Filters’ input 7677 within the ‘Pivot Table Inputs’ 7657) and automatically sees the selection list 7684, they see only fields/columns from ‘table_m’ 7674 and ‘table_n’ 7694 displayed. There are no fields/columns from ‘table_o’ because the chained/sequenced join that would add ‘table_o’ would create a non-unique to non-unique cardinality chained/sequences join from ‘table_m’ to ‘table_o’. Here our technology is protecting an unsophisticated user from a partial Cartesian Product join despite previously displaying fields from all three tables together because a selection now from ‘table_o’ would results in a many to many join. And if in this embodiment they proceed to force in the usage of a field/column from ‘table_o’, as they did with a typed input in the ‘Filters’ input 7977 of ‘date_contact’ 7976 in FIG. 79, they are rewarded with an ‘ERROR; message 7943 in the cell ‘A3’ instead of a PivotTable result. In this embodiment they are also given a more detailed error message in the status bar 7994. Note, the manual typing of the field ‘date_contact’ 7976 of ‘table_o’ into the ‘Filters’ input 7977 after already having inputs from both data sets ‘table_m’ (‘donation’ 7967) and ‘table_n’ (‘state’ 7937) would result in the blocked many to many cardinality. Also note this example has two invisible joins between the three data sets setup, each one passing the cardinality test but the chained/sequenced join of the three data sets failing it. In this embodiment they would have gotten the same outcome had the join arguments been visible in the “PivotTable Inputs” 7957 ‘Joins’ display 7987 with that cardinality blocking in place.

### Cardinality Limit Override

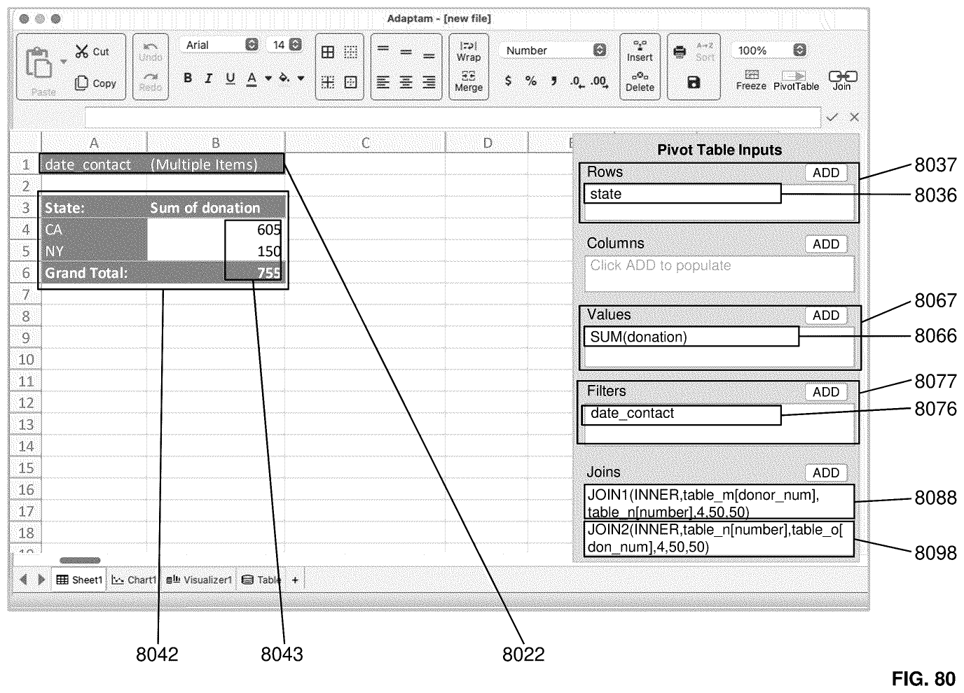

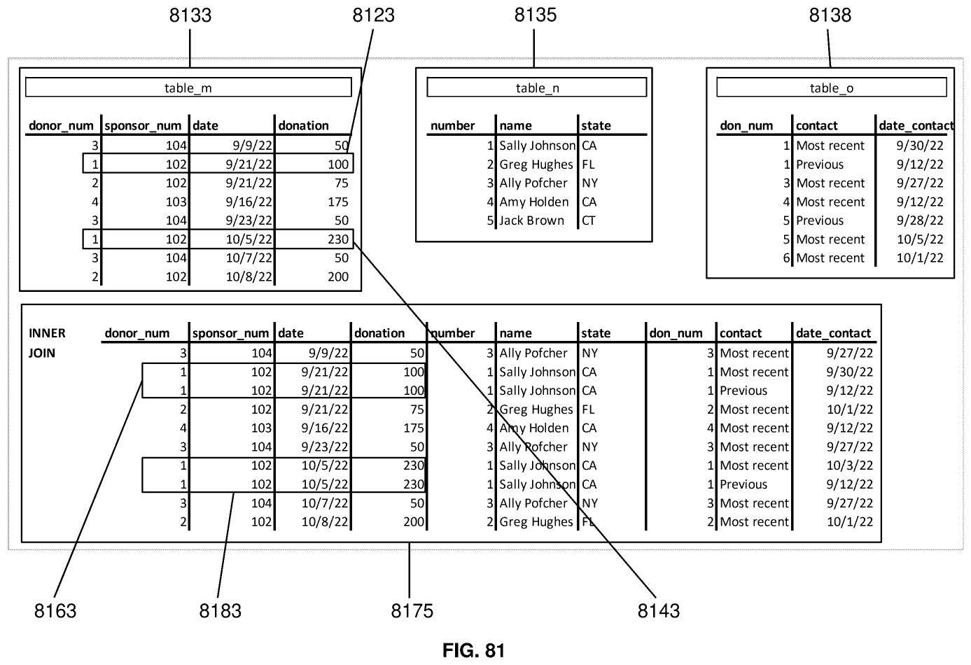

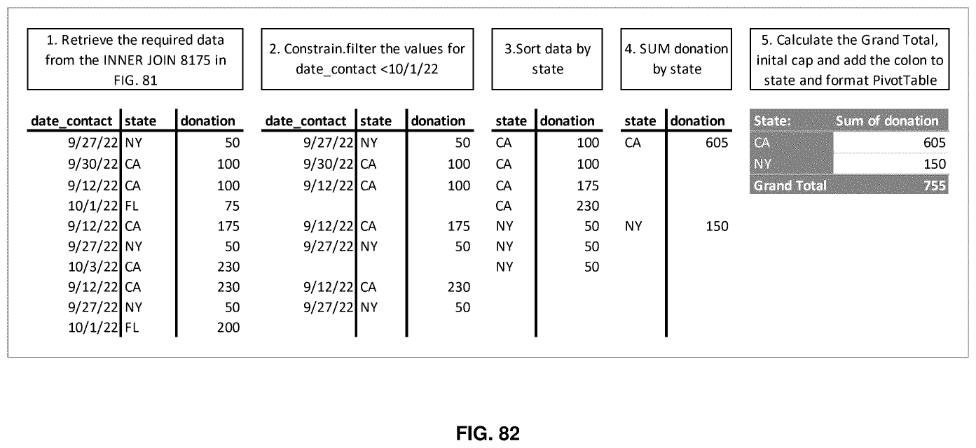

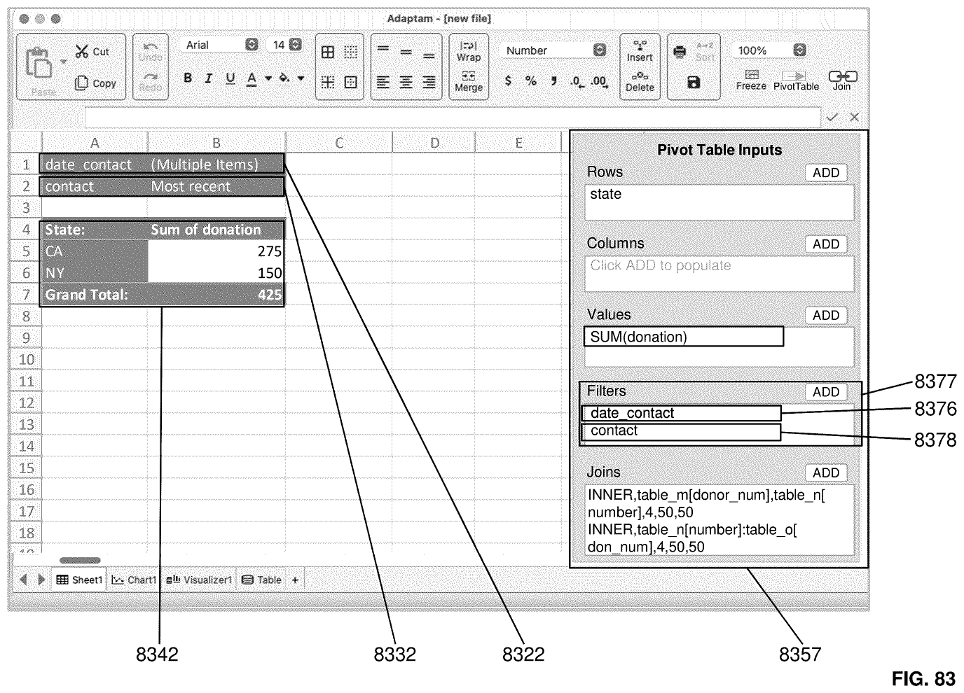

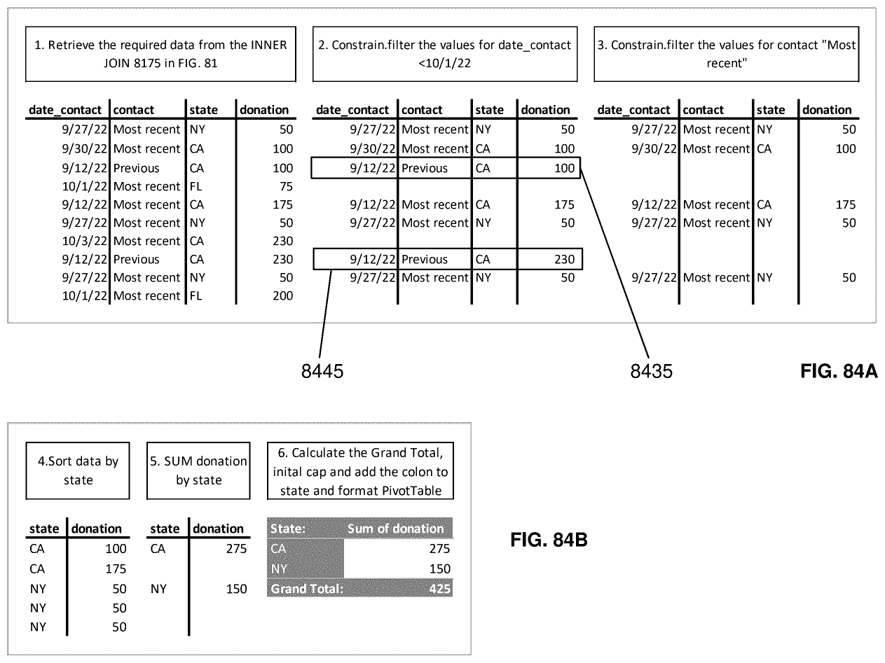

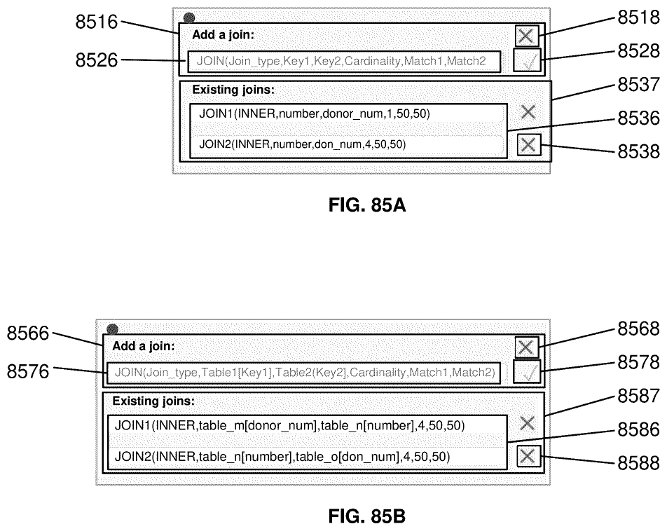

However, in another embodiment the user is given a within the PivotTable way to change a join altering the cardinality rule of the existing joins or add a new join setting different cardinality rules using join adding UIs like those exampled in FIG. 85A and FIG. 85B. This allows the charity user who wants to set up a PivotTable of the total donations by state for each donor contacted before ‘Oct. 1, 2022’ to be able to get their desired result. In FIG. 80 with the joins 8088 and 8098 that accept non-unique to non-unique cardinality joins (the ‘4’ argument in the two joins) the user is able to execute a PivotTable with the three data set join precluded in FIG. 76 and FIG. 79. They are taking on the responsibility of dealing with the Partial Cartesian product issue. The PivotTable in FIG. 80 done by that user with a ‘date_contact’ ‘Filter’ setting 8076 in the ‘Filters’ input 8077 with only dates before ‘Oct. 1, 2022’ generates the result 8042. The user needs to be sophisticated enough to know that result contains Partial Cartesian products (as exampled in FIG. 81 8163 in the join versus 8123 in ‘table_m’ 8133 and 8183 in the join versus 8143 in ‘table_m’ 8133) for the ‘SUM(donation) input 8066 (in the ‘Values’ input 8067), ‘state’ 8036 input (in the ‘Rows’ input 8037), and ‘date_contact’ 8076 input (in the ‘Filters’ input 8077) generated values 8043 in FIG. 80. The generation of these values is illustratively exampled starting with the INNER 8175 join of the three data sets ‘table_m’ 8133, ‘table_n’ 8135, and ‘table_o’ 8138 in FIG. 81. Then those joined values are used in the calculations in FIG. 82 to generate the pivot table result 8042 in FIG. 80. Therefore, that PivotTable result, illustratively generated in FIG. 82, contains duplicate donations. However, the sophisticated user knows how to remove those by adding an additional ‘Filter’ of ‘contact’ 8378 in the ‘Filters’ input 8377 (in the ‘Pivot Table Inputs 8357) and setting its value to ‘Most recent’ 8332 to remove the data which created the Cartesian Product in FIG. 81. This eliminates the duplication of ‘donation’ values and works with the ‘date_contact’ filter 8322/8376 which limits the values to dates before ‘Oct. 1, 2022’. Thus, getting the correct result 8342 from the PivotTable as illustratively exampled by the steps in FIG. 84A and FIG. 84B. Note, 8435 and 8445 in FIG. 84A illustrate the avoided Partial Cartesian Product as they do not duplicate the original donations shown in 8123 and 8143 in FIG. 81 by filtering out those duplications created in 8163 and 8183.

Our technology provides a way to protect the unsophisticated user from Partial Cartesian Product induced problems while allowing the sophisticated user a way to create PivotTable many to many joins (joins with all types of cardinalities). Those joins can be between two data sets, or more than two chained/sequence joined data sets. As exampled elsewhere those joins can be done with different types of joins (e.g., INNER, FULL OUTER, and LEFT OUTER) and can be applicable to chained/sequenced joins of more than three data sets. Our technology supports many different UIs for setting up these joins and we will discuss more in depth later.

### Cardinality Limit Override Setting UI Example

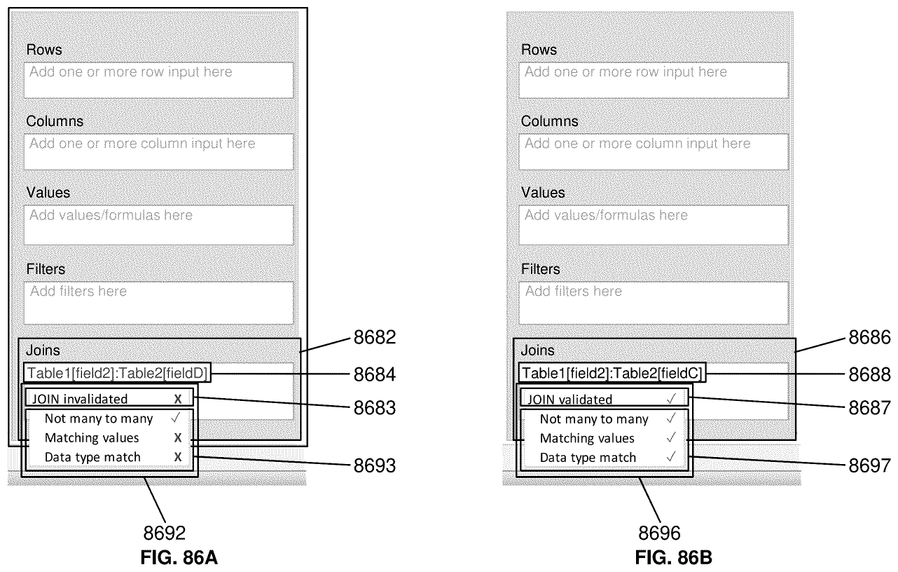

FIG. 85A and FIG. 85B example two variants of one embodiment of a UI setup approach where the user effectively constructs the arguments (8526 and 8576) specifying the join including setting cardinality. The first argument ‘Join type’ is where the user specifies the type of join they want employed, e.g., inner left outer, or full outer using an appropriate abbreviation for the argument. The next two arguments of ‘Key1,Key2’ in FIG. 85A and ‘Table1[Key1],Table2[Key2]’ in FIG. 85B in these examples define both the data set and the join key field. They are different in these examples because FIG. 85A utilizes the fact that in this example the fields/columns have unique names that therefore identify the data set. FIG. 85B handles the situation where the field/column names are not unique and therefore need some unique table identifier (or unique combination of the table and field/column) which then would need to be used in the other field/column inputs. After that comes a data modelling cardinality input where in this example the user inputs a number identifying the accepted cardinality or cardinalities. For example, ‘1’ would be accepting true one to one (a very limiting situation). ‘2’ would be accepting unique to unique cardinalities, which would of course include accepting one to one. ‘3’ would be accepting unique to unique, unique to non-unique, and non-unique to unique cardinalities. ‘4’ would be accepting unique to unique, unique to non-unique, non-unique to unique, and non-unique to non-unique cardinalities. Thus, giving the user many different cardinality options. The next two arguments of ‘Match1,Match2’ in this example set are the minimum match percentages of the values in the two join keys found in the other join key. Those could be weighted in different way, e.g., by rows of the keys or by distinct values. With these criteria our spreadsheet application will then validate an input then asking the user to finalize the selection by enabling the check 8528 or 8578 to become live for the user to ‘Add a join:’ 8516 or 8566 to the ‘Existing joins:’ 8537 or 8587. In this example to add to the two joins 8536 or 8586 already there. If the join fails, the qualification tests the ‘X’ 8518 or 8568 goes live to allow the user to remove the input and start again (alternatively they can edit the inputs until they get a check). If the user wants to get rid of one of the existing joins in 8536 or 8586, they simply click its corresponding ‘X’ (e.g., 8538 or 8588). These joins could have any path of qualification validation testing exampled in FIG. 27 with more or less qualification test inputs as dictated by the arguments. The information given back to the user could be less like this of pass fail or more like that shown in FIG. 30 (3087, 3077, 3067, 3053, 3055, and 3054). The information given back could also be like that in FIG. 86A 8682 popup UI 8692 and FIG. 86B 8686 popup UI 8696 where the ‘Xs’ or ‘checks’ are accompanied by an evaluation of each argument 8693 or 8697 as well as the overall assessment 8683 or 8687. The potential join arguments could also be color coded with one color for success and another for failed as done here with red 8684 for failed and 8688 green for successful. In different embodiments of our technology where a user decides the final joins without our automated validation eliminating incorrect joins our technology then definitively alerts the use of their error as exampled next.

### Data Type and Data Value Mismatch PivotTable Errors

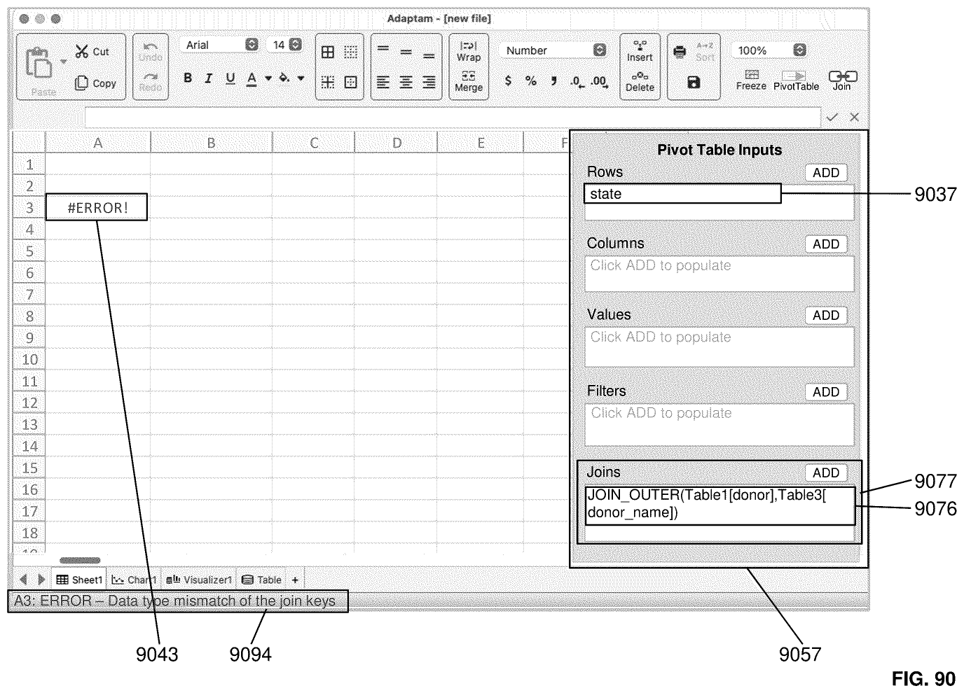

FIG. 90 examples an embodiment of our technology that displays an error in the PivotTable should a user enters a join where the keys have a data type mismatch (e.g., text field in one key and a date field in the other key). The ‘Joins’ input
‘JOIN_OUTER(Table1[donor],Table3[donor_name])’ 9076
   is built using the data sets 4762 and 4765 in FIG. 47. The field ‘donor’ 4752 is a numeric field (integer) while ‘donor_name’ 4746 is a text field. As such the outer join will not join (combine) any rows of the data and because of that will be deemed an error in this embodiment of our technology. If the user had selected an inner join then no data would be returned and also deemed an error in this embodiment of our technology. A left outer or right outer join would return values from only one of the two data sets, again deemed an error in this embodiment of our technology as no rows of the two data sets would have been combined (joined). In this example the ‘ #ERROR!’ 9043 message is generated when the user first completes the pivot table join 9076 in ‘Joins’ input 9077 within the ‘Pivot Table Inputs’ 9057. This embodiment of our technology then generates the ‘ #ERROR!’ message in cell ‘A3’ 9043 definitively telling the user the PivotTable did not work and giving more detail in the status bar message ‘A3: ERROR—Data type mismatch of the join keys’ 9094. Our technology does not give some vague suggestion there might be a problem and generate a PivotTable result but instead definitively gives the user an error message with a specific description of the problem causing the error. Note, in this example the spreadsheet correctly populated the pivot table for the ‘Rows’ input ‘state’ 9037 before the input of the erroneous join 9076 but then replaced that with the ‘#ERROR!’ 9043 message after the input the of the invalid join 9076.

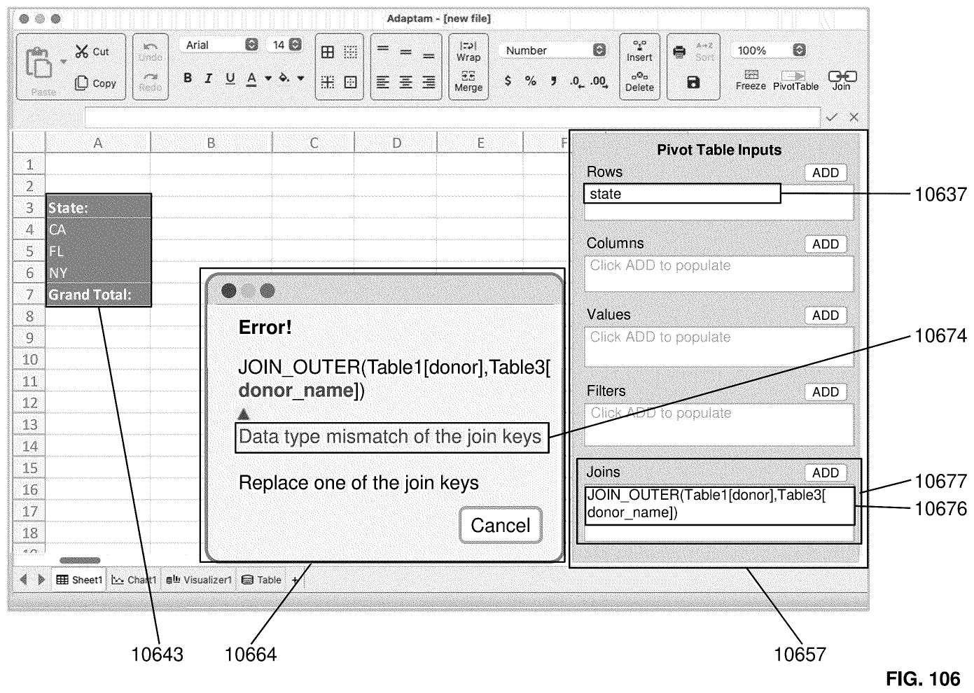

FIG. 106 examples a different embodiment of our technology handling the mismatched join in FIG. 90. In this embodiment our technology instead of executing the join to generate the error, stops the join 10676 as the user attempts to enter it in the ‘Joins’ input 10677 in the ‘Pivot Table Inputs 10657. It triggers the ‘Error!’ popup 10664 which identifies the problem ‘Data type mismatch of the join keys’ 10674. When the user clicks ‘Cancel’ our technology puts the user back into the join formula 10676 for them to correct the error before trying to again ‘ADD’ it in the ‘Joins’ input 10677 within the ‘Pivot Table Inputs’ 10657. Of course, the user can also decide to not add the join and remove it to use the pivot table without adding a join. Note, in this example the spreadsheet correctly populated the pivot table 10643 for the ‘Rows’ input ‘state’ 10637 before the input of the erroneous join 10676 which is still visible because the next versions of the pivot table result awaits the correction or elimination of the erroneous join 10676.

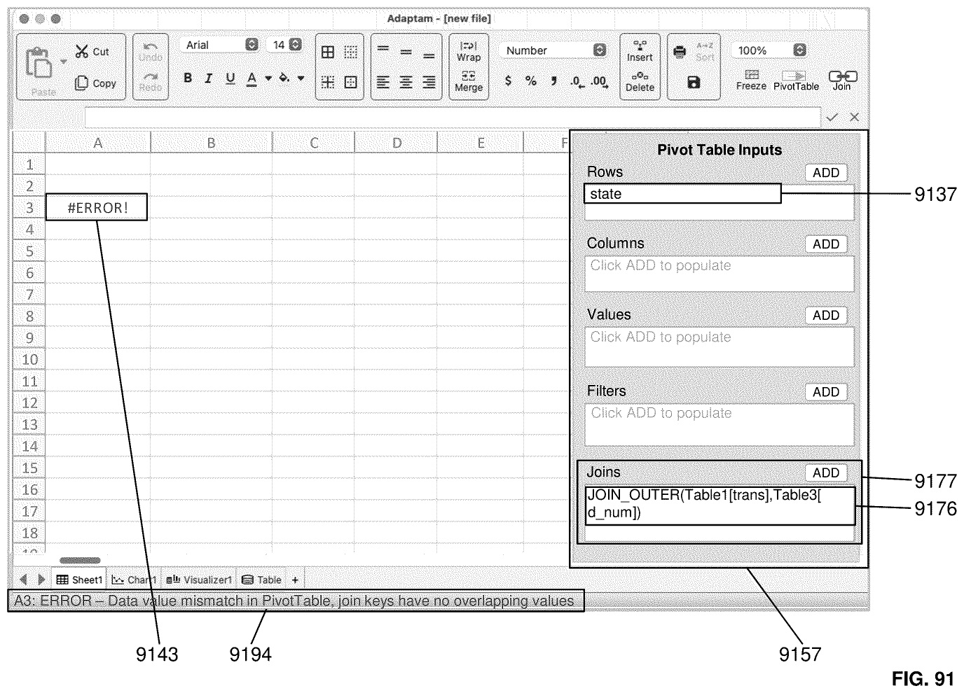

FIG. 91 examples an embodiment of our technology that displays an error in the PivotTable should a user enter a join where the keys have the same data type but a values mismatch (e.g., no common values in the two keys). In this example the ‘Joins’ input 9177 ‘JOIN_OUTER(Table1[trans],Table3[d_num])’ 9176 uses the data sets ‘Table1’ 4762 and ‘Table3’ 4765 in FIG. 47. They are both numeric fields but share no common values as ‘trans’ 4751 has integer values ranging from ‘422’ to ‘429’ while ‘d_num’ 4751 has integer values ranging from ‘1’ to ‘5’. As such the outer join will not join (combine) any rows of the data and because of that will be deemed an error in this embodiment of our technology. If the user had selected an inner join, then no data would be returned and also deemed an error in this embodiment of our technology. A left outer or right outer join would return values from only one of the two data sets, again deemed an error in this embodiment of our technology as no rows of the two data sets would have been combined (joined). In this example the ‘#ERROR!’ 9143 message is generated when the user first completes the pivot table join 9176 in ‘Joins’ input 9177 within the ‘Pivot Table Inputs’ 9157. This embodiment of our technology then generates the ‘#ERROR!’ 9143 message in cell ‘A3’ definitively telling the user the PivotTable did not work and giving more detail in the status bar message ‘A3: ERROR—Data value mismatch in the PivotTable, join key have no overlapping values’ 9194. Our technology does not give some vague suggestion there might be a problem and generate a PivotTable result but instead definitively gives the user an error message with a specific description of the problem causing the error. Note, in this example the spreadsheet correctly populated the pivot table for the ‘Rows’ input ‘state’ 9137 before the input of the erroneous join 9176.

While we could example many more join error situations and UI variants, in the interest of conciseness we will example one more chained/sequenced example where with multiple ‘Values’ argument inputs and with an embodiment where our more regular cell formula like ‘Values’ inputs carry over to the PivotTable output result headings.

### Multiple Values Arguments Example

FIG. 100 examples the charity user wanting to know for each of the female sponsors (i.e., gender(“F”)) the total net donations (i.e., ‘SUM(donation)−SUM(fee_2)’), the largest donation (i.e., ‘MAX(donation)’), and the number of different donors (i.e., ‘COUNT_UNIQUE(donor_name)’). They are using the five data sets exampled in FIG. 47. They have set up (qualified) the color-coded joins in FIG. 47 in the ‘Joins’ 10087 visible in the ‘Pivot Table Inputs’ 10057 in FIG. 100. The user inputted ‘sponsor_name’ 10037 in the ‘Rows’ input, gender(“F”) 10077 in the “Filters’ input and three different calculation arguments in the ‘Values’ input:

```
‘SUM(donation)-SUM(fee_2)’ 10047
  ‘MAX(donation)’ 10056
  ‘MAX(donation)’ 10067
```

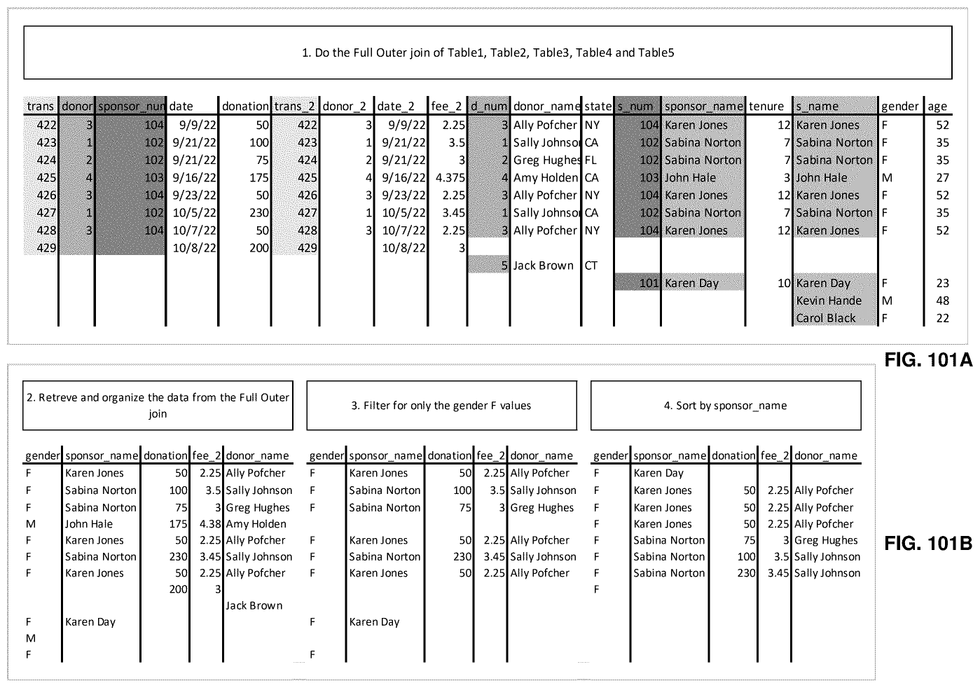

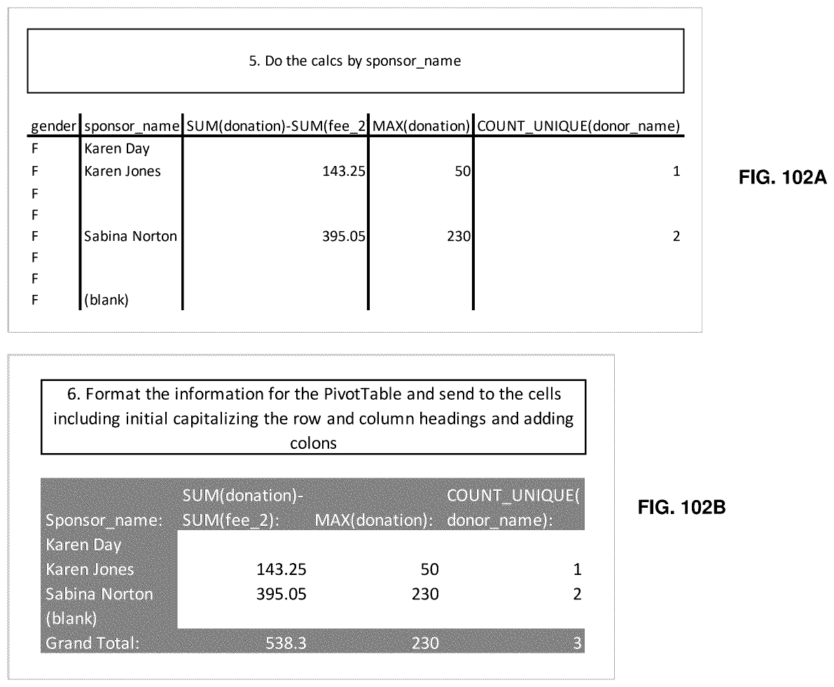

This successfully chain/sequenced joined all five data sets in FIG. 47 as illustratively exampled in FIG. 101A. That joined data was then illustratively used in the PivotTable data sorting, calculations, and formatting in FIG. 101B through FIG. 102B to example automatically generating the PivotTable result 10066 in FIG. 100. As previously mentioned, this embodiment use our more regular cell formula like ‘Values’ inputs (versus the more sentence like inputs) and carried those formula-like inputs over to the value output headings 10076 adding a colon after each one. Another embodiment of our technology could have used the more sentence like inputs and/or PivotTable results headings.

While we could continue to example combinations of features disclosed (e.g., locations of joins, types of joining, validation of joins, join selection lists and joinable data selection lists) which have not been repeated with each of the other features (e.g., two data set joins, chained/sequenced joins, and double joins between two data sets) and in all the possible combinations. The reader will understand how features identified in this section can readily be combined with sets of other features. We will therefore move on to describing one of many example computer systems that can be used for our technology.

### Computer System

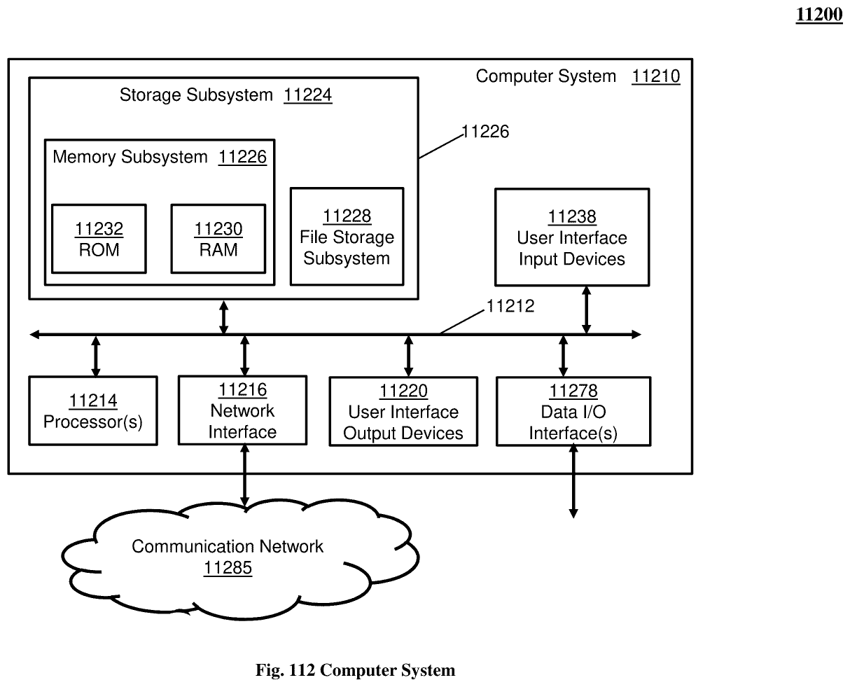

FIG. 112 is a block diagram of an example computer system, according to one implementation. Computer system 11210 typically includes at least one processor 11214 which communicates with a number of peripheral devices via bus subsystem 11212. These peripheral devices may include a storage subsystem 11224 including, for example, memory devices 11226 and a file storage subsystem, user interface input devices 11238, user interface output devices 11220, Data I/O Interface(s) 11278, and a network interface subsystem 11216. The input and output devices allow user interaction with computer system 11210. The network interface subsystem 11216 provides an interface to outside networks, including an interface to communication network 11285, and is coupled via communication network to corresponding interface devices in other computer systems or in the cloud and usable for cloud applications.

User interface input devices 11238 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 11210 or onto communication network.

User interface output devices 11220 may include a display subsystem, a printer, a fax machine, or non-visual displays such as audio output devices. The display subsystem may include a touch screen, a flat-panel device such as a liquid crystal display (LCD), a projection device, a cathode ray tube (CRT), or some other mechanism for creating a visible image. The display subsystem may also provide a non-visual display such as via audio output devices. In general, use of the term “output device” is intended to include all possible types of devices and ways to output information from computer system 11210 to the user or to another machine or computer system.

Storage subsystem 11224 stores programming and data constructs that provide the functionality of some or all of the modules and methods described herein. These software modules are generally executed by processor 11214 alone or in combination with other processors.

Memory 11226 used in the storage subsystem can include a number of memories including a main random-access memory (RAM) 11230 for storage of instructions and data during program execution and a read only memory (ROM) 11232 in which fixed instructions are stored. A file storage subsystem 11228 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 11228 in the storage subsystem 11224, or in other machines accessible by the processor.

Bus subsystem 11212 provides a mechanism for letting the various components and subsystems of computer system 11210 communicate with each other as intended. Although bus subsystem 11212 is shown schematically as a single bus, alternative implementations of the bus subsystem may use multiple busses.

Computer system 11210 can be of varying types including a workstation, server, computing cluster, blade server, server farm, or any other data processing system or computing device. Due to the ever-changing nature of computers and networks, the description of computer system 11210 depicted in FIG. 112 is intended only as one example. Many other configurations of computer system 11210 are possible having more or fewer components than the computer system depicted in FIG. 112.

### Some Particular Implementations

Some particular implementations and features are described in the following discussion. Implementations of our PivotTable data joining technology support a broad spectrum of situations from two data set joins, multiple joins between two data sets, multi-data set chained/sequenced joins, and combinations of the prior mentions. Our implementations support prequalifying joins (before this PivotTable), so the typical spreadsheet user does not have to deal with the mechanics of determining the join keys and/or the join type. So that the prequalified joinable fields are simply available to users in selection lists for use in their PivotTables. For the more sophisticated users our technology supports implementations altering (requalifying) those join keys or join types as well as having implementations with no prequalification where all the join setting is done in the Pivot Table Inputs or other inputs within the spreadsheet. Implementations of our technology support the full spectrum of cardinality (data modelling relationships between data sets) as well as having implementations that limit cardinality types and implementations with different cardinalities for join set in different places, e.g., prequalified joins versus in this PivotTable qualified joins. All our implementations support data sets from different types of sources, data external to the spreadsheet cells, data in cells, and combinations of those sources.

### Some Particular Implementations—Join Stopping

Implementations of our technology stop users from setting up joins that will result in no joined data across the two or more joined data sets. Implementations which stop the user from setting up join keys that have a data type mismatch (e.g., one join key integers and the other join key text) or a data value mismatch (e.g., both join keys are integers but share no common values between the two). One implementation stops the joins by simply not giving the user the option to join the mismatched keys as exampled in FIG. 30 (3087 and 3067) and FIG. 35B through FIG. 36C. Another implementation stops the join at the generation of the pivot table as exampled in FIG. 90 and FIG. 91, or at the generation of the join as exampled in FIG. 106. That stopping can come in the form of an in PivotTable error message as in FIG. 90 and FIG. 91 or in a UI (e.g., popup) error message requiring correction of the join selection before acceptance of the join and generation of the joined pivot table as exampled in FIG. 106. All of those implementations can be accompanied by a descriptive rationale explaining why the join was stopped as exampled in FIG. 30 3067 and 3087, FIG. 86A 8693, FIG. 90 9094, FIG. 91 9194, and FIG. 106 10674. These joins being stopped can be in the Pivot Table Inputs or in some location before the specific Pivot Table as exampled in FIG. 25 2535, 2545, 2555, 2565, and 2575. Implementations can also support stopping join value mismatches below a specified value match criteria (e.g., less than 5%) such as that described in FIG. 27 ‘Step 3A’.

### Some Particular Implementations—Join Stopping Input Panel Locations

Implementations of our pivot table join stopping technologies support a broad set of locations for the join input panel and join qualification capabilities as exampled in FIG. 25. Implementations support the input panel UI and join qualification capability in a data intake tool before the spreadsheet as exampled in FIG. 30. Implementations also support a UI and pivot table join qualification capability like that discussed in FIG. 30 within a data intake tool within the spreadsheet. Implementations support the input panel UI and join qualification capability located within the spreadsheet as exampled in FIG. 32 through FIG. 37. Where these implementations can be applicable to one specific pivot table or all the pivot tables within a worksheet or the overall spreadsheet. Implementations also support the input panel UI and join qualification capability located within the spreadsheet pivot table input panel as exampled in FIG. 48, FIG. 51, FIG. 52, FIG. 57 through FIG. 62, and many additional figures herein.

### Some Particular Implementations—Join Stopping Cardinalities

Implementations also include stopping joins based on cardinality, for example stopping joins that have a non-unique to non-unique cardinality as exampled in FIG. 27 ‘Step 4’, FIG. 79, FIG. 86A, and FIG. 86B. Additionally implementations support stopping joins differentially by location of the setup for cardinality. For example, stopping non-unique to non-unique cardinality joins set up before the pivot table input but allowing those non-unique to non-unique cardinality joins set up in the pivot table input as exampled by the different paths in FIG. 27 applied to the different locations in FIG. 25.

### Some Particular Implementations—Join Stopping Data Sources

All of our implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Join Stopping Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

### Some Particular Implementations—Join Setup Assist

Implementations of our technology assist users in the setting up of spreadsheet pivot table joins by better informing them about their options once the user has selected a first data set, selected its join key, and then selected the second data set. At that point an implementation of our technology automatically evaluates the data type match and data value match for every field in the second data set relative the data type and values of the first data set join key field and outputs a mismatch indicator for any mismatches as exampled in FIG. 35A, FIG. 35B, and FIG. 30. Implementations output for those fields that have no mismatch indicator output a data value overlap fraction (relative to the first data set join key) for each such field in the second data set as exampled in FIG. 30 3053 and 3055. Our implementations support many different ways of determining the fraction or fractions of overlap, for example including fractions rows common across both data sets versus the total of rows for both data sets. Fractions of rows in one of the two data sets in common with values in the other versus that data set's number of rows. Fractions of distinct (unique) values in common across both data sets versus the total number of distinct values across both data sets. Fractions of distinct values in one of the two data sets in common with values in the other versus the number of distinct values in that data set.

### Some Particular Implementations—Join Setup Assist UI Location

Implementations of our technology support many different locations for the join assist UI and capability within the spreadsheet and external to it as exampled in FIG. 25. Implementations support the input panel UI and join qualification capability in a data intake tool before the spreadsheet as exampled in FIG. 30. Implementations also support a UI and pivot table join qualification capability like that discussed in FIG. 30 within a data intake tool within the spreadsheet. Implementations support the input panel UI and join qualification capability located within the spreadsheet as exampled in FIG. 32 through FIG. 37.

### Some Particular Implementations—Join Setup Assist Cardinalities

Implementations of our technology automatically evaluates the join cardinality for each field in the second data set as a join key pair to the first field in the first data set having the same data types and having at least one common value as exampled in FIG. 30 3054 and FIG. 35A 3534. Additional implementations stop any joins with a blocked cardinality as exampled in FIG. 33 3077, FIG. 86A, and FIG. 86B.

### Some Particular Implementations—Join Setup Assist Data Sources

All of our join setup assist implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Join Setup Assist Other Implementations

Other implementations of our join setup assist technology may include a non-transitory computer readable storage medium storing instructions executable by a processor to perform any of the methods described above. Yet another implementation may include a system including memory and one or more processors operable to execute instructions, stored in the memory, to perform any of the methods described above.

### Some Particular Implementations—Non-Aligned Two Data Set Joins

Implementations of our two data set joining technology supports joins successful working without any directional alignment of the join inputs and the directional alignment of the pivot table inputs as exampled for different types of inputs in FIG. 41 (‘Values’/‘Rows’) and FIG. 45 (‘Values’/‘Columns’) in our technology and the failure of the same setup to work in Microsoft Excel in FIG. 7 (same as FIG. 41) and FIG. 11 (same as FIG. 45). Implementations of our technology support all types of SQL joins including inner, full outer, left outer, right outer, self, and cross joins as exampled in FIG. 37 3748. Implementations support the types of join used being application specified or user specified. Implementations of our technology support all combinations of data modelling cardinalities including one to one, unique to unique, one to many, many to one, unique to many, many to unique, and many to many as exampled herein. Note, where many is the same as non-unique. Nulls in the first or the second join keys do not stop our technology from completing a successful join as exampled herein. Implementations where all joins between keys having the same data type and at least one matching value are supported with no primary key limitation (that limitation exampled for Microsoft Excel Pivot table joins in FIG. 4). An additional implementation of our non-aligned two data set joins for pivot tables supports only unique to unique (includes one to one), unique to non-unique (many), and non-unique (many) to unique cardinality joins for joins set up before the pivot table and supports joins of all cardinalities for joins set up within the pivot table.

### Some Particular Implementations—Non-Aligned Two Data Set Joins Error Generation

Implementations of our non-aligned two data set joins technology support generation of errors in situations where the join does not work or joins nothing, unlike what happens in Microsoft Excel where a pivot table result is generated which is not its left outer join as exampled in the prior art. Our technology generates an error outcome with data type mismatch between the join keys as exampled in FIG. 90 and FIG. 106. Implementations of our technology generate an error outcome with data value mismatch (i.e., no common values) between the join keys as exampled in FIG. 91. Implementations of our technology also generate an error outcome if there is no valid join between the different data sets from which fields are populated into the pivot table inputs as exampled in FIG. 87 (where ‘donation’ lacks the joins for ‘Rows’ and ‘Columns’ field inputs).

### Some Particular Implementations—Non-Aligned Two Data Set Joins Data Sources

All of our non-aligned two data set joins implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Non-Aligned Two Data Set Joins Other Implementations

Other implementations of our non-aligned two data set joins technology may include a non-transitory computer readable storage medium storing instructions executable by a processor to perform any of the methods described above. Yet another implementation may include a system including memory and one or more processors operable to execute instructions, stored in the memory, to perform any of the methods described above.

### Some Particular Implementations—Non-Aligned Three or More Data Set Joins

Implementations of our three or more data set joining technology supports joins successful working without any directional alignment of the join inputs and the directional alignment of the pivot table inputs as exampled for different types of inputs in FIG. 48, FIG. 49 and FIG. 52. This is in contrast to Microsoft Excel in FIG. 14 failing to generate the correct values for the exact same situation that works in our technology exampled in FIG. 48. Implementations of our technology support all types of SQL joins including inner, full outer, left outer, right outer, self, and cross joins as exampled in FIG. 37 3748. Implementations support the types of join used being application specified or user specified. Implementations support any of the different type of joins used as the application default join, with the full outer join being an attractive option that drops no data. Implementations of our technology support all combinations of cardinalities including one to one, unique to unique, one to many, many to one, unique to many, many to unique, and many to many as exampled herein. Note, where many is the same as non-unique. Where nulls in the first or the second join keys do not stop our technology from completing a successful join as exampled herein. Implementations where all joins between keys having the same data type and at least one matching value are supported with no primary key limitation (that limitation exampled for Microsoft Excel Pivot table joins in FIG. 4). An additional implementation of our non-aligned two data set joins for pivot tables supports only unique to unique (includes one to one), unique to non-unique (many), and non-unique (many) to unique cardinality joins for joins set up before the pivot table and supports joins of all cardinalities for joins set up within the pivot table.

### Some Particular Implementations—Non-Aligned Three or More Data Set Joins Error Generation

Implementations of our non-aligned three or more data set joins technology support generation of errors in situations where the join does not work or joins nothing, unlike what happens in Microsoft Excel where a pivot table result is generated which is not its left outer join as exampled in the prior art. Our technology generates an error outcome with data type mismatch between the join keys as exampled in FIG. 90 and FIG. 106. Implementations of our technology generate an error outcome with data value mismatch (i.e., no common values) between the join keys as exampled in FIG. 91. Implementations of our technology also generate an error outcome if there is no valid join between the two different data sets from which fields are populated into the pivot table inputs as exampled in FIG. 87.

### Some Particular Implementations—Non-Aligned Three or More Data Set Joins Data Sources

All of our non-aligned three or more data set joins implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Non-Aligned Three or More Data Set Joins Other Implementations

Other implementations of our non-aligned three or more data set joins technology may include a non-transitory computer readable storage medium storing instructions executable by a processor to perform any of the methods described above. Yet another implementation may include a system including memory and one or more processors operable to execute instructions, stored in the memory, to perform any of the methods described above.

### Some Particular Implementations—Double Joins Involving Only One of the Doubles

Implementations of our technology make the execution of double joins very easy for the user. Joins between two data sets where the two join keys for one of the data sets is the same field while the corresponding join keys in the other data set differ for the two joins. Thus, creating two possible joins between the two data sets that can be used in generating a pivot table outcome as exampled in FIG. 56A through FIG. 60, FIG. 97, and FIG. 98 for a pivot table using one of the two double joins.

Implementations of our technology further makes double join usage easy by automatically changing the double joined data set field names for the data set which has the same field as the two join keys. Those name changes then identify which of the two different joins in the other data set has been used as exampled in FIG. 58 5876 and 5886. One implementation uses the two different join key field names as the automatically altered names as exampled by ‘donor_state’ and ‘sponsor_state’ automatically appended to the data set field names (in the double joined data set with the same field as the two join keys) in FIG. 58 5876 and 5886. Implementations also include character(s) automatically appended to differentiate the appended characters from the original data set field names such as the dash and right pointing greater than characters ‘->’ exampled in FIG. 58 5876 and 5886 before the other table join key field names. Additional implementations replace the automatically generated additions to differentiate the double joined data set field names with a user specified set of characters for each of the double joins.

### Some Particular Implementations—Double Joins Involving Only One of the Doubles Double Join Conversion

Situations occur in the pivot table inputs where users have already populated a pivot table input with a double joinable field and then make an additional input that requires that already populated field to need to be converted to one of the two double joins. Implementations of our technology automatically identify those situations and when it is not possible for the application to know which of the two double joins is applicable automatically present the user with both options for their selection options as exampled in FIG. 68 through FIG. 72. Then our technology automatically alters the field after the user selection.

### Some Particular Implementations—Double Joins Involving Only One of the Doubles Join Types

Implementations of our technology support all types of SQL joins including inner, full outer, left outer, right outer, self, and cross joins as exampled in FIG. 37 3748. Implementations support the types of join used being application specified or user specified. Implementation support any of the different type of joins used as the application default join, with the full outer join being an attractive option that drops no data.

### Some Particular Implementations—Double Joins Involving Only One of the Doubles Data Sources

All of our double joins involving only one of the doubles implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Double Joins Involving Only One of the Doubles Other Implementations

Other implementations of our double joins involving only one of the doubles technology may include a non-transitory computer readable storage medium storing instructions executable by a processor to perform any of the methods described above. Yet another implementation may include a system including memory and one or more processors operable to execute instructions, stored in the memory, to perform any of the methods described above. Implementations also support triple, quadruple, and so on multiple joins working in the same manner where all the join keys in one data set are the same key and each of the join keys in the other data set are different fields.

### Some Particular Implementations—Double Joins Involving Both Doubles

Implementations of our technology make the execution of pivot tables using fields employing both of the double joins very easy for the user. Joins between two data sets where the two join keys for one of the data sets is the same field while the corresponding join keys in the other data set differ. Thus, creating two possible joins between the two data sets where one or more of each of the double joined data sets can be used in generating a pivot table outcome as exampled in FIG. 56A through FIG. 60, FIG. 97, and FIG. 98 for setting up the first double join usage and then exampled in FIG. 61 through FIG. 64B for setting up the second double join usage.

Implementations of our technology further makes double join usage easy by automatically changing the double joined data set field names for the data set which has the same join keys. Those name changes then identify which of the two different joins in the other data set has been used as exampled in FIG. 58 5876 and 5886. One implementation uses the two different join key field names as the automatically altered names as exampled by ‘donor_state’ and ‘sponsor_state’ automatically appended to the data set field names (in the double joined data set with the same field as the two join keys) in FIG. 58 5876 and 5886. Implementations also include character(s) automatically appended to differentiate the appended characters from the original data set field names such as the dash and right pointing greater than characters ‘->’ exampled in FIG. 58 5876 and 5886 before the other table join key field names. Additional implementations replace the automatically generated additions to differentiate the double joined data set field names with a user specified set of characters for each of the double joins.

### Some Particular Implementations—Double Joins Involving Both Doubles Double Join Conversion

Situations occur in the pivot table inputs where users have already populated a pivot table input with a double joinable field and then make an additional input that requires that already populated field to need to be converted to one of the two double joins. In some of those situations the pivot table input limitations make it knowable by our technology as to which of the double joins that field should be converted to. In that situation an implementation of our technology automatically converts the field to the joined field as exampled in FIG. 65 through FIG. 67. In other situations where it is impossible to know which of the two joins the field should be converted to, our applicable automatically presents the user with both options for their selection as exampled in FIG. 68 through FIG. 72. Once the user makes a selection our technology automatically alters the field in the pivot table input.

### Some Particular Implementations—Double Joins Involving Both Doubles Join Types

Implementations of our double joins involving both doubles technology support all types of SQL joins including inner, full outer, left outer, right outer, self, and cross joins as exampled in FIG. 37 3748. Implementations support the types of join used being application specified or user specified. Implementation support any of the different type of joins used as the application default join, with the full outer join being an attractive option that drops no data.

### Some Particular Implementations—Double Joins Involving Both Doubles Data Sources

All of our double joins involving both doubles implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Double Joins Involving Both Doubles Other Implementations

Other implementations of our double joins involving both doubles technology may include a non-transitory computer readable storage medium storing instructions executable by a processor to perform any of the methods described above. Yet another implementation may include a system including memory and one or more processors operable to execute instructions, stored in the memory, to perform any of the methods described above. Implementations also support triple, quadruple, and so on multiple joins working in the same manner where all the join keys in one data set are the same key and each of the join keys in the other data set are different fields.

### Some Particular Implementations—Intelligent Selection Lists for Joined Fields

Our technology importantly makes it very easy for users to populate joined data set fields/ranges into the pivot table inputs. Implementations of our hints/selection list joins technology works for a join qualification flag set anywhere previous to the beginning of the pivot table input entry of the field/range for which the selection list is generated. Once a joinable field/range is entered into a pivot table input then our technology makes any joinable fields to that inputted field available in our selection lists and stops displaying of any fields/ranges from data sets that are not joinable, while of course displaying fields in the same data set as exampled in FIG. 39B through FIG. 40E using data sets in FIG. 31A and FIG. 31B.

Different implementations of our hints/selection list technology support alternative ways of accessing the joinable fields. One implementation displays all the joinable fields in a single selection list/hint as exampled in FIG. 38, FIG. 39B through FIG. 39E, and FIG. 41 with a functional limitation and in FIG. 94 through FIG. 95E without a functional limitation. In another implementation the joinable fields are accessible in the first selection list/hint with a click taking the user to the joinable fields (only) in a second hint/selection list as exampled in FIG. 38, FIG. 40A through FIG. 41 with a functional limitation and in FIG. 94, FIG. 96A through FIG. 96E without a functional limitation.

Implementations of our hints/selection lists contain additional information, where that additional information goes beyond the field/range names to give informative and descriptive information helpful to the user such as data field descriptions, examples of the data values within the field/range (e.g., first/lowest, and last/highest values), whether the field has nulls, the data type of the field, or the data set it resides in. Other examples would include for the table selections the number of rows of data or the number of fields/ranges.

Some Particular Implementations—Intelligent Selection Lists for Joined Fields from Three or More Data Sets

Implementations of our hints/selection list joins technology works for multiple join qualification flags set for three or more data sets joined together. Once a joinable field/range is entered into a pivot table input then our technology makes any joinable fields to that inputted field available in our selection lists and stops displaying of any fields/ranges from data sets that are not joinable (of course displaying fields in the same data set as the entered field) as exampled in FIG. 75 using data sets in FIG. 74A and FIG. 74B.

Different implementations of our intelligent selection lists for joined fields from three or more data sets then have different outcomes when attempting to add a field from a third data set. If there is a cardinality qualification blocking joins between many to many (non-unique to non-unique) cardinality joins and the individual joins between the two individual joins linking the three data sets pass that rule, but the chain join then chain/sequence joining the third data set does not pass that rule our selection lists/hints in that situation will not present for selection any of the fields in the third data set as exampled in FIG. 76 of the sequence in FIG. 74A through FIG. 78. Instead, only populating fields from the first two data sets for use in the pivot table inputs.

### Some Particular Implementations—Intelligent Selection Lists for Three Data Sets Chain Joined

Alternatively, if there is no applicable cardinality rule limiting joins or that rule is not applicable to the potential chain join then implementations of our hints/selection lists will populate some (e.g., because of function limitations like SUM limiting fields/ranges to numeric) or all of the fields in the third data set as well as the applicable fields in the first two data sets as exampled in FIG. 107, FIG. 108A, FIG. 108B, and FIG. 109 through FIG. 110B.

### Some Particular Implementations—Intelligent Selection Lists for Joined Fields Data Sources

All of intelligent hints/selection list implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Intelligent Selection Lists for Joined Fields Other Implementations

Other implementations of our intelligent hints/selection list technology may include a non-transitory computer readable storage medium storing instructions executable by a processor to perform any of the methods described above. Yet another implementation may include a system including memory and one or more processors operable to execute instructions, stored in the memory, to perform any of the methods described above.

### Some Particular Implementations—Intelligent Selection Lists for Three or More Data Sets Chain Joined

Implementations of our intelligent selection lists/hint support all combinations of chain joinable fields populated and used in our pivot table inputs. Those chain joins implementations can employ three data sets as exampled in FIG. 107, FIG. 108A, FIG. 108B, and FIG. 109 through FIG. 110B or chains through many more data sets as exampled in FIG. 107, FIG. 108C, FIG. 108C, and FIG. 49. They can utilize two pivot table input fields/ranges at the ends of the chain joins or chains with multiple joinable field pivot table inputs included in between.

Different implementations of our hints/selection list technology support alternative ways of accessing the joinable fields. One implementation displays all the joinable fields in a single selection list/hint as exampled in FIG. 38, FIG. 39B through FIG. 39E, and FIG. 41 with a functional limitation and in FIG. 94 through FIG. 95E without a functional limitation. In another implementation the joinable fields are accessible in the first selection list/hint with a click taking the user to the joinable fields (only) in a second hint/selection list as exampled in FIG. 38, FIG. 40A through FIG. 41 with a functional limitation and in FIG. 94, FIG. 96A through FIG. 96E without a functional limitation. However, in settings with many joinable tables implementations of our technology adds another step of selecting the data set as exampled in FIG. 108A through FIG. 108D.

Implementations of our hints/selection lists contain additional information, where that additional information goes beyond the field/range names to give informative and descriptive information helpful to the user such as data field descriptions, examples of the data values within the field/range (e.g., first/lowest, and last/highest values), whether the field has nulls, the data type of the field, or the data set it resides in. Other examples would include for the table selections the number of rows of data or the number of fields/ranges.

### Some Particular Implementations—Intelligent Selection Lists for Three or More Data Sets Chain Joined Data Sources

All of our intelligent selection lists for chain joined fields from three or more data sets implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Intelligent Selection Lists for Three or More Data Sets Chain Joined Other Implementations

Other implementations of our intelligent selection lists/hints for chain joined fields from three or more data sets technology may include a non-transitory computer readable storage medium storing instructions executable by a processor to perform any of the methods described above. Yet another implementation may include a system including memory and one or more processors operable to execute instructions, stored in the memory, to perform any of the methods described above.

### Some Particular Implementations—Intelligent Selection Lists for Double Joined Fields

Implementations of our technology support the intelligent selections lists for double (or more) joined data sets. These hints/selection lists automatically display the double joined fields with field names that have been differentiated so the user and application can tell the two different joins apart. Implementations work in the pivot table inputs after the user has populated a field from one of the two double joined databases at which point subsequent hints/selection lists accessibly display at least some of the fields from the double joined data set with the same join keys displaying the differentiation of its fields for the two different joins as exampled in hints/selection list in FIG. 58, FIG. 59, and FIG. 61 in the example in FIG. 56A through FIG. 64B.

Implementations of our technology present the automatically differentiated names of the same key data set in the double join data set pairs as exampled in FIG. 58 5876 and 5886 (also exampled in FIG. 59 and FIG. 61). One implementation uses the two different join key field names as the automatically altered names as exampled by ‘donor_state’ and ‘sponsor_state’ automatically appended to the data set field names (in the double joined data set with the same field as the two join keys) in FIG. 58 5876 and 5886. Implementations also include character(s) automatically appended to differentiate the appended characters from the original data set field names such as the dash and right pointing greater than characters ‘->’ exampled in FIG. 58 5876 and 5886 before the other table join key field names (also exampled in FIG. 59 and FIG. 61). Additional implementations replace the automatically generated additions to differentiate the double joined data set field names with a user specified set of characters for each of the double joins and our hints/selection lists automatically display which approach is in effect for this double join.

### Some Particular Implementations—Intelligent Selection Lists for Double Joined Fields Double Join Field Conversion

Implementations handle the situation where the user selection of the second pivot table input requires conversion of the first pivot table input from the undifferentiated field name to one of the two differentiated field names. In situations where the limitations of the pivot table inputs limit the conversion to only one of the two possible double joins then our technology automatically implements the change without need of an additional UI as exampled in FIG. 65 through FIG. 67. In the other situations where both possible join alternatives work our intelligent selection list technology automatically triggers the population of a select list UI offering the user a selection list with the two different field double join field names for the first field as exampled in FIG. 68 through FIG. 71.

### Some Particular Implementations—Intelligent Selection Lists for Double Joined Fields Selection Lists

Different implementations of our hints/selection list technology support alternative ways of accessing the double joinable fields. One implementation displays all the joinable fields in a single selection list/hint as exampled in FIG. 58, FIG. 59, and FIG. 61. In another implementation the double joinable fields are accessible from the first selection list/hint by selecting options that open further selection lists as exampled in FIG. 103 through FIG. 105.

Implementations of our hints/selection lists contain additional information, where that additional information goes beyond the field/range names to give informative and descriptive information helpful to the user such as data field descriptions, examples of the data values within the field/range (e.g., first/lowest, and last/highest values), whether the field has nulls, the data type of the field, or the data set (table) it resides in.

### Some Particular Implementations—Intelligent Selection Lists for Double Joined Fields Data Sources

All of our intelligent selection lists for double joined fields implementations support using data sets from non-spreadsheet cell external to the spreadsheet cells data as exampled in FIG. 28A and FIG. 28B. Those implementations also support using data sets that are ranges of data or tables within cells of the spreadsheet as exampled in FIG. 29A and FIG. 29B and those implementations support use of combinations of external data sets and in-cell data sets.

### Some Particular Implementations—Intelligent Selection Lists for Double Joined Fields Other Implementations

Other implementations of our intelligent selection lists for double joined fields technology may include a non-transitory computer readable storage medium storing instructions executable by a processor to perform any of the methods described above. Yet another implementation may include a system including memory and one or more processors operable to execute instructions, stored in the memory, to perform any of the methods described above.

### Mix and Match Implementations

While the technology disclosed is disclosed by reference to the embodiments, examples, and implementations detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following clauses and claims.

### CLAUSES

### Join Setup Assist

1. A method of better informing a user setting up a spreadsheet pivot table data join of the join keys' data type matches and data value matches, including:
a user input UI for setting up spreadsheet pivot table join that will join data between two data sets;
receiving from a user input a first field from a first data set and a second data set;
where the join set up capability automatically evaluates the data type match and data value match for each field in the second data set as a join key pair to the first field in the first data set;
outputting a data mismatch indicator if the field in the second data set is not the same data type as the first field in the first data set; and
outputting a data value lack of overlap indicator for any field in the second data set that is the same data type as the first field in the first data set and shares no common values.

2. The method of clause 1, further including where a data value overlap fraction is outputted for a field in the second data set that is the same data type as the first field in the first data set and shares common values.

3. The method of clause 2, wherein the data overlap fraction is calculated as the fraction of rows with values in the first field in common with the second data set field values.

4. The method of clause 2, wherein the data overlap fraction is calculated as the fraction of distinct values in the first field in common with the second data set field values.

5. The method of clause 2, wherein the data overlap fraction is calculated as the fraction of rows with values in the second data set field in common with values in the first field.

6. The method of clause 2, wherein the data overlap fraction is calculated as the fraction of distinct values in the second data set field in common with values in the first field.

7. The method of clause 2, wherein the data overlap fraction is calculated as the fraction of rows in first data set field and number of rows in the second data set field having common values.

### Join Setup Assist—Location

8. The method of clause 1, wherein the spreadsheet joins set up capability is within the spreadsheet.

9. The method of clause 1, wherein the spreadsheet joins set up capability is within a separate data setup tool for the spreadsheet.

### Join Setup Assist—Cardinalities

10. The method of clause 1, further including where the spreadsheet joins set up capability automatically evaluates the join cardinality for each field in the second data set as a join key pair to the first field in the first data set having the same data types and having at least one common value.

11. The method of clause 10, wherein the spreadsheet joins set up capability outputs an indicator of the cardinality for each join key combination passing the mismatch requirements.

12. The method of clause 1, further including where stopping is triggered by blocked data modeling cardinalities and outputs a blocked data modeling cardinality indicator.

### Join Setup Assist—Data Sources

13. The method of clause 1, wherein the data sets are data tables external to the spreadsheet.

14. The method of clause 1, wherein the data sets are ranges of data or tables within cells of the spreadsheet.

15. The method of clause 1, wherein the data sets are a combination of ranges of data or tables within cells of the spreadsheet and data tables external to the spreadsheet.

### Join Setup Assist—Other Implementations

16. A non-transitory computer readable memory, the memory impressed with computer instructions that, when executed on hardware, cause the hardware to carry out the method of any of clauses 1 through 15.

17. A system including processing hardware coupled to memory, the memory impressed with computer instructions that, when executed, cause the hardware to carry out the method of any of clauses 1 through 15.

### Non-Aligned Two Data Set Joins

18. A method of joining data sets within a spreadsheet pivot table requiring no directional alignment of the join inputs and direction alignment of the pivot table inputs, including:
receiving a user field input from the first data set in the spreadsheet pivot table Values input;
receiving a user input field input from the second data set in the pivot table Rows or Columns input;
executing the application or user specified SQL join type for the pivot table join between the first and second data set via a first key field in the first data set and a second key field in the second data set; and
using that joined data to create the pivot table results for all the different combinations of pivot table Values and Rows or Columns input without regard to the direction of the different table inputs between the pivot table Values and Rows or Columns inputs.

19. The method of clause 18, wherein inner, full outer, and left outer SQL join types are supported.

20. The method of clause 19, wherein the join type is selected by the user.

21. The method of clause 18, wherein the following data modeling cardinality joins are supported, one to one, unique to unique, one to many, many to one, unique to non-unique (many), non-unique (many) to unique, and non-unique (many) to non-unique (many).

22. The method of clause 21, wherein the SQL join succeeds when there is a null in either or both of the first key field and the second key field.

23. The method of clause 18, wherein all joins between keys having the same data type and at least one matching value are supported.

24. The method of clause 18, wherein joins set up before the pivot table inputs support only unique to unique, unique to non-unique (many), and non-unique (many) to unique cardinality joins and joins set up in the pivot table input support all cardinalities.

### Non-Aligned Two Data Set Joins—Error Generation

25. A method of clause 18, wherein any join with join keys with data type mismatch results in the generation of an error outcome.

26. The method of clause 18, wherein any join with join keys of the same data type but no matching values results in the generation of an error outcome.

27. The method of clause 18, wherein any pivot table with inputs from non-joined data sets results in the generation of an error outcome.

### Non-Aligned Two Data Set Joins—Data Sources

28. The method of clause 18, wherein the data sets are data tables external to the spreadsheet.

29. The method of clause 18, wherein the data sets are ranges of data or tables within cells of the spreadsheet.

30. The method of clause 18, wherein the data sets are ranges of data or tables within cells of the spreadsheet and the data sets are data tables external to the spreadsheet.

### Non-Aligned Two Data Set Joins—Other Implementations

31. A non-transitory computer readable memory, the memory impressed with computer instructions that, when executed on hardware, cause the hardware to carry out the method of any of clauses 18 through 30.

32. A system including processing hardware coupled to memory, the memory impressed with computer instructions that, when executed, cause the hardware to carry out the method of any of clauses 18 through 30.

### Non-Aligned Three or More Chained Data Set Joins

33. A method of chain joining data sets within a pivot table requiring no directional alignment of the joins and direction alignment of the pivot table inputs, including:
receiving a user field input from the first data set in the spreadsheet pivot table Values input;
receiving a user input of a field from the second data set in the pivot table Rows or Columns input;
receiving a user input of a field from the third data set in the pivot table Values, Rows or Columns input;
executing the application or user specified SQL join type(s) for the pivot table chain joins between the first, second and third data sets via:
   a first key field in the first data set and a second key field in the second data set; and
   a third key field in the third data set and a fourth key field in either the first data set or the second data set;
using that joined data to create the pivot table results for all the different combinations of pivot table Values, Rows, Columns, or Filters inputs that fulfill the limitations of pivot table input fields.

34. The method of clause 33, wherein inner, full outer, right outer, self and cross, and left outer SQL join types are supported.

35. The method of clause 33, wherein nulls do not stop the join if they are in any of the join keys

36. The method of clause 33, wherein all data modeling cardinality joins are supported.

37. The method of clause 36, wherein the accepted data modeling cardinality varies by the location of the join set up.

38. The method of clause 37, wherein joins set up before the pivot table inputs support only unique to unique, unique to non-unique (many), and non-unique (many) to unique cardinality joins and joins set up in the pivot table input support all cardinalities.

39. The method of clause 33, wherein all joins between keys having the same data type and at least one matching value are supported.

### Non-Aligned Two Data Set Joins—Error Generation

40. A method of clause 33, wherein any join with join keys with data type mismatch results in the generation of an error outcome.

41. The method of clause 33, wherein any join with join keys of the same data type but no matching values results in the generation of an error outcome.

42. The method of clause 33, wherein any pivot table with inputs from non-joined data sets results in the generation of an error outcome.

### Non-Aligned Two Data Set Joins—Data Sources

43. The method of clause 33, wherein the data sets are data tables external to the spreadsheet.

44. The method of clause 33, wherein the data sets are ranges of data or tables within cells of the spreadsheet.

45. The method of clause 33, wherein the data sets are ranges of data or tables within cells of the spreadsheet and the data sets are data tables external to the spreadsheet.

### Non-Aligned Two Data Set Joins—Other Implementations

46. A non-transitory computer readable memory, the memory impressed with computer instructions that, when executed on hardware, cause the hardware to carry out the method of any of clauses 33 through 45.

47. A system including processing hardware coupled to memory, the memory impressed with computer instructions that, when executed, cause the hardware to carry out the method of any of clauses 33 through 45.

### Double Joins Involving Only One of the Doubles

48. A method of selecting between two potentially simultaneous joins between two data sets within a spreadsheet pivot table and using one of the two joins to produce the pivot table output, including:
receiving a definition of two potentially simultaneous joins:
   join one a first and second data set via a first key field in the first data set and a second key field in the second data set and
   join two the same first and the second data sets via a third key field in the first data set that is different than the first key field and the second key field in the second data set that is the same second key as used with the first key in the first join;
receiving input from a user that specifies:
   at least one field from the second data set employing the join one; and
   at least one field from first data set;
not receiving any input from a user specifying a field from the second data set employing join two;
joining the inputted fields from the first and the second datasets using join one; and using the joined data to create the spreadsheet pivot table.

49. The method of clause 48, wherein the joinable field names for the join one data set two and the join two data set two are automatically changed so they are differentiated from the other versions.

50. The method of clause 49, wherein the automatic change of the field names includes appending the first key field name to each of the fields in data set two to make the join one version of data set two field names and appending the third key field name to each of the fields in data set two to make the join two version of data set two fields names.

51. The method of clause 50, wherein the appended second and third key field names are preceded by the dash and right pointing characters (->).

52. The method of clause 48, wherein the joinable field names for the join one data set two and the join two data set two are changed by a user specified data field name addition so they are differentiated from the other versions.

### Double Join Involving Only One of the Doubles—Double Join Field Conversion

53. The method of clause 48, wherein a previous population of a non-join one or non-join two data set two field into an input is automatically presented an option for a join one or join two version of the same field once a user populates an input with a data set one field, a data set two join one field, or a data set two join two field.

### Double Joins Involving Only One of the Doubles—Join Types

54. The method of clause 48, wherein inner, full outer, right outer, self, cross and left outer SQL join types are supported.

55. The method of clause 54, wherein the default join type is a full outer join.

### Double Joins Involving Only One of the Doubles—Data Sources

56. The method of clause 48, wherein the data sets are data tables external to the spreadsheet.

57. The method of clause 48, wherein the data sets are ranges of data or tables within cells of the spreadsheet.

58. The method of clause 48, wherein the data sets are ranges of data or tables within cells of the spreadsheet and the data sets are data tables external to the spreadsheet.

### Double Joins Involving Only One of the Doubles—Other Implementations

59. A non-transitory computer readable memory, the memory impressed with computer instructions that, when executed on hardware, cause the hardware to carry out the method of any of clauses 48 through 58.

60. A system including processing hardware coupled to memory, the memory impressed with computer instructions that, when executed, cause the hardware to carry out the method of any of clauses 48 through 58.

### Double Join Involving Both Doubles

61. A method of simultaneously executing two joins between two data sets within a spreadsheet pivot table and using two different join versions of the same data set to produce the pivot table output, including:
receiving a definition of two simultaneous joins:
   join one a first and second data set via a first key field in the first data set and a second key field in the second data set and
   join two the same first and the second data sets via a third key field in the first data set that is different than the first key field and the second key field in the second data set that is the same second key as used with the first key in the first join;
receiving input from a user that specifies:
   at least one field from the second data set employing the join one; and
   at least one field from the second data set employing the join two;
chain joining the inputted fields from second datasets and any inputted fields from the first data set using join one and join two; and
using the chain joined data to create the spreadsheet pivot table result.

62. The method of clause 61, wherein the joinable field names for the join one data set two and the join two data set two are automatically changed so they are differentiated from the other versions.

63. The method of clause 62, wherein the automatic change of the field names includes appending the first key field name to each of the fields in data set two to make the join one version of data set two field names and appending the third key field name to each of the fields in data set two to make the join two version of data set two fields names.

64. The method of clause 63, wherein the appended second and third key field names are preceded by the dash and right pointing characters (->).

65. The method of clause 61, wherein the joinable field names for the join one data set two and the join two data set two are changed by a user specified data field name addition so they are differentiated from the other versions.

### Double Join Involving Both Doubles—Double Join Field Conversion

66. The method of clause 61, wherein a previous population of a non-join one or non-join two data set two field into an input is automatically converted to a join one version of the same field once a user populates an input with a data set two join one field of the same field into pivot table inputs that do not allow multiple use of the same field.

67. The method of clause 61, wherein a previous population of a non-join one or non-join two data set two field into an input is automatically presented an option for a join one or join two version of the same field once a user populates an input with a data set one field, a data set two join one field, or a data set two join two field.

### Double Join Involving Both Doubles—Join Types

68. The method of clause 61, wherein inner, full outer, right outer, self, cross and left outer SQL join types are supported.

69. The method of clause 61, wherein the default join type is a full outer join.

### Double Join Involving Both Doubles—Data Sources

70. The method of clause 61, wherein the data sets are data tables external to the spreadsheet.

71. The method of clause 61, wherein the data sets are ranges of data or tables within cells of the spreadsheet.

72. The method of clause 61, wherein the data sets are a combination of ranges of data or tables within cells of the spreadsheet and the data sets are data tables external to the spreadsheet.

### Double Join Involving Both Doubles—Other Implementations

73. A non-transitory computer readable memory, the memory impressed with computer instructions that, when executed on hardware, cause the hardware to carry out the method of any of clauses 61 through 72.

74. A system including processing hardware coupled to memory, the memory impressed with computer instructions that, when executed, cause the hardware to carry out the method of any of clauses 61 through 72.

### Intelligent Selection Lists for Joined Fields

75. A method of presenting only joinable fields in a pivot table input selection list once a joinable field has been populated into the pivot table inputs, including:
having set a join qualification flag for joinability of a first data set with a second data set via a first key field in the first data set and a second key field in the second data set;
having received from a user input into a pivot table input panel specifying a first field from the first data set;
starting from a position in the pivot table input panel responsive to the specified first field and the join qualification flag, automatically displaying a selectable list including at least some of the fields of the second data set, fields from the first data set but not including selectable fields from and any other data sets, accepting a user selected second field from the second data set from the selectable list, and populating a section of the pivot table input panel with the selected second field;
joining the specified field and the selected field from the first and second data sets; and using the joined data to create the pivot table.

### Intelligent Selection Lists for Joined Fields—Selection Lists

76. The method of clause 75, wherein the fields in joinable data sets are displayed in a single selection list.

77. The method of clause 75, wherein the fields in joinable sets are accessible from a single selection list.

78. The method of clause 77, wherein accessing the fields in the joinable data set involves one or more sequential selection list selections.

79. The method of clause 75, wherein the selection list includes additional information for the list of selectable options, the additional information including:
for data fields, informative descriptions of data field content of the data fields, informative and descriptive beyond data field names.

### Intelligent Selection Lists for Joined Fields—Three or More Data Sets

80. The method of clause 75, further including:
having set a join qualification flag for joinability of the first data set with a third data set via a third key field in the first data set and a fourth key field in the third data set;
displaying in the selection list in addition to some fields from the first and second data sets displaying some fields from the third data set but not including selectable fields from and any other data sets; accepting a user selected second field from the second data set or the third data set from the selectable list, and populating a section of the pivot table input panel with the selected second field;
joining the specified field and the selected field from the first and second data sets or first and third data sets; and
using the joined data to create the pivot table.

81. The method of clause 80, further including:
having received a join qualification flag requirement that blocks many-to-many cardinality joins;
having both the data set one to data set two and the data set one to data set two joins pass the cardinality qualification flag requirement, but the data set two to data set three chain join fail the cardinality qualification flag;
limiting the displaying in the selection list to some fields from the first and second data sets in the selection list but not including selectable fields from the third data set and any other data sets; accepting a user selected third field from the first data set or the second data set from the selectable list, and populating a section of the pivot table input panel with the selected second field;
joining the specified field and the two selected fields from the first and second data sets; and
using the joined data to create the pivot table.

### Intelligent Selection Lists for Joined Fields—Three Data Sets Chain Joined

82. The method of clause 80, further including:
having already received a selected field from the second data set populated in a section of the pivot table input panel;
displaying in the selection list some fields from the first, second, and third data sets but not including selectable fields from and any other data sets; accepting a user selected second field from the third data set from the selectable list, and populating a section of the pivot table input panel with the selected third field;
chain joining the specified first field from the first data set, the selected second field from the second data set, and the third data field from the third data set; and
using the chain joined data to create the pivot table.

### Intelligent Selection Lists for Joined Fields-Data Sources

83. The method of clause 75, wherein the data sets are data tables external to the spreadsheet.

84. The method of clause 75, wherein the data sets are ranges of data or tables within cells of the spreadsheet.

85. The method of clause 75, wherein the data sets are a combination of ranges of data or tables within cells of the spreadsheet and the data sets are data tables external to the spreadsheet.

### Intelligent Selection Lists for Joined Fields—Other Implementations

86. A non-transitory computer readable memory, the memory impressed with computer instructions that, when executed on hardware, cause the hardware to carry out the method of any of clauses 75 through 85.

87. A system including processing hardware coupled to memory, the memory impressed with computer instructions that, when executed, cause the hardware to carry out the method of any of clauses 75 through 85.

### Intelligent Selection Lists for Joined Fields—Three or More Data Sets Chain Joined

88. A method of presenting only joinable fields in a pivot table input selection list once a joinable field has been populated into the pivot table inputs, including:
having set a join qualification flag for joinability of a multiple data sets that all join or chain join together;
having received from a user input into a pivot table input panel specifying a first field from the one of the join or chain join data sets;
starting from a position in the pivot table input panel responsive to the specified first field and the join qualification flag, automatically displaying a selectable list including at least some of the fields of the fields from the joinable or chain joinable data sets but not including selectable fields from and any other data sets, accepting a user selected second field from the selectable list, and populating a section of the pivot table input panel with the selected second field;
joining or chain joining the specified field and the selected field from the first and second data sets; and
using the joined data to create the pivot table.

### Intelligent Selection Lists for Joined Fields—Three or More Data Sets Chain Joined Selection Lists

89. The method of clause 88, wherein the fields in joinable data sets are displayed in a single selection list.

90. The method of clause 88, wherein the fields in joinable sets are accessible from a single selection list.

91. The method of clause 88, wherein accessing the fields in the joinable data set involves one or more sequential selection list selections.

92. The method of clause 88, wherein the selection list includes additional information where that additional information for the list of selectable options, the additional information including: for data fields, informative descriptions of data field content of the formulaic data fields, informative and descriptive beyond data field names.

### Intelligent Selection Lists for Joined Fields—Three or More Data Sets Chain Joined Data Sources

93. The method of clause 88, wherein the data sets are data tables external to the spreadsheet.

94. The method of clause 88, wherein the data sets are ranges of data or tables within cells of the spreadsheet.

95. The method of clause 88, wherein the data sets are a combination of ranges of data or tables within cells of the spreadsheet and the data sets are data tables external to the spreadsheet.

### Intelligent Selection Lists for Joined Fields—Three or More Data Sets Chain Joined Other Implementations

96. A non-transitory computer readable memory, the memory impressed with computer instructions that, when executed on hardware, cause the hardware to carry out the method of any of clauses 88 through 95.

97. A system including processing hardware coupled to memory, the memory impressed with computer instructions that, when executed, cause the hardware to carry out the method of any of clauses 88 through 95.

### Intelligent Selection Lists for Joined Fields—Double Joins

98. A method of presenting only joinable fields in a pivot table input selection list once a joinable field has been populated into the pivot table inputs, including:
having set a join qualification flag for the double joinability of two data sets sharing the same join keys for one of the two data sets but not sharing the same join keys for the other data set;
having received from a user input into a pivot table input panel specifying a first field from the one of the two data sets;
automatically creating two differentiated sets of the field names of the data set containing the same join keys;
starting from a position in the pivot table input panel responsive to the specified first field and the double join qualification flags, automatically displaying a selectable list including at least some of the fields with the two different sets of field names of the data set containing the same join keys, accepting a user selected second field from the two different sets of field names of the data set containing the same join keys in the selectable list, and populating a section of the pivot table input panel with the selected second field;
joining the specified field and the selected field from the first and second data sets; and using the joined data to create the pivot table.

99. The method of clause 98, wherein the differentiated sets of field names of the double join data set one containing the same join keys includes appending the first key field name of the other data set to each of the fields in data set one to make the differentiated join one version of data set one field names and appending the second key field name of the other data set to each of the fields in data set one to make the differentiated join two version of data set one fields names.

100. The method of clause 99, wherein the appended added key field names are preceded by the dash and right pointing characters (->).

### Intelligent Selection Lists for Joined Fields—Double Join Field Conversion

101. The method of clause 98, wherein the selection of the second field requires conversion of the first field to a double joined version of the field and because of the pivot table input limitation of not repeat using the field it automatically triggers the replacement of the first field to the only variant of the double field available.

102. The method of clause 98, wherein the selection of the second field requires conversion of the first field to one of the two different join versions and automatically triggers the creation of a select list UI offering the user a selection list with the two different field double join field names for the first field.

### Intelligent Selection Lists for Joined Fields—Double Join Selection Lists

103. The method of clause 98, wherein the fields in joinable sets are accessible from a single selection list.

104. The method of clause 103, wherein accessing the fields in the joinable data set involves one or more sequential selection list selections.

105. The method of clause 103, wherein the selection list includes additional information where that additional information for the list of selectable options, the additional information including:
for data fields, informative descriptions of data field content of the formulaic data fields, informative and descriptive beyond data field names.

### Intelligent Selection Lists for Joined Fields-Double Joins Data Sources

106. The method of clause 98, wherein the data sets are data tables external to the spreadsheet.

107. The method of clause 98, wherein the data sets are ranges of data or tables within cells of the spreadsheet.

108. The method of clause 98, wherein the data sets are a combination of ranges of data or tables within cells of the spreadsheet and the data sets are data tables external to the spreadsheet.

### Intelligent Selection Lists for Joined Fields-Double Joins Other Implementations

109. A non-transitory computer readable memory, the memory impressed with computer instructions that, when executed on hardware, cause the hardware to carry out the method of any of clauses 98 through 108.

110. A system including processing hardware coupled to memory, the memory impressed with computer instructions that, when executed, cause the hardware to carry out the method of any of clauses 98 through 108.

We claim as follows:

1. A method of stopping a spreadsheet pivot table data set join when user specified join keys have a data type mismatch or data value mismatch, including:
receiving from a user input from an input panel specifying for a spreadsheet pivot table join a first field from a first data set as a join key and a second field from a second data set as a join key;
comparing data types of the first field and the second field then stopping the spreadsheet pivot table join with a message when both the first field and the second field are not the same data type; and
comparing data values found in the first field and the second field then stopping the spreadsheet pivot table join with a message when the first field and the second field share no common values.

2. The method of claim 1, wherein stopping the join stops generation of the pivot table.

3. The method of claim 1, wherein the message includes a popup error message requiring correction of the join selection before the generation of the pivot table.

4. The method of claim 1, wherein the message is an in-cell error message rather than a pivot table.

5. The method of claim 1, wherein the message includes an explanation that the join was stopped because of data type mismatch and/or data value mismatch.

6. The method of claim 1, further including comparing the data values found in the first field and the second field then stopping the join when the fields share common values below a specified fraction of the data values.

7. The method of any of claim 1, wherein the input panel for the pivot table join is accessed from within the spreadsheet.

8. The method of any of claim 7, wherein the input panel is within a pivot table input panel.

9. The method of claim 1, further including comparing the data values found in the first field and the second field then stopping of the join when the fields have non-unique to non-unique cardinalities.

10. The method of claim 1, wherein the first and second data sets are data tables external to the spreadsheet cells.

11. The method of claim 1, wherein the first and second data sets are ranges of data or tables within cells of the spreadsheet.

12. The method of claim 1, wherein the first and second data sets mix a range of data or a table within cells of the spreadsheet with a data table external to the spreadsheet.

13. A non-transitory computer readable medium holding instructions that, when executed on hardware, configure the hardware to implement a method of stopping a spreadsheet pivot table data set join when user specified join keys have a data type mismatch or data value mismatch, including:
receiving from a user input from an input panel specifying for a spreadsheet pivot table join a first field from a first data set as a join key and a second field from a second data set as a join key;
comparing data types of the first field and the second field then stopping the spreadsheet pivot table join with a message when both the first field and the second field are not the same data type; and
comparing data values found in the first field and the second field then stopping the spreadsheet pivot table join with a message when the first field and the second field share no common values.

14. The non-transitory computer readable medium of claim 13 holding instructions that, when executed on hardware, configure the hardware to implement the method, wherein stopping the join stops generation of the pivot table.

15. The non-transitory computer readable medium of claim 13 holding instructions that, when executed on hardware, configure the hardware to implement the method, wherein the message includes a popup error message requiring correction of the join selection before the generation of the pivot table.

16. The non-transitory computer readable medium of claim 13 holding instructions that, when executed on hardware, configure the hardware to implement the method, wherein the message is an in-cell error message rather than a pivot table.

17. The non-transitory computer readable medium of claim 13 holding instructions that, when executed on hardware, configure the hardware to implement the method, wherein the message includes an explanation that the join was stopped because of data type mismatch and/or data value mismatch.

18. The non-transitory computer readable medium of claim 13 holding instructions that, when executed on hardware, configure the hardware to implement the method, wherein the input panel for the pivot table join is accessed from within the spreadsheet.

19. The non-transitory computer readable medium of claim 18 holding instructions that, when executed on hardware, configure the hardware to implement the method, wherein the input panel is within a pivot table input panel.

20. The non-transitory computer readable medium of claim 13 holding instructions that, when executed on hardware, configure the hardware to implement the method, wherein the data sets mix a range of data or a table within cells of the spreadsheet with a data table external to the spreadsheet.

21. A computer-implemented system including at least one processor and memory coupled to the processor, the memory holding program instructions that, when executed, implement a method of stopping a spreadsheet pivot table data set join when user specified join keys have a data type mismatch or data value mismatch, including:
receiving from a user input from an input panel specifying for a spreadsheet pivot table join a first field from a first data set as a join key and a second field from a second data set as a join key;
comparing data types of the first field and the second field then stopping the spreadsheet pivot table join with a message when both the first field and the second field are not the same data type; and
comparing data values found in the first field and the second field then stopping the spreadsheet pivot table join with a message when the first field and the second field share no common values.

22. The computer system of claim 21, wherein stopping the join stops generation of the pivot table.

23. The computer system of claim 21, wherein the message includes a popup error message requiring correction of the join selection before the generation of the pivot table.

24. The computer system of claim 21, wherein the message is an in-cell error message rather than a pivot table.

25. The computer system of claim 21, wherein the message includes an explanation that the join was stopped because of data type mismatch and/or data value mismatch.
